(19) United States
(12) Patent Application Publication
(10) Pub. No.: US 2025/0291469 A1
(43) Pub. Date: Sep. 18, 2025

(54) DEVICES, SYSTEMS, AND METHODS FOR CONTENT BOARD APPLICATIONS

(71) Applicant: Apple Inc., Cupertino, CA (US)

(72) Inventors: Evan S. TORCHIN, Austin, TX (US); Faruk YUCEL, Wexford, PA (US); Benjamin STIGLITZ, Pittsburgh, PA (US); Emily L. PEPKE, Pittsburgh, PA (US)

(21) Appl. No.: 18/957,560

(22) Filed: Nov. 22, 2024

Related U.S. Application Data
(60) Provisional application No. 63/564,432, filed on Mar. 12, 2024.

(51) Int. Cl. G06F 3/04845; G06F 3/0482; G06T 3/40; G06T 11/60

(52) U.S. Cl. CPC G06F 3/04845; G06F 3/0482; G06T 3/40; G06T 11/60; G06F 2203/04806; G06T 2200/28

(57) ABSTRACT

An electronic devices receives an indication to store a content board scene associated with a content board and displays one or more user interfaces that facilitate user interactions with previously stored content board scenes, including modifying content board scenes, navigating between content board scenes, and exporting content board scenes. In some embodiments, in response to an indication from a user to display an object, the electronic device generates a continuous boundary around the first object, wherein the area within the continuous boundary designates an area of interactivity for the connection of a second object to the first object.

### CROSS-REFERENCE TO RELATED APPLICATIONS

This application claims the benefit of U.S. Provisional Application No. 63/564,432, filed Mar. 12, 2024, the entire disclosure of which is herein incorporated by reference for all purposes.

### FIELD OF THE DISCLOSURE

This relates generally to interactions between a user of an electronic device and content board applications running on the electronic device.

### BACKGROUND

User interaction with electronic devices has increased significantly in recent years. These devices can be devices such as computers, tablet computers, televisions, multimedia devices, mobile devices, and the like.

In some circumstances, users wish to interact with a content creation application and specifically content boards that are associated with content creation applications. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY

Some embodiments of the disclosure are directed to an electronic device that facilitates efficient interactions between a user and a content board/creation application. In some embodiments, the electronic device receives an indication to store a content board scene associated with a content board. In some embodiments, the electronic device provides one or more user interfaces for interacting with saved content board scenes, thus allowing the user to modify, navigate between, and export content board scenes. In some embodiments, the electronic device receives an indication to display a first object, via the display generation component, on a content board associated with a content creation application, and in response the electronic device optionally generates a continuous boundary around the first object, wherein an area within the continuous boundary defines an area of interactivity of the first object. Following the display of the first object, when the electronic device receives an indication to display a second object, wherein one or more portions of the second object intersect with the area of interactivity of the first object, the electronic device subsequently, or simultaneously, connects the second object with the first object. Accordingly, when the electronic device receives inputs to modify no or more characteristics of the first object (e.g., scale, location, color), the electronic device applies such modification inputs to the first object and the second object connected thereto.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates a block diagram of an exemplary architectures for devices according to some embodiments.

FIGS. 6A-60 illustrate exemplary ways in which an electronic device facilitates the creation of and interaction with content board scenes associated with a content creation application.

FIG. 7 is a flowchart illustrating a method for generating and interacting with content board scenes, in accordance with some embodiments.

FIGS. 8A-8N illustrate exemplary ways in which an electronic device displays one or more objects in response to receiving one or more inputs from a user, and the interactivity of objects, in accordance with some embodiments.

FIG. 9 is a flowchart illustrating a method for displaying one or more objects, and in response, generating areas and/or elements of interactivity, in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that facilitate the creation of and interaction with content board scenes associated with a content board that is part of a content creation application. There is also a need for electronic devices that provide efficient methods for interaction between multiple objects displayed by the user on a content board associated with a content creation application running on an electronic device wherein the electronic device provides processes to efficiently establish connections between objects to reduce user inputs, and allow efficient modifications to multiple objects. The techniques described above can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

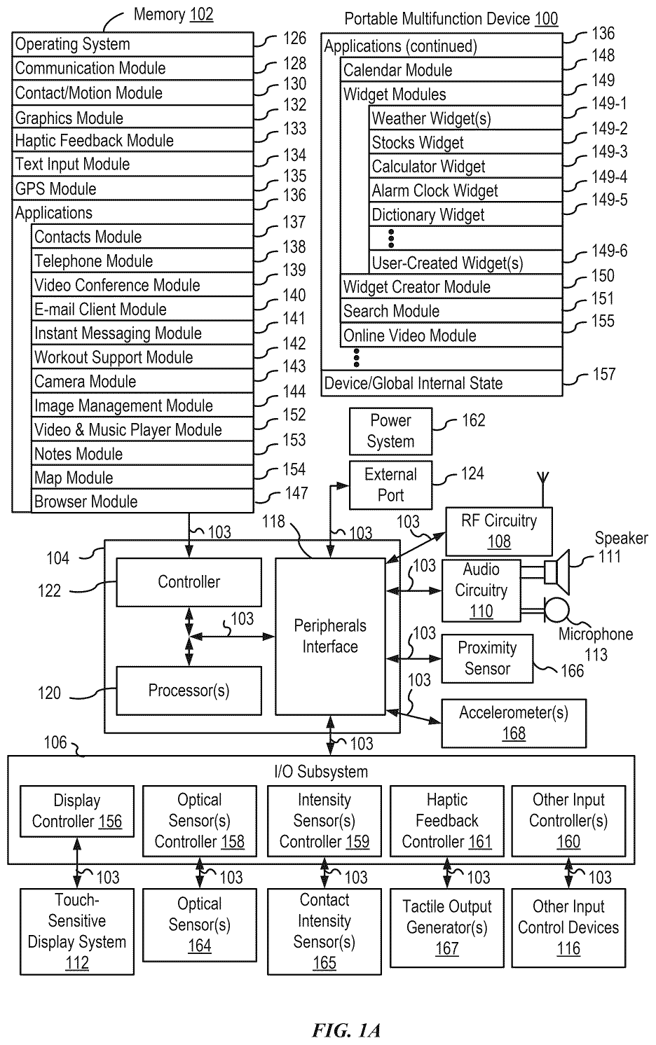

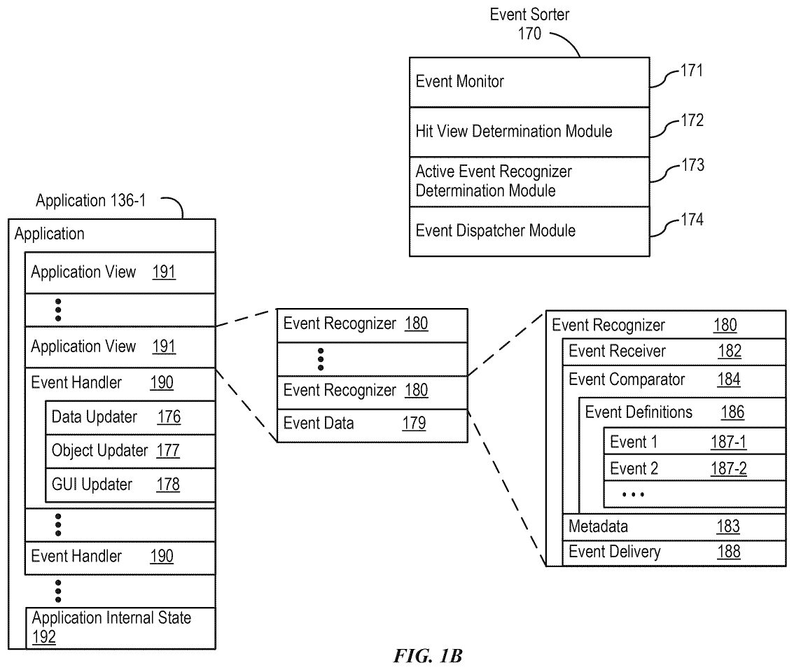

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, and/or rocker buttons), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

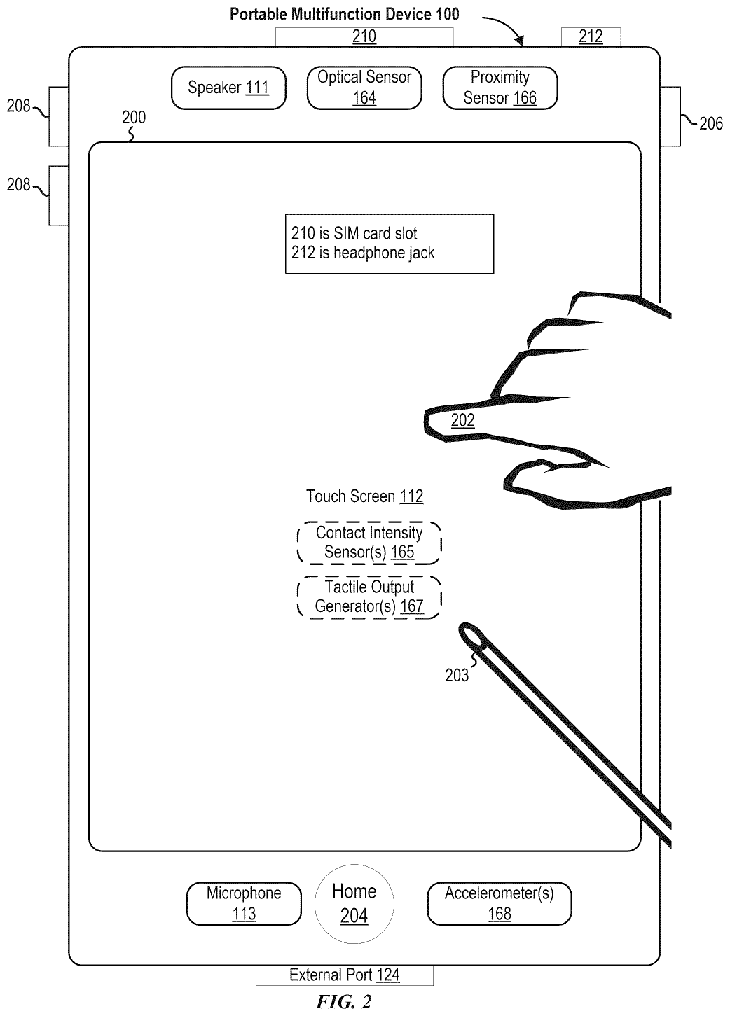

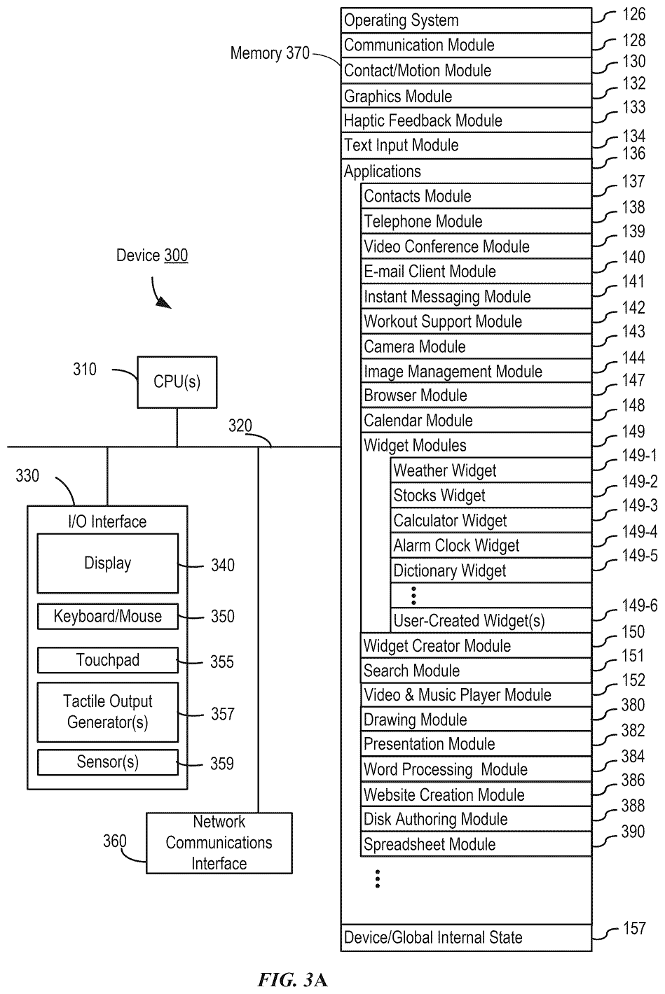

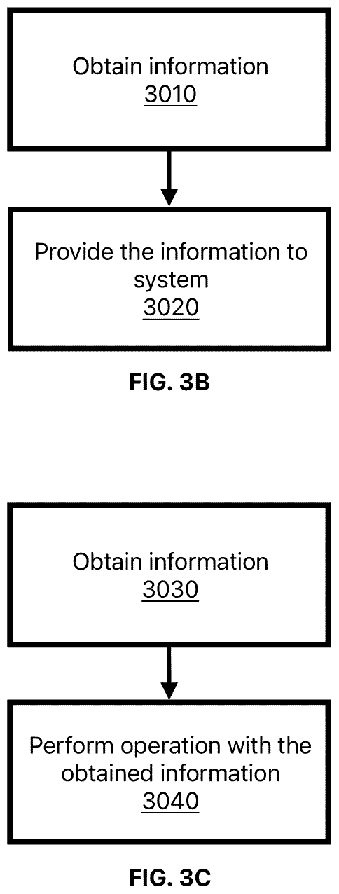

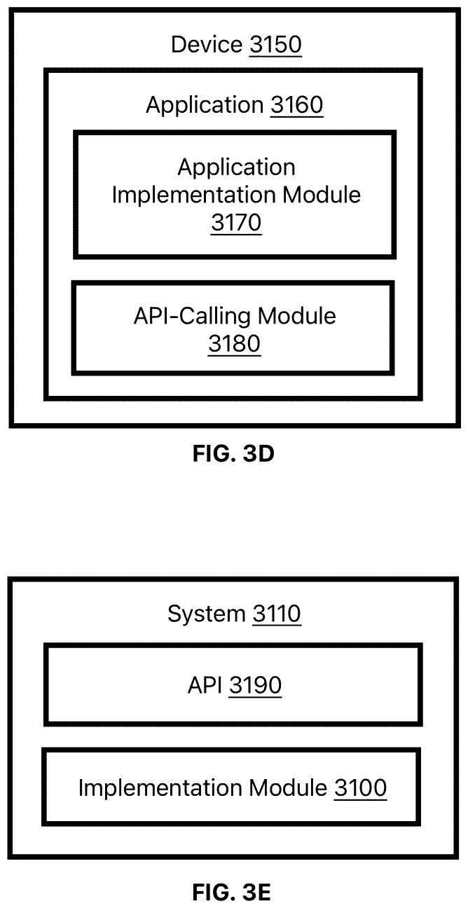

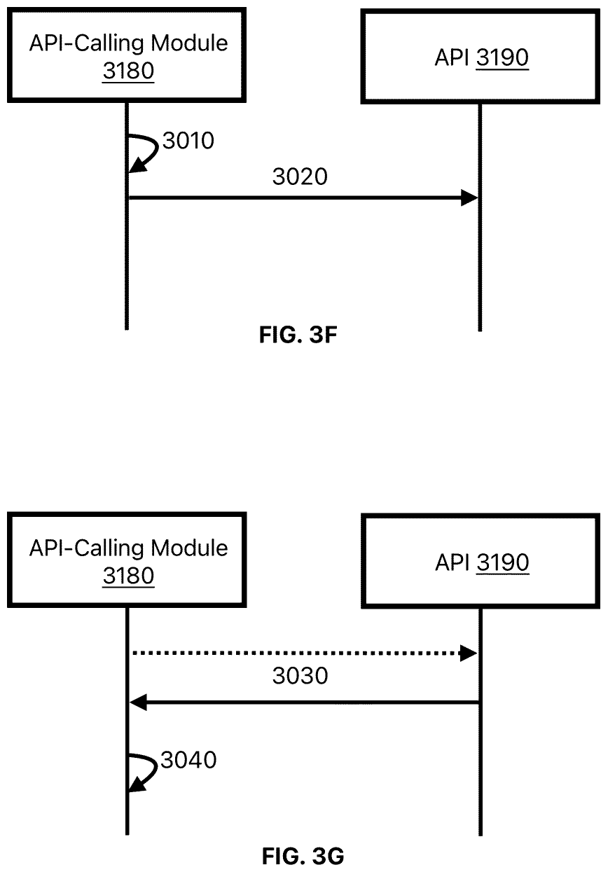

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, and/or power management) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), and/or FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications, etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, and/or to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, and/or scrolls on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable, or non-portable, multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also includes one or more physical buttons, such as “home” or menu button 204. As previously described, menu button 204 is, optionally, used to navigate to any application 136 in a set of applications that are, optionally, executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be include the display and the touch-sensitive surface, as described above, but rather, in some embodiments, optionally communicates with the display and the touch-sensitive surface on other devices. Additionally, device 300 need not portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable, or non-portable, multifunction device 100 (FIG. 1A), or a subset thereof. Furthermore, memory 370 optionally stores additional programs, modules, and data structures not present in memory 102 of portable, or non-portable, multifunction device 100. For example, memory 370 of device 300 optionally stores drawing module 380, presentation module 382, word processing module 384, website creation module 386, disk authoring module 388, and/or spreadsheet module 390, while memory 102 of portable, or non-portable, multifunction device 100 (FIG. 1A) optionally does not store these modules.

Each of the above-identified elements in FIG. 3A are, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

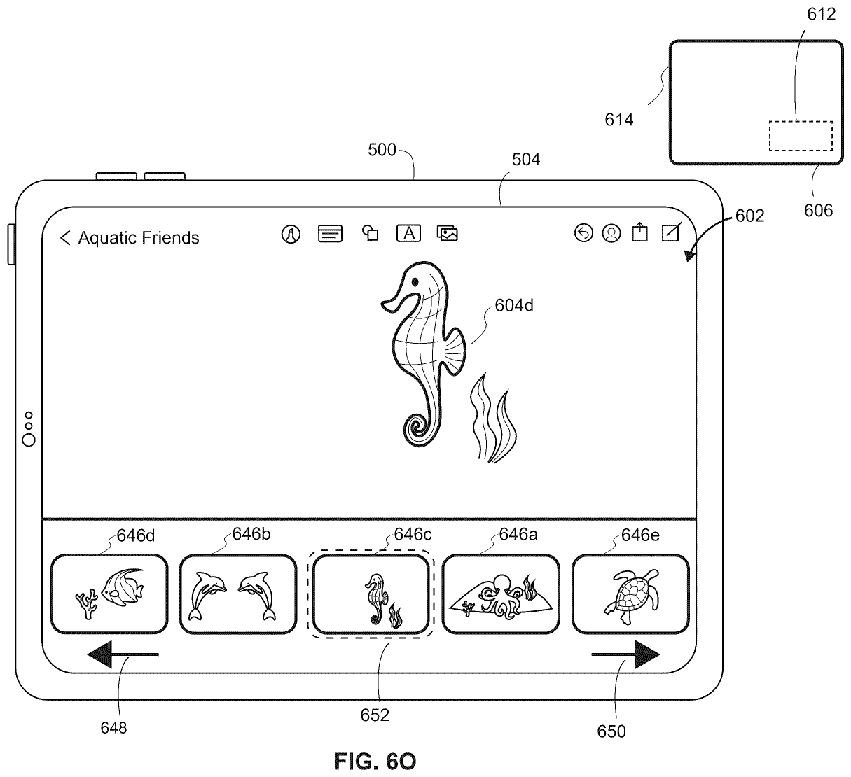

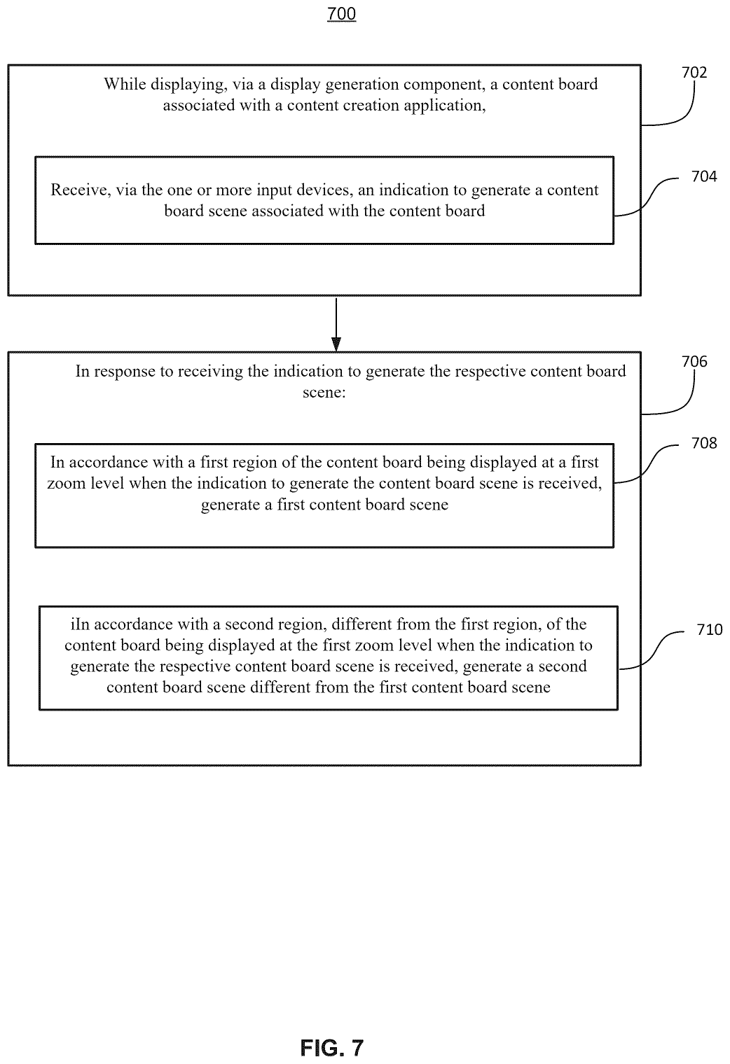

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

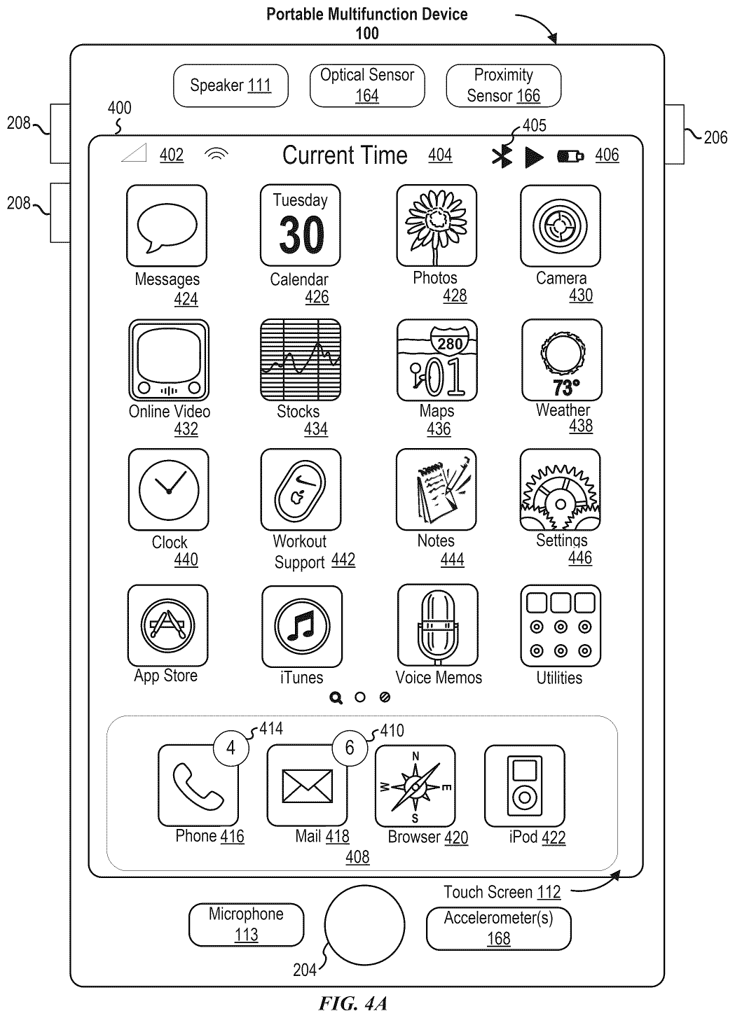

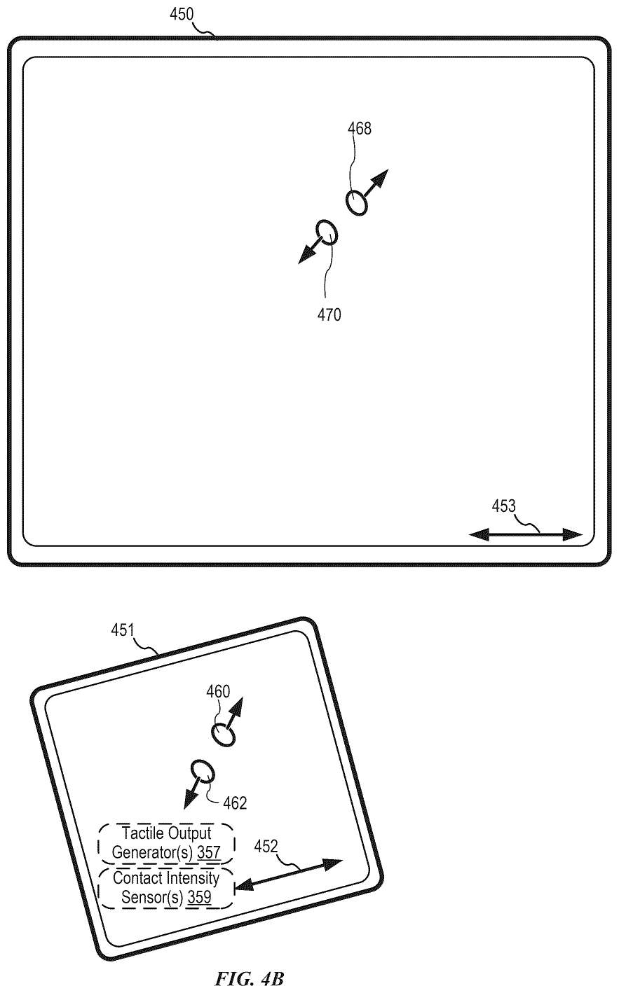

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

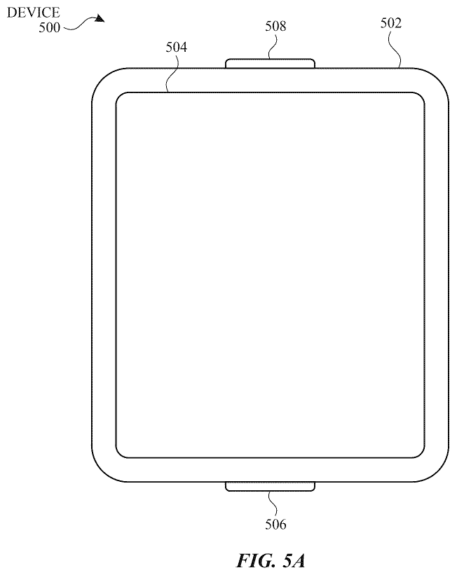

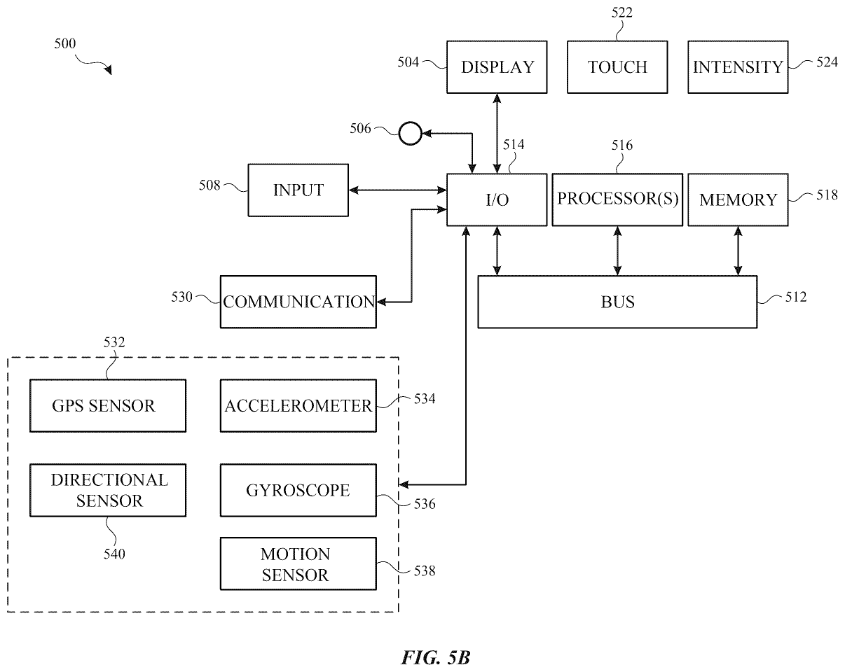

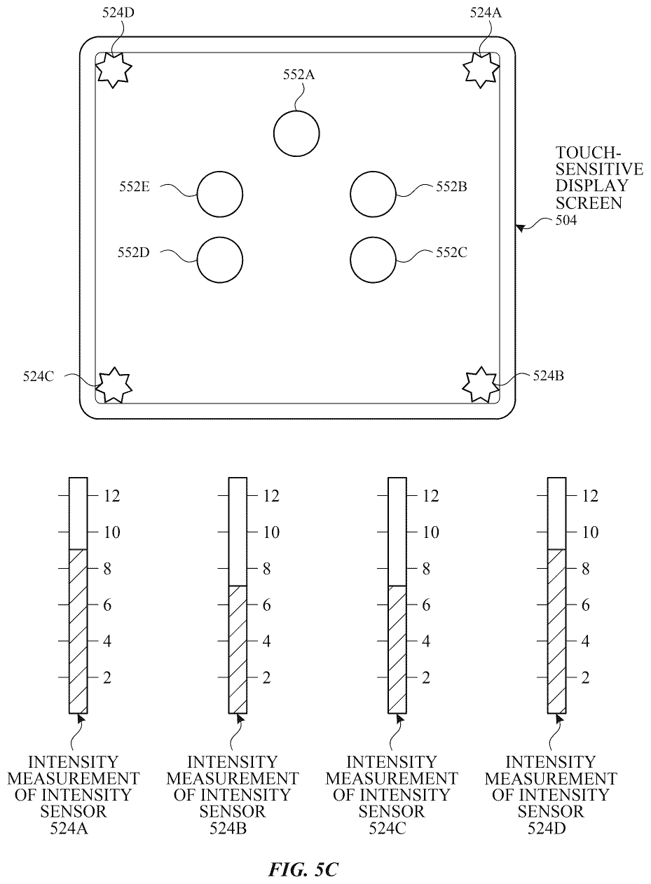

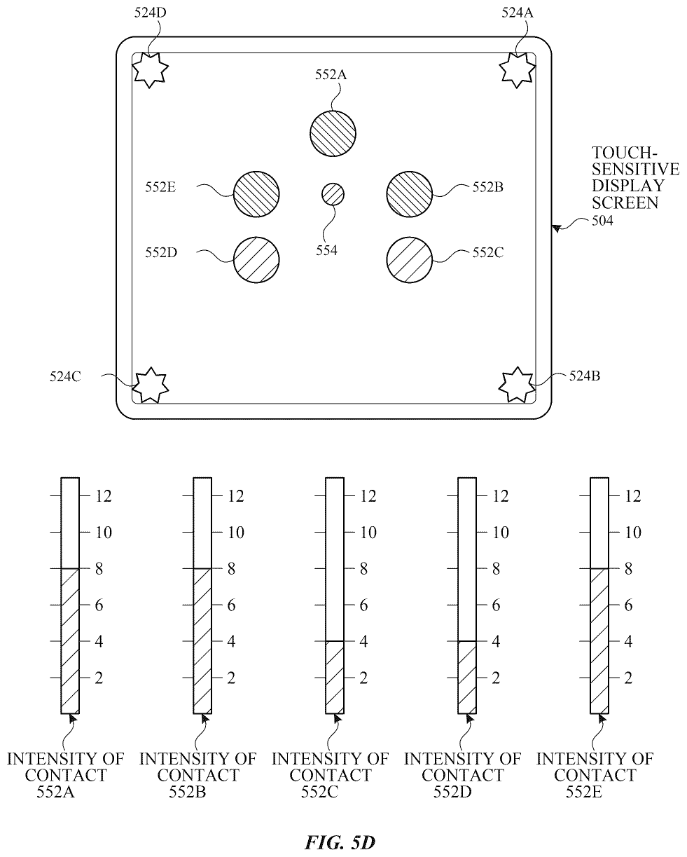

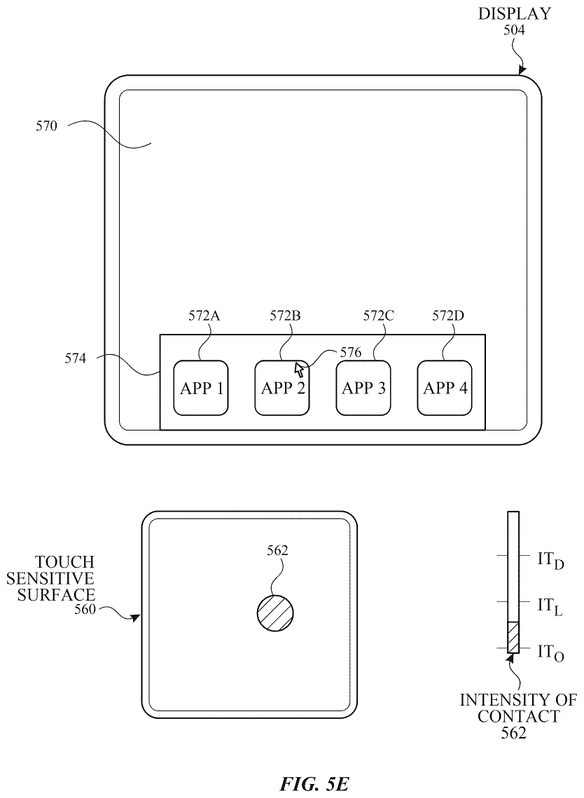

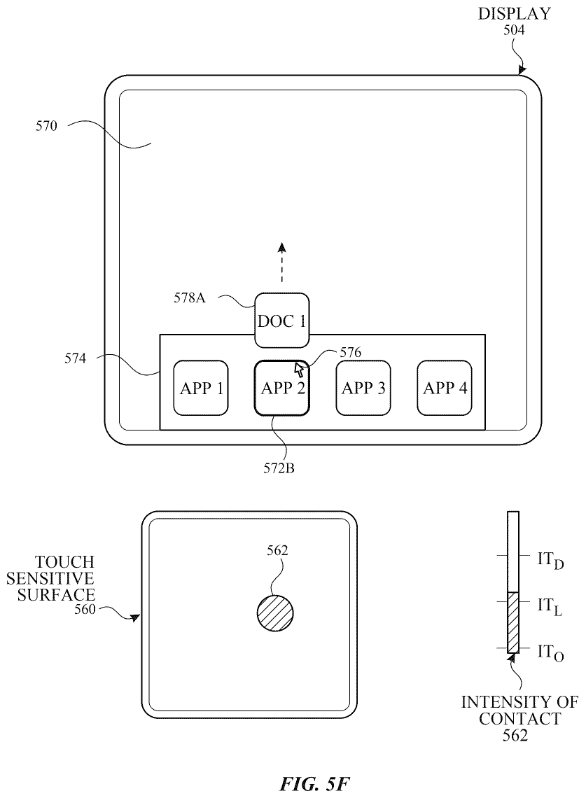

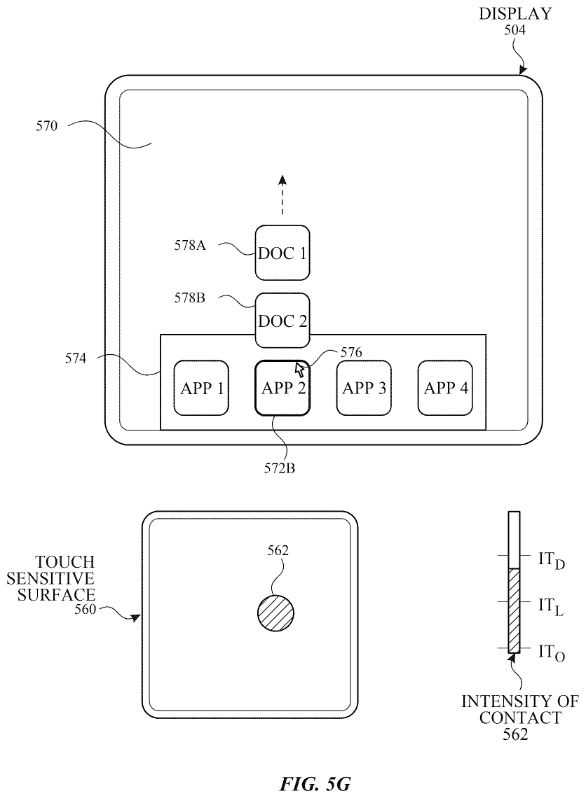

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

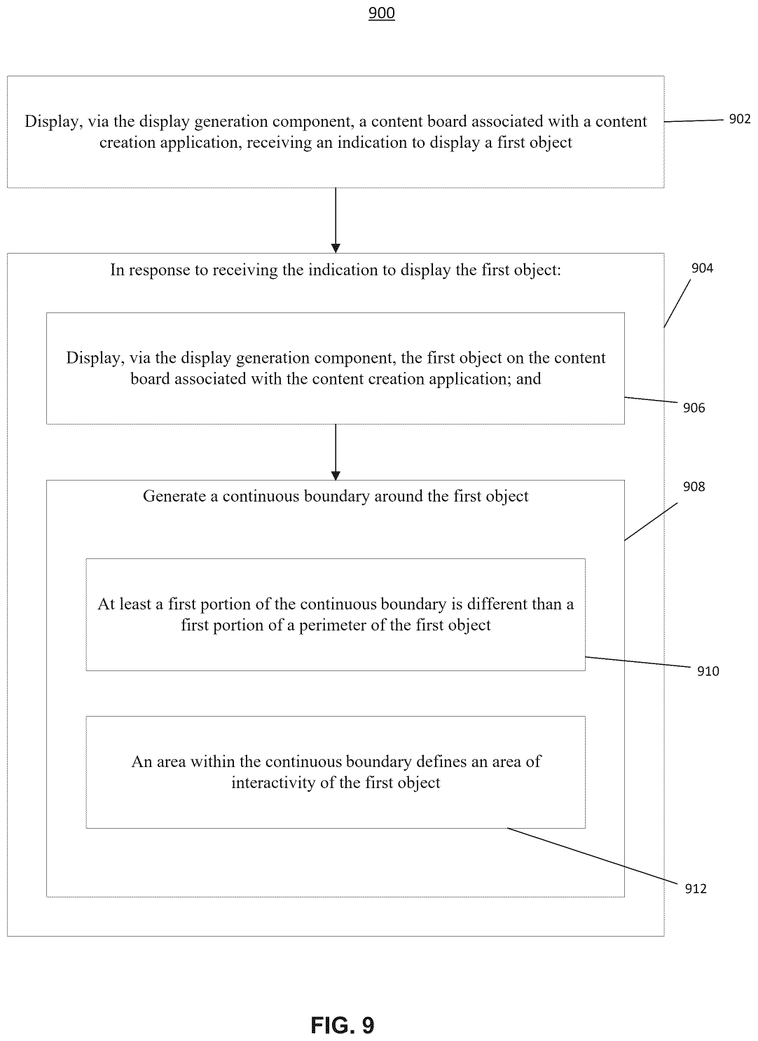

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, and 900 (FIGS. 7, and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5I. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

FIG. 5I illustrates a block diagram of an exemplary architecture for the device 580 according to some embodiments of the disclosure. In the embodiment of FIG. 5I, media or other content is optionally received by device 580 via network interface 582, which is optionally a wireless or wired connection. The one or more processors 584 optionally execute any number of programs stored in memory 586 or storage, which optionally includes instructions to perform one or more of the methods and/or processes described herein (e.g., methods 700, 900, 1100, 1300, 1500, and 1700).

In some embodiments, display controller 588 causes the various user interfaces of the disclosure to be displayed on display 594. Further, input to device 580 is optionally provided by remote 590 via remote interface 592, which is optionally a wireless or a wired connection. In some embodiments, input to device 580 is provided by a multifunction device 591 (e.g., a smartphone) on which a remote control application is running that configures the multifunction device to simulate remote control functionality, as will be described in more detail below. In some embodiments, multifunction device 591 corresponds to one or more of device 100 in FIGS. 1A and 2, device 300 in FIG. 3A, and device 500 in FIG. 5A. It is understood that the embodiment of FIG. 5I is not meant to limit the features of the device of the disclosure, and that other components to facilitate other features described in the disclosure are optionally included in the architecture of FIG. 5I as well. In some embodiments, device 580 optionally corresponds to one or more of multifunction device 100 in FIGS. 1A and 2, device 300 in FIG. 3A, and device 500 in FIG. 5A; network interface 582 optionally corresponds to one or more of RF circuitry 108, external port 124, and peripherals interface 118 in FIGS. 1A and 2, and network communications interface 360 in FIG. 3A; processor 584 optionally corresponds to one or more of processor(s) 120 in FIG. 1A and CPU(s) 310 in FIG. 3A; display controller 588 optionally corresponds to one or more of display controller 156 in FIG. 1A and I/O interface 330 in FIG. 3A; memory 586 optionally corresponds to one or more of memory 102 in FIG. 1A and memory 370 in FIG. 3A; remote interface 592 optionally corresponds to one or more of peripherals interface 118, and I/O subsystem 106 (and/or its components) in FIG. 1A, and I/O interface 330 in FIG. 3A; remote 590 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3A, and touch-sensitive surface 451 in FIG. 4; and, display 594 optionally corresponds to one or more of touch-sensitive display system 112 in FIGS. 1A and 2, and display 340 in FIG. 3A.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Content Board Scene Generation and Interaction

Users interact with electronic devices in many different manners, including interacting with content creation applications for creating visual content such as drawings, paintings, and textual content. In some embodiments, content creation applications include content boards. Content boards optionally include an amalgamation of visual content and/or textual content that are laid out on a digital canvas thus giving users the ability to share, see, and collaborate on projects involving the visual content. In some embodiments, while interacting with a content board, including viewing a particular portion of a content at a particular zoom level, the user may want to have the ability to return to the exact view of the content board that they are currently viewing at a later time. Currently, a user who wishes to return to a particular view of the content board must manually navigate to the specific portion of the content board and set the zoom level to the specific zoom level so as to recreate the view. Such a process can be inefficient and cumbersome, especially in contexts where the user would like to quickly bring up a specific view of the content board. For instance, if the user were giving a presentation using the content board, and the user wanted to direct the audience's attention to a specific portion of the content board displayed at a particular zoom level, the user would have to manually navigate to the portion of the content board that they wish to display, and also would have to possibly manually adjust the zoom level so as to show the audience of the presentation the exact portion of the content board they wish to present on. In some embodiments, if the presentation included multiple views of the content board, then navigating to each view (e.g., scene) manually would be a cumbersome and inefficient process.

In some embodiments, rather than manually navigating to a particular region of a content board and modifying the zoom level to view a particular portion of a content board, the user can create and store a content board scene. In some embodiments, a content board scene refers to a particular view of a content board (e.g., a particular region/location at a particular zoom level) that when stored on an electronic device can be recalled such that when recalled, the electronic device displays the content board according to the location and zoom level associated with the content board scene.

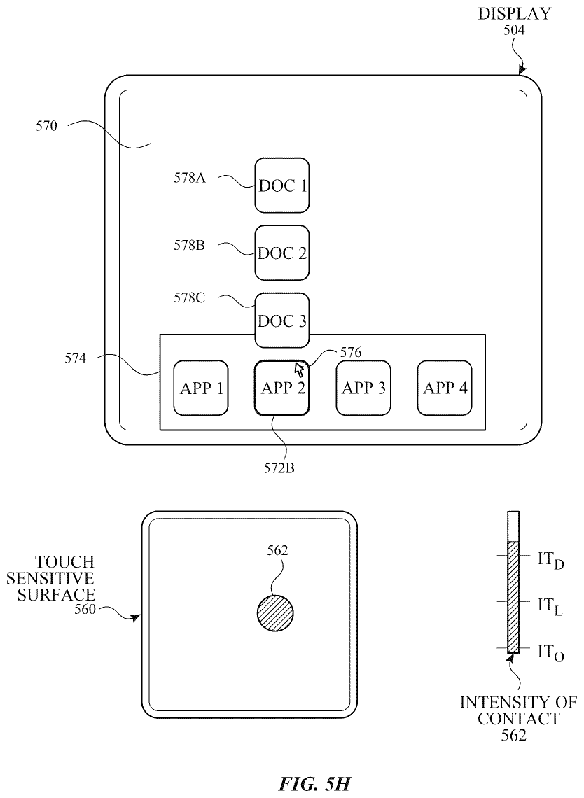

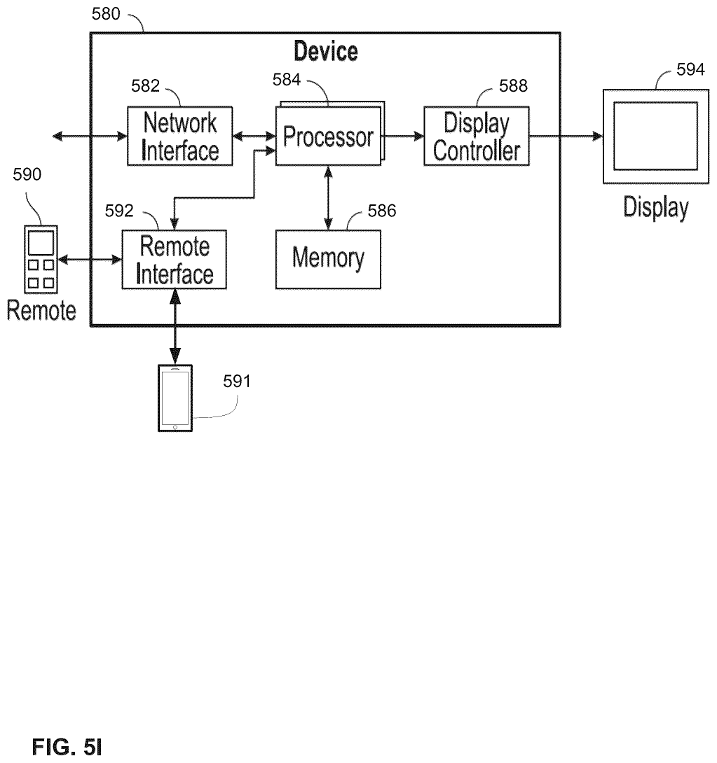

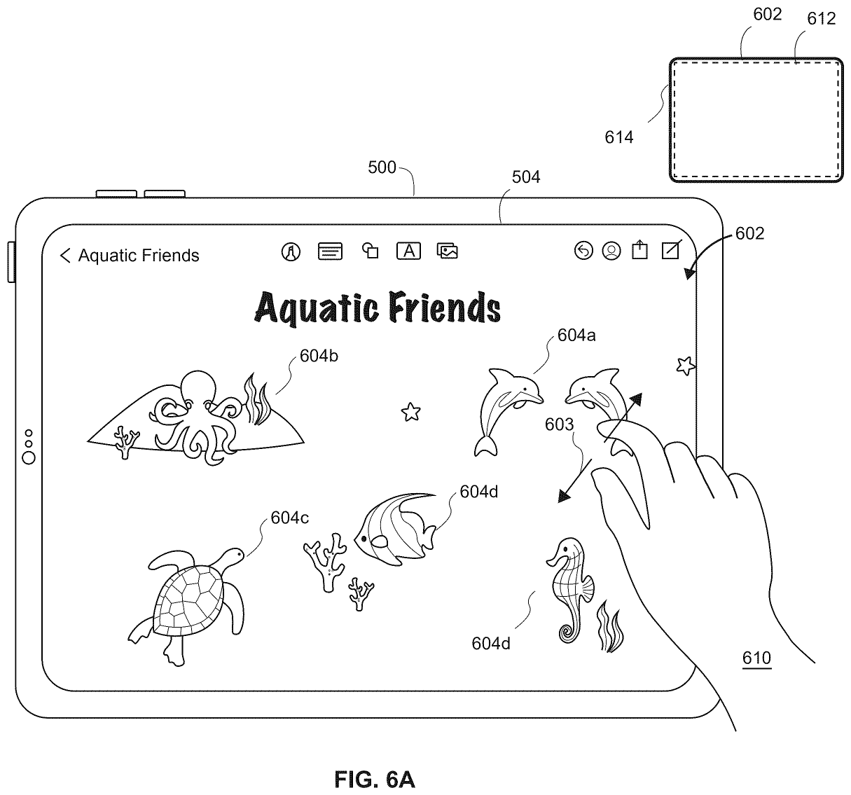

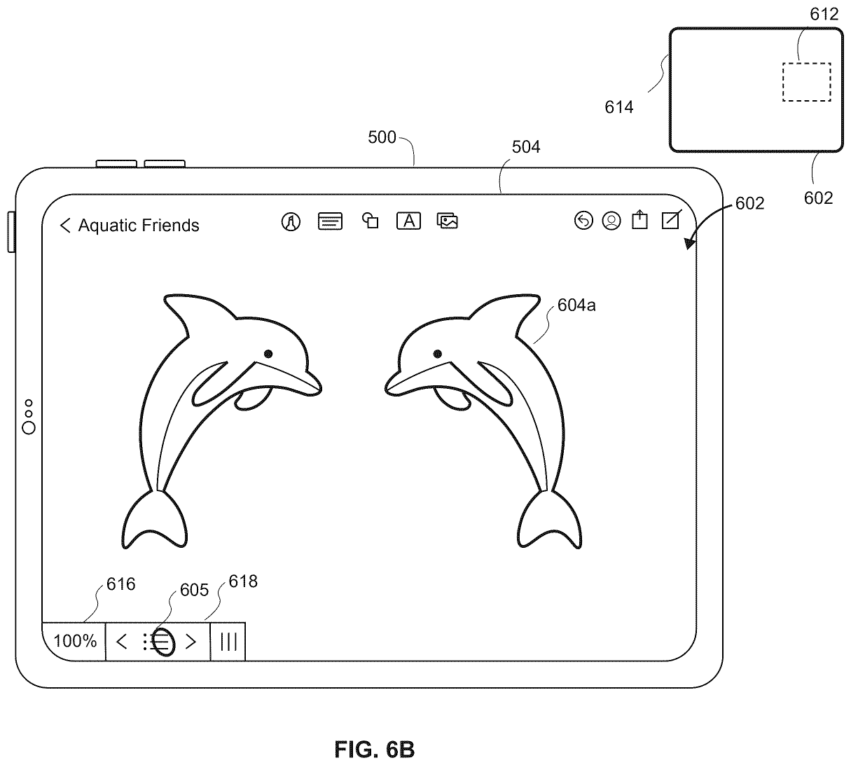

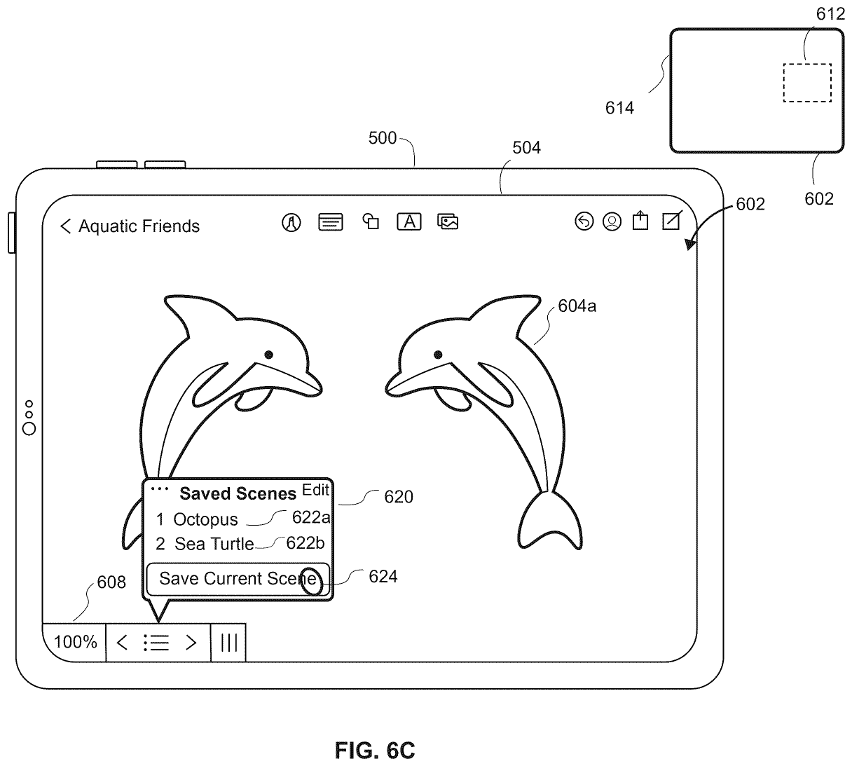

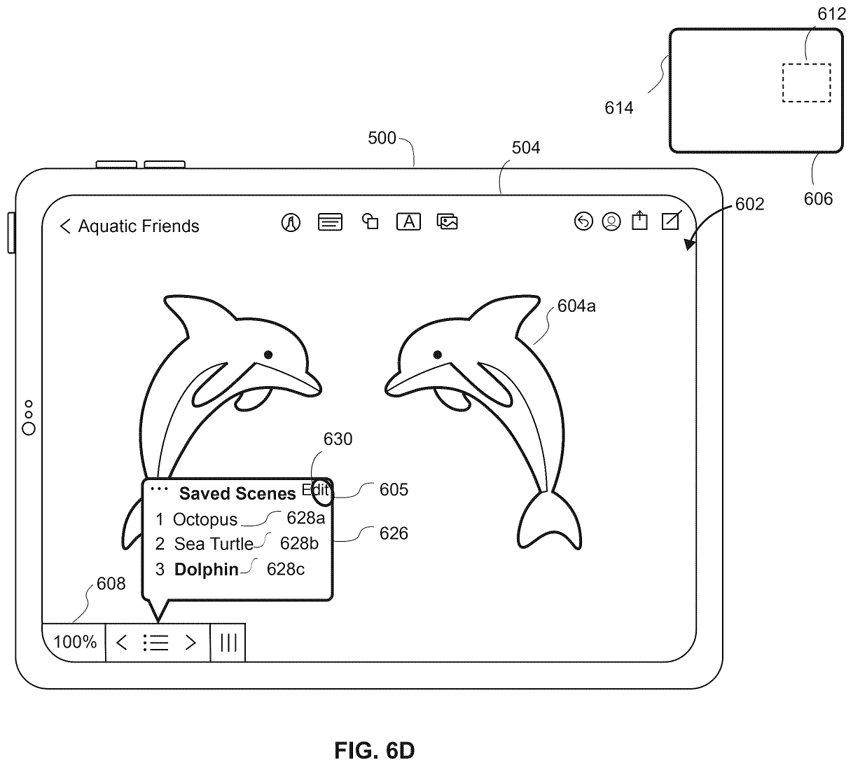

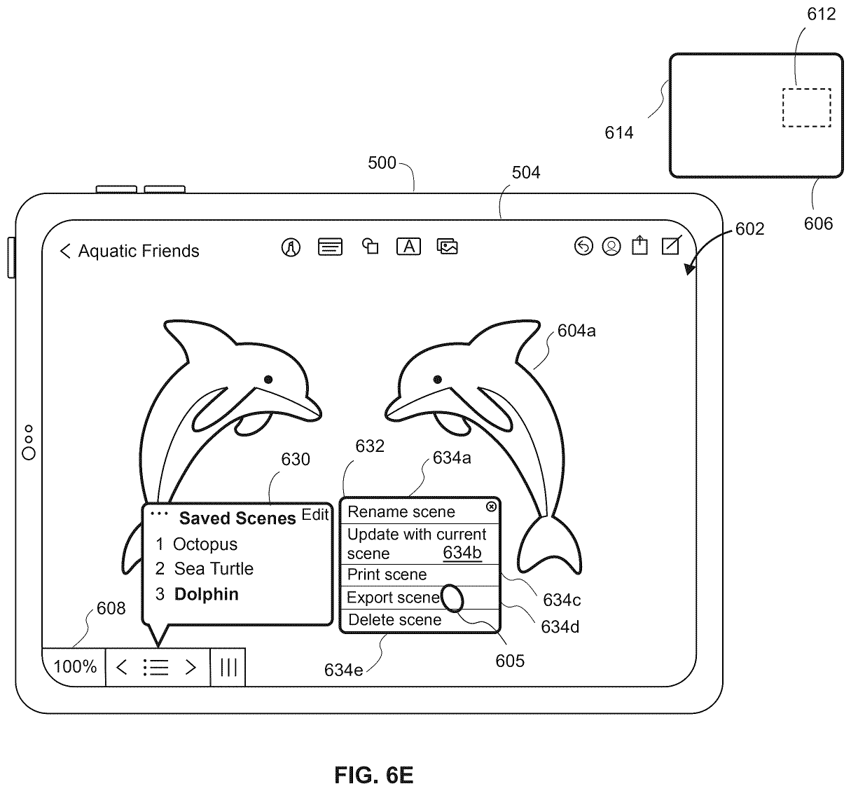

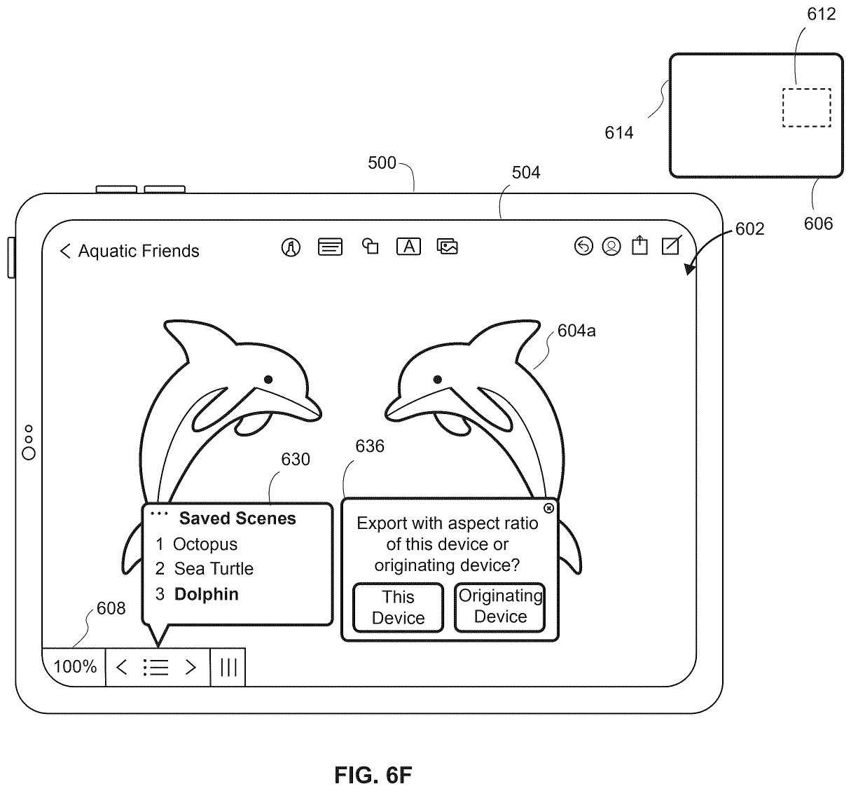

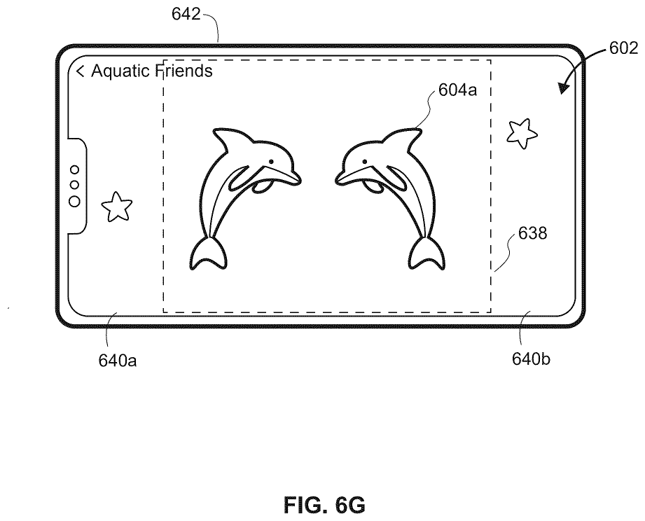

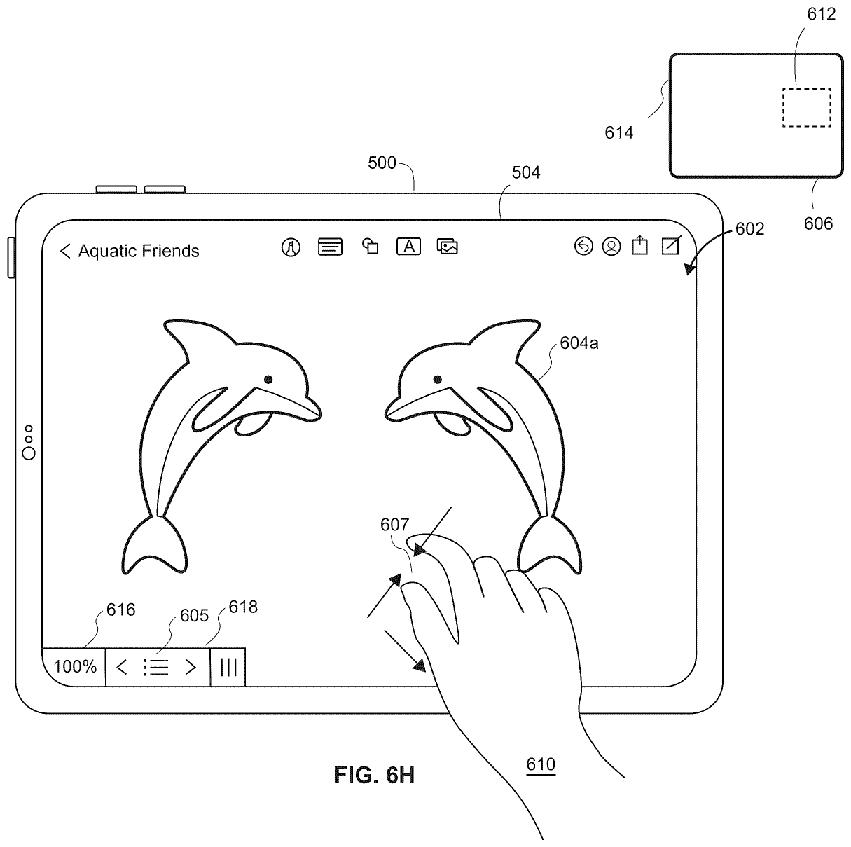

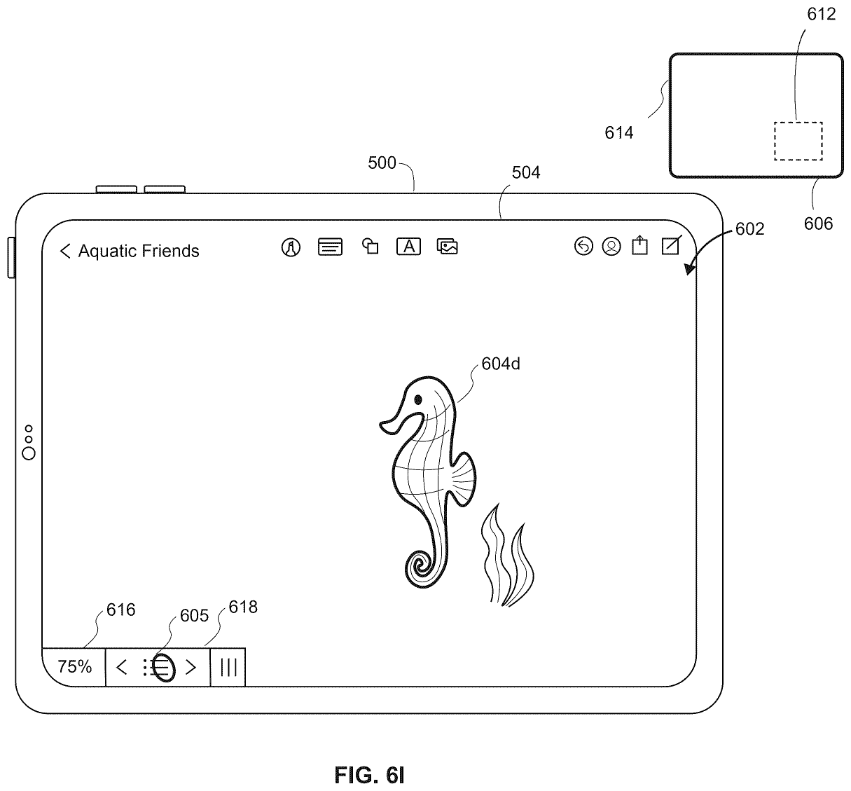

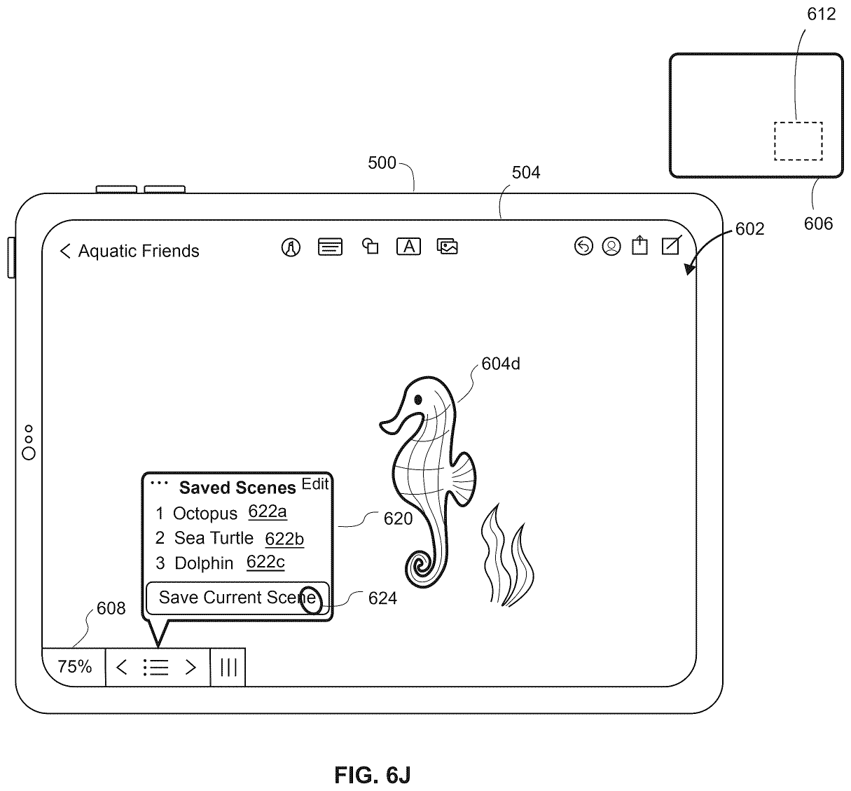

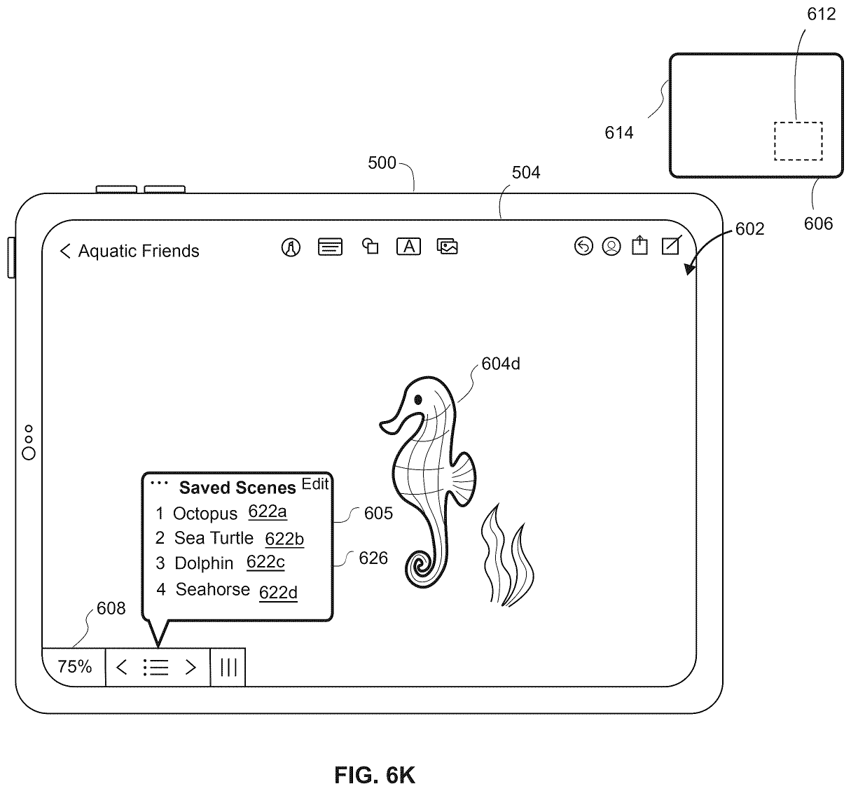

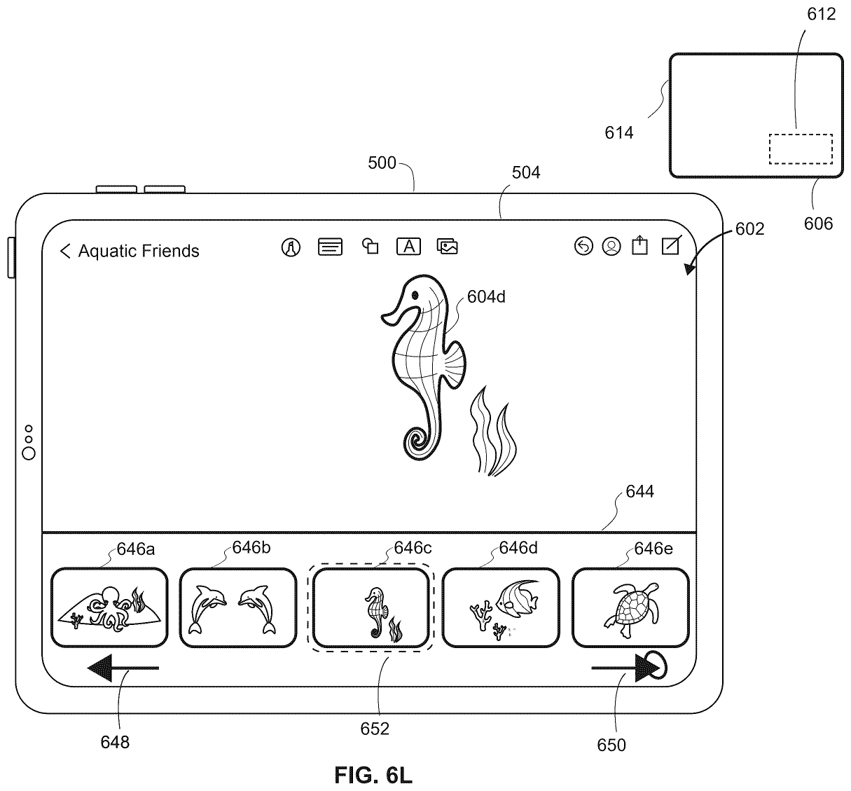

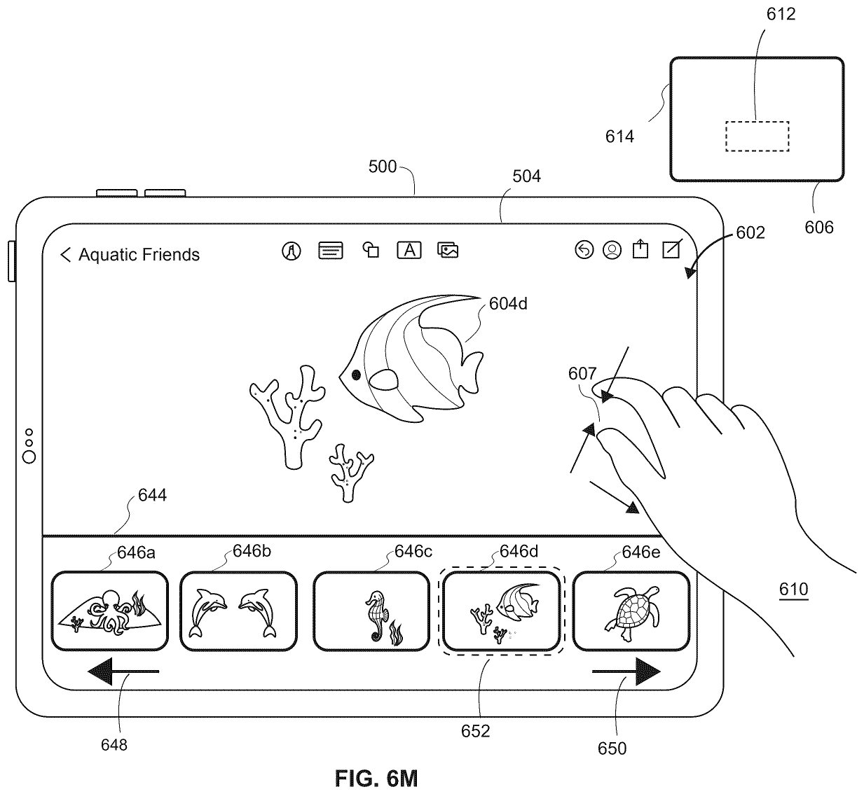

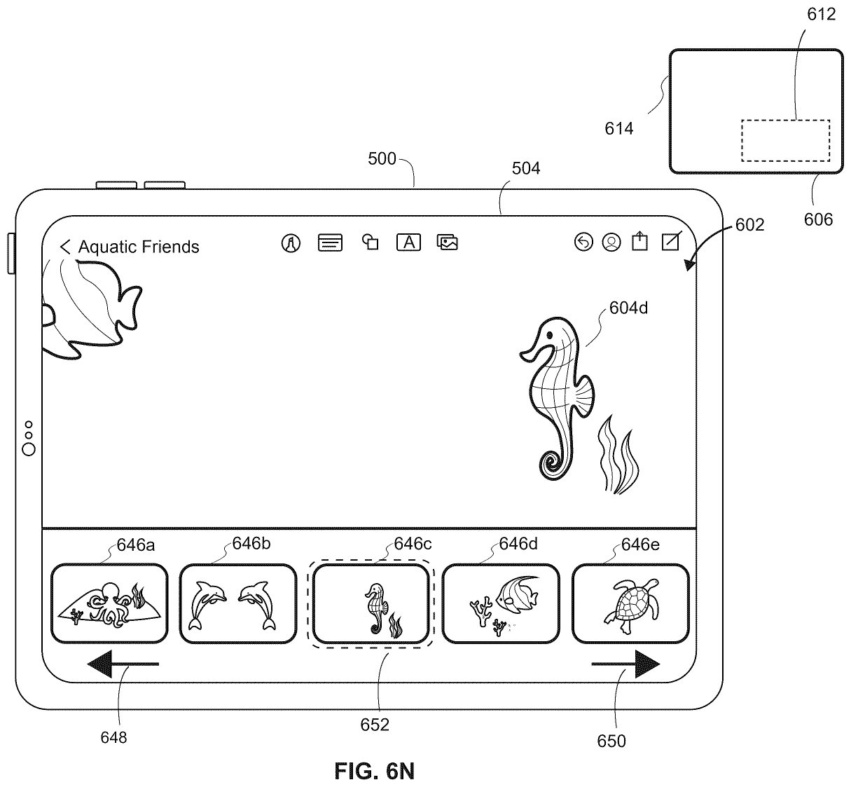

FIGS. 6A-60 illustrate examples of an electronic device displaying one or more user interfaces associated with generating, managing, and displaying content board scenes to enable efficient interactions between a user and a content board of a content creation application. The embodiments in these figures are used to illustrate the processes described below, including the processes described with reference to FIG. 7. Although FIGS. 6A-60 illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-60.

FIG. 6A illustrates an exemplary device 500 displaying a content board 602 associated with a content creation application. In some embodiments, the content board 602 is displayed via a display generation component. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, and as illustrated in FIG. 6A, content board 602 includes one more visual content objects 604a-d that collectively form the content board 602. For instance, in the example of FIG. 6A, the content board labeled “Aquatic Friends” includes various images of aquatic animals that collectively make up the content board. In some examples, when the content board 602 is sufficiently zoomed out, the entirety of the content board 602 is visible as illustrated in view 614. In view 614, the content board 602 and the visible area of the content board 612 (e.g., the portion of the content board that is visible on display generation component 540) are the same, meaning that every portion of the content board 602 is visible on display generation component 540. In some embodiments, the user (for instance using one or more fingers of hand 610) can change which portion of content board is visible on display generation component 540. For instance, using a pinching gesture 603 at a particular location on content board 602, device 500 displays a zoomed in portion of the content board 602 as illustrated in FIG. 6B.

In the example of FIG. 6B, in response to detecting pinching gesture 603 and in accordance with the area of the content board 602 that the gesture 603 is performed at device 500 displays via display generation component 540. As illustrated in view 614, visible portion 612 of content board 602 has changed to coincide with the location and zoom level that device 500 is displaying in response to pinch gesture 603 such that only a portion of content board 602 is now visible. In some embodiments, in response to displaying visible portion 612, device 500 displays a content board scene user interface 608 that as explained in further detail below, allows for the user to create a content board scene. In some embodiments, content board scene user interface 608 includes a zoom visual indicator 616 that displays the current zoom level of the content board 602. Optionally, content board scene user interface includes selectable option 618, which when device 500 detects that selectable option 618 has been selected by the user, provides the user with one or more options for generating and/or modifying content board scenes.

In some embodiments, in response to detecting selection of selectable option 618 (for instance in response to detecting that the user has applied an input 605 to selectable option 618), device 500 displays a content board scene editing user interface as illustrated in FIG. 6C. In the example of FIG. 6C, in response to detecting selection of selectable option 618, device 500 displays content board scene editing user interface 620. As illustrated in FIG. 6C, content board scene editing user interface 620 includes one or more selectable options 622a-b and 624 for interacting with content board scenes that have already been stored on electronic device 500 and/or generating a new content board scene. For instance, selectable options 622a-b pertain to content board scenes “Octopus” and “Sea Turtle” that have already been saved on device 500, and upon detecting selection of either 622a or 622b, device 500 displays one or more additional user interfaces that are configured to allow the user to display and/or modify the already saved scenes. Additionally and/or alternatively, content board scene editing user interface 620 includes selectable option 624 that causes device 500 to store a new scene based on the current visible area 612 of content board 602 when the device 500 detects selection of selectable option 624 (for instance by detecting an input 605 received at the selectable option 624) as illustrated in FIG. 6D.

In the example of FIG. 6D, in response to detecting selection of selectable option 624, device 500 displays content board scene list user interface 626, which includes a listing of the content board scenes 628a-c saved on device 500, including content board scene 628c (labeled as “Dolphin”) which is stored by device 500 in response to detecting selection of selectable option 624. In some embodiments, storing a content board scene includes storing the location and zoom level of a particular view of a content board such that when recalled from memory, device 500 displays the exact portion of the content board at the same level of zoom as when the scene was created. In some embodiments, content board scene list user interface 626 includes selectable option 630 for editing a saved content board scene. For instance, in response detecting selection of selectable option 630 (for instance by detecting an input 605 provided by the user) and while the “Dolphin” content board scene 628c is highlighted (indicating that it is the active content board scene), device 500 displays a content board scene editing user interface 632 as illustrated in FIG. 6E.

In the example of FIG. 6E, device 500 displays content board scene editing user interface 632 in response to detecting that selectable option 630 has been selected. In some embodiments, content board scene editing user interface 632 includes one or more selectable options 634a-e for editing and/or performing an operation on a saved content board scene. For instance, content board scene editing user interface 632 includes selectable option 634a for renaming a saved scene, selectable option 634b for updating a saved scene with the current location and zoom level that the content board is displayed at, selectable option 634c for printing a saved scene (which includes similar features to exporting a scene that is described further below (e.g., the ability to select that aspect ratio of the printed product), selectable option 634d for exporting a scene (described in further detail below) and selectable option 634e for deleting a saved scene.

In some embodiments, device 500 is able to export a scene (e.g., transmit a content board scene to an external device, print to a printer, and/or saving as/exporting to a portable document format (pdf)) in response to determining that selectable option 634d for exporting a scene has been selected. For instance, in response to determining that selectable option 634d has been selected (for instance upon detecting a touch input 605 applied to selectable option 634d), the electronic device initiates a process to export/transmit the saved content board scene as illustrated in FIG. 6F. In the example of FIG. 6F, and in response to detecting selection of selectable option 634d, device 500 displays user interface 636. In some embodiments, user interface 636 is configured to prompt the user to decide whether to export the content board scene using the aspect ratio of the device 500 (e.g., display generation component 540) or to instead use the aspect ratio of the originating device (e.g., the device on which the content board scene was originally created). In the example of FIG. 6F, since the dolphin content board scene was originally created and is being exported from the same device, the aspect ratios associated with the selectable options of user interface 636 will be the same. However, in the instance where the originating device and the device that is exporting a scene are different, the aspect ratios associated with the selectable options of user interface 636 are optionally different as well. In some embodiments, and in the example where the scene is being exported to another device, the scene is displayed on the other device according to aspect ratio of the transmitting device or the originating device based on the selection of the user who is transmitting the scene as described above.

In some embodiments, when a content board scene is exported to an external device and/or printed, and in the example where the device 500 exports the content board scene to be displayed according to the aspect ratio of the originating device and/or the device that is exporting the scene (as described with respect to FIG. 6F), the appearance of the content board scene can be different on the recipient device than it appeared on the transmitting device as illustrated in FIG. 6G. In the example of FIG. 6G, when the content board scene that was exported from device 500 is displayed on a device 642 that has an aspect ratio that is greater than the aspect ratio of display 540 (e.g., the ratio of the width to the height of the display of device 642 is greater than that of display 540 of device 500), the exported content scene may be displayed with portions of the content board that were not part of the content board scene that was exported. For instance, as illustrated in FIG. 6G, the original content board scene was displayed according to aspect ratio 638 such that only the dolphins 604a were visible on display 540 when device 500 displayed the content board scene. However, since device 642 has a larger aspect ratio, portions 640a and 640b of content board 602 are now also visible when the content board scene is displayed since the content board scene is being displayed according to the aspect ratio of the receiving device (e.g., device 642).

In some embodiments, device 500 enables the creation of multiple scenes as illustrated in FIGS. 6H-6K. In the example of FIG. 6H, while device 500 displays a portion of content board 602 (e.g., the visible portion 612 of content board 602), device 500 detects input 607 (e.g., a pinch input from hand 610 followed by movement of hand 610) and in response navigates to a location on the content board and at a zoom level that is commensurate with input 607 as illustrated in FIG. 6I.

As illustrated in FIG. 6I, in response to input 607 (from FIG. 6H), device 500 changes the visible portion 612 of content board 602 and displays a new portion of content board 602 at a new zoom level 616. Similar to the example of FIGS. 6A-6D, device 500 initiates a process to store a new content board scene in response to receiving an input 605 on content board scene user interface 608. In response to receiving input 605 at content board scene user interface 608, device 500 initiates the process to store a new content board scene by displaying content board scene editing user interface 620 as illustrated in FIG. 6J.

As illustrated in FIG. 6J (and similar to the example of FIG. 6C), device 500 displays content board scene editing user interface 620 which includes selectable option 624 for saving the current scene (e.g., the visible portion 612 of content board that is being displayed on device 500 at the current moment). Similar to the example of FIG. 6D, and in response to detecting selection of selectable option 624 (e.g., via a tap input at selectable option 624), device 500 stores the current view of the content board as a new content board scene as illustrated in FIG. 6K. In the example of FIG. 6K, device 500 displays content board scene list user interface 626 that lists the currently saved content board scenes including content board scene 622c (that was previously stored in the example of FIG. 6D) as well as content board scene 622d (labeled “Seahorse”) which represents the current scene that was just saved to device 500.

In some embodiments, a user can navigate between scenes using content board scene list user interface 626, for instance by selecting one or more of selectable options pertaining to content board scenes 622a-d. Alternatively, device 500 displays a content board scene navigation user interface that provides a visual interface for navigating between scenes as illustrated in FIG. 6L. In the example of FIG. 6L, device 500 displays content board scene navigation user interface 644 that the user can interact with to navigate between one or more content board scenes that are stored on device 500. In some embodiments, content board scene navigation user interface 644 includes one or more selectable options 646a-e, with each selectable option pertaining to a content board scene that is saved on device 500. In some embodiments, device 500 displays a visual representation at or on selectable options 646a-e, with each visual representation including a miniaturized (e.g., thumbnail) version of the content board scene that the selectable option 646a-e pertains to. For instance as illustrated in FIG. 6L, selectable option 646b includes a representation of the “Dolphins” content board scene that was previously stored on device 500 (discussed in relation to FIGS. 6A-6E), and also includes selectable option 646c which pertains to the “Seahorse” content board scene previously stored on device 500 (discussed in relation to FIGS. 6I-6K).

In some embodiments, device 500 displays a visual indicator 652 on or near a selectable option of selectable options 646a-e of content board scene user interface 644, when the content board scene associated with a selectable option is being displayed on display 540. For instance, as illustrated in FIG. 6L, device 500 displays a visual indicator 652 around selectable option 646c in response to determining that the content board scene “Seahorses” is being displayed on display 540. In some embodiments, visual indicator 652 is displayed even if more than just the content board scene associated with the selectable option is being displayed (e.g., the content board scene is within visible portion 612 along with other portions of content board 602).

In some embodiments, the order in which selectable options 646a-e are displayed on content board scene navigation user interface 644 is based on the relative locations of the scenes on content board 602 and their relative proximity to one another. For instance, referring back to FIG. 6A, starting from the left upper corner of content board 602, the octopus 604b (which pertains to a first content board scene) is closes to the “Dolphins” content board scene (which includes dolphins 604a), thus as illustrated in FIG. 6L, selectable option 646a (pertaining to the Octopus content board scene) is next to selectable option 646b (pertaining to the dolphins content board scene). Similarly as illustrated in FIG. 6A, the Seahorse content board scene (described above) is next to the Dolphins content board scene and thus device 500 displays selectable option 646c (pertaining to the “Seahorse” content board scene) next to selectable option 646b.

In some embodiments, content board scene navigation user interface 644 includes one or more scene navigation selectable options 648 and 650 for navigating between different content board scenes that are stored on device 500. In some embodiments selectable options 648 and 650 are configured to allow the user to navigation backwards (e.g., to the left) and forwards (e.g., to the right) between the content board scenes that are displayed on content board scene navigation user interface 644 in the order that the content board scenes (e.g., selectable options 646a-e that pertain to the content board scenes) are displayed on content board scene navigation user interface 644. For instance in response to detecting input 605 (e.g., a tap input with a finger of the user), device 500 displays the content board scene associated with selectable option 646d (e.g., the “Fish” content board scene) as illustrated in FIG. 6M.

As illustrated in FIG. 6M, device 500 displays the content board scene associated with selectable option 646d in response to detecting an input at selectable option 650 (device 500 also displays visual indicator 652 around selectable option 646d in response to the content board scene pertaining to selectable option 646d being displayed). In some embodiments, device 500 displays the content board scene pertaining to selectable option 646d using the exact location and zoom level to display the content board scene in the exact same manner that it was displayed when the content board scene was created. In some embodiments, even when the user is navigating between scenes using content board scene navigation user interface 644, device 500 still accepts manual inputs from the user to navigate to other portions of the content board 602 without requiring interaction with content board scene navigation user interface 644. For instance in response to detecting input 607 (e.g., a pinch input followed by motion of hand 610) device 500 displays another portion of content board 602 as illustrated in FIG. 6N.

In the example of FIG. 6N, as the content board scene pertaining to seahorse 604d is displayed in the portion 612 of content board 602 in response to input 607, device 500 displays visual indicator 652 around selectable option 646c. As illustrated in FIG. 6N, even though additional portions of content board 602 are within the visible portion 612 of content board 602, since the content board scene pertaining to selectable option 646c is also visible, device 500 displays visual indicator 652 around selectable option 646c. As described above, the order in which selectable options 646a-e are displayed can be displayed by device 500 based on different factors. For instance, while in the example of FIGS. 6L-6N, the order is based on location/proximity, in some embodiments the order can be based on other factors such as the order in which the content board scenes were created as illustrated in FIG. 6O.

In the example of FIG. 6O, device 500 displays selectable options 646a-e in a different order than in FIGS. 6L-6N, since the ordering in FIG. 6O is based on the order in which the content board scenes were created, whereas in FIGS. 6L-6N, the order is based on location/proximity of the content board scenes with respect to content board 602.

FIG. 7 is a flow diagram illustrating a method 700 for generating and interacting with content board scenes, in accordance with some embodiments. The method 700 is optionally performed at an electronic device such as device 100, device 300, device 500 or device 580, as described above with reference to FIGS. 1A-1B, 2-3, 4A-4B and 5A-5I. Some operations in method 700 are, optionally combined and/or order of some operations is, optionally, changed.

In some embodiments, method 700 is performed at an electronic device in communication with a display generation component and one or more input devices. For example, the electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the electronic device is part of a computer system that is part of a wearable device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while displaying, via the display generation component, a content board associated with a content creation application (702), the electronic device receives (704), via the one or more input devices, an indication to generate a content board scene associated with the content board such as selection of selectable option 624 to scene editing user interface 620 in FIG. 6C. In some embodiments, the content creation application is one or more of a word processing application, a note taking application, an image management application, a digital content management application, a drawing application, a presentation application, a spreadsheet application, a messaging application, a web browsing application, and/or an email application. In some embodiments, the content board associated with the content creation application refers to any user interface that a user of the electronic device utilizes to enter content into the content creation application (e.g., a content entry field, area or region). In some embodiments, the content board can be zoomed in and out by the user such that a portion of the content board may not be visible when the content board is displayed by the display generation component (e.g., is outside of the rendering area or field of view of the display generation component). In some embodiments, the content creation application is configured to receive input from a user, via the one or more input devices of the electronic device, that allows the user to navigate (e.g., via zooming and/or panning) which portions of the content board are visible at the display generation component. For instance, the user can zoom the content board in and out as described above, and additionally can scroll (e.g., pan) the content board on the display generation component (e.g., move the content board on the display) so that a different portion of the content board is visible at the display generation component, such as scrolling in horizontal and/or vertical directions. In some embodiments the content board associated with the content creation application is collaborative, meaning that multiple users (each using their own electronic device) can edit the same content board using their own device. In some embodiments, a content board scene refers to a specific portion of the content board at specific zoom level (described below) that is saved in a memory of the electronic device for later recall by the content creation application. In some embodiments, the content board scene is generated based on the portion of the content board that is displayed on the display generation component at the time that the indication to generate the content board scene is received. In some embodiments, the indication to generate the content board scene is received at a content board scene editing user interface that is configured to allow a user of the electronic device to add, modify, and/or delete saved content board scenes. In some embodiments, the content board scene editing user interface includes one or more selectable options that when selected, generates a content board scene (e.g., save the content board scene to the memory of the electronic device) based on the portion of the content board that is visible on the display at the time that the selectable option of the content board scene editing user interface is selected. In some embodiments, the indication to generate a content board scene includes detecting that the user has selected a physical button on the device, or a selectable option on a user interface indicating a request to generate a scene. In some embodiments, the indication to generate a content board scene does not define the parameters (e.g., location and zoom level) associated with the scene. Instead, the one or more parameters associated with the scene are based on other user inputs/indications associated with panning the content board and/or zooming in and out of the content board.

In some embodiments, in response to receiving the indication to generate the respective content board scene (706), in accordance with a first region of the content board being displayed at a first zoom level when the indication to generate the content board scene is received, the electronic device generates (708) a first content board scene such as the “Dolphin” content board scene generated in FIGS. 6A-6D. In some embodiments, the generated content board scene (generated in response to the receiving the indication) is based on the portion (e.g., region) of the content board being displayed at the time the indication was received, as well as the zoom level (e.g., how zoomed in or out) of the content board at the time the indication was received. Thus, in some embodiments, at the time that the indication to generate a content board scene is received, the computer system optionally stores location and/or zoom information associated with the displayed portion of the content board at the time the indication was received. In some embodiments, when a content board scene is recalled from the memory (described in further detail below), the computer system utilizes the stored location and/or zoom information to display the content board scene. As each content board scene is based on the specific location and/or zoom level of the content board at the time the scene is created, each specific combination of location and/or zoom level associated with the content board is associated with a different content board scene.

In some embodiments, in accordance with a second region, different from the first region, of the content board being displayed at the first zoom level when the indication to generate the respective content board scene is received, the electronic device generates a second content board scene different from the first content board scene such as the “Seahorse” content board scene generated in FIGS. 6I-6K. In some embodiments, the second content board scene has one or more analogous characteristics as the first content board scene. In some embodiments, when the first content board scene is generated (e.g., when the indication to create the first content board scene is received), the second region is not being displayed by the electronic device. Similarly, in some embodiments, when the second content board scene is generated (e.g., when the indication to create the second content board scene is received), the first region is not being displayed by the electronic device. Enabling the user to generate content board scenes based on a currently displayed portion of a content board associated with a content creation application, allows the computer system to more efficiently create scenes by minimizing the amount of user input necessary to create a scene thus conserving computing resources associated with the user's input.

In some embodiments, in response to receiving the indication to generate the respective content board scene: in accordance with the second region, different from the first region, of the content board being displayed at a second zoom level, different from the first zoom level, when the indication to generate the respective content board scene is received, the electronic devices generates a third content board scene different from the first content board scene and different from the second content board scene such as the “Seahorse” content board scene generated in FIGS. 6I-6K. In some embodiments, the third content board scene has one or more characteristics of the first and/or second content board scenes described above. In some embodiments, each scene stored on the electronic device corresponds to a unique combination of a particular region of the content board being displayed at a particular zoom level. Thus, in some embodiments, two different scenes include the same region of the content board, but are displayed at two different zoom levels. In some embodiments, two different scenes include the same zoom level, but correspond to two different regions of the content board. In some embodiments, while displaying a first scene, if the device detects that the user adjusts the zoom level while displaying the first scene, and then detects an indication to generate a second scene, the device generates the second scene with the same region as the first scene but at adjusted zoom level. Enabling the user to generate content board scenes based on a currently displayed portion of a content board associated with a content creation application including at different zoom levels, allows the computer system to more efficiently create scenes by minimizing the amount of user input necessary to create a scene thus conserving computing resources associated with the user's input.

In some embodiments, in accordance with the display generation component of the electronic device having a first aspect ratio, the first content board scene has the first aspect ratio. In some embodiments, in accordance with the display generation component of the electronic device having a second aspect ratio, different from the first aspect ratio, the first content board scene has the second aspect ratio. For instance, the “Dolphins” content board scene is displayed with an aspect ratio that matches the aspect ratio of display 540 in FIG. 6D. In some embodiments, the aspect ratio of the electronic device refers to the ratio between the length of the display generation component of the device to the width of the display generation component of the device. In some embodiments, the aspect ratio of the content board scene refers to the ratio between the length of the content board scene to the width of the content board scene. In some embodiments, displaying the content board scene using the aspect ratio of display of the device refers to displaying the content board scene using an aspect ratio that is based on the aspect ratio of the device. For instance, the content board scene is displayed using the same aspect ratio as the display of the device. Additionally or alternatively, the content board scene is displayed according to some predetermined multiple of the aspect ratio of the device (e.g., 0.1, 0.5, 0.75, 2, 10). In some embodiments, the aspect ratio of the first region (or second region) that makes up the first content board scene (or second content board scene) corresponds to (e.g., is the same as) the aspect ratio of the display generation component and/or display region displayed by the display generation component. Displaying the content board scene in accordance with the aspect ratio of the device used to capture the content board scene minimizes the likelihood that one or more portions of the content board scene are not visible when being displayed on the electronic device due to a mismatch between the aspect ratio of the capturing device and the aspect ratio of the displaying device, thus conserving computing resources associated with correcting erroneous user input associated with parts of the content board scene not being visible. Furthermore, displaying the content board scene in accordance with the aspect ratio of the device used to capture the content board scene simplifies the process of generating a content board scene because the user is not required to provide seperate input to define the aspect ratio, thereby conserving further computing resources.

In some embodiments, the first region is displayed on a user interface of the content creation application, and an aspect ratio of the first content board scene is based on an aspect ratio of the of the user interface of the content creation application such as if the user interface of the content creation application was different than the aspect ratio of display 540 and the “Dolphin” content board scene was displayed according to the aspect ratio of the user interface in FIG. 6D. In some embodiments, the aspect ratio of the user interface refers to the ratio between the length of the user interface to the width of the user interface (as displayed on the electronic device). In some embodiments, the aspect ratio of the user interface of the content creation application is different from the aspect ratio of the display generation component of the electronic device even though the user interface is being displayed on the electronic device. Alternatively, the aspect ratio of the user interface is the same as the aspect ratio of the display generation component of the electronic device (for instance if the user interface occupies the entirety of the display generation component of the electronic device). In some embodiments, displaying the content board scene using the aspect ratio of user interface of the content creation application refers to displaying the content board scene using an aspect ratio that is based on the aspect ratio of the user interface. For instance, the content board scene is displayed using the same aspect ratio as the user interface. Additionally or alternatively, the content board scene is displayed according to some predetermined multiple of the aspect ratio of the user interface (e.g., 0.1, 0.5, 0.75, 2, 10). In some embodiments, the aspect ratio of the first region (or second region) that makes up the first content board scene (or second content board scene) corresponds to (e.g., is the same as) the aspect ratio of the user interface of the content creation application. In some embodiments, if the user interface has a first aspect ratio, then the first content board scene has the first aspect ratio. If the user interface has a third aspect ratio, different from the first aspect ratio, then the first content board scene has the third aspect ratio. In some embodiments, the same electronic device creates scenes having different aspect ratios at different times, due to for instance, the user interface of the content having its aspect ratio changed during interaction or use of the content creation application (e.g., in response to user input). Displaying the content board scene in accordance with the aspect ratio of the user interface of the content creation application minimizes the likelihood that one or more portions of the content board scene are not visible when being displayed on the electronic device due to a mismatch between the aspect ratio of the user interface and the aspect ratio of the displaying device, thus conserving computing resources associated with correcting erroneous user input associated with parts of the content board scene not being visible. Furthermore, displaying the content board scene in accordance with the aspect ratio of the user interface of the content creation application simplifies the process of generating a content board scene because the user is not required to provide sperate input to define the aspect ratio, thereby conserving further computing resources.

In some embodiments, the electronic device receives, via the one or more input devices, an indication to display a third content board scene (e.g., the first or second content board scenes, or a different content board scene) via the display generation component of the electronic device. In some embodiments, in response to receiving the indication to display the third content board scene, the electronic device displays the third content board scene with an aspect ratio that is based on an aspect ratio of the display generation component of the electronic device such the “Dolphin” content board scene being displayed according to the aspect ratio of the display of device 642 in FIG. 6G. In some embodiments, the aspect ratio of the display generation component refers to the ratio between the length of the display generation component to the width of the width of the display generation component. In some embodiments, displaying the content board scene using the aspect ratio of the display generation component displaying the content board scene refers to displaying the content board scene using an aspect ratio that is based on the aspect ratio of the display generation component. For instance, the content board scene is displayed using the same aspect ratio as the display generation component. Additionally or alternatively, the content board scene is displayed according to some predetermined multiple of the aspect ratio of the display generation component (e.g., 0.1, 0.5, 0.75, 2, 10). In some embodiments, the aspect ratio of the display generation component of the electronic device is different from the aspect ratio of the device that originally generated/created the third content board scene. Displaying the content board scene in accordance with the aspect ratio of the display generation component of the electronic device displaying the content board scene minimizes the likelihood that one or more portions of the content board scene are not visible when being displayed on the electronic device due to a mismatch between the aspect ratio of the user interface and the aspect ratio of the displaying device, thus conserving computing resources associated with correcting erroneous user input associated with parts of the content board scene not being visible.

In some embodiments, the electronic device receives, via the one or more input devices, an indication to display a third content board scene via the display generation component of the electronic device, wherein the third content board scene is received from an external electronic device, the external electronic device having a first aspect ratio (such as if device 642 received the “Dolphins” content board scene from an external device), and the third content board scene is associated with a third region of a respective content board. In some embodiments, in response to receiving the indication to display the third content board, and in accordance with the electronic device having a second aspect ratio, different from the first aspect ratio, the electronic device displays the third content board scene with the second aspect ratio, wherein displaying the third content board scene with the second aspect ratio comprises displaying the third region of the third content board scene within a fourth region of the respective content board, the fourth region having the second aspect ratio such as the “Dolphins” content board scene being displayed with portions 640a-b in addition to the original content board region 638 in FIG. 6G. In some embodiments, if the aspect ratio of the device used to capture (e.g., generate) a content board scene is different from the aspect ratio of the device that is currently displaying the content board scene, the content board scene is adjusted such that it fits within the aspect ratio of the device that is currently displaying the content board scene. In some embodiments, adjusting the content board scene to fit with the aspect ratio of the displaying device includes changing a zoom level of the content board scene such that more or less of the region associated with the content board scene is displayed, and/or the original region is fully displayed but with optionally more or less of the content board also being displayed. For instance, if the aspect ratio of the creating device is a square (e.g., 1:1), while the aspect ratio of the displaying device is rectangular, then when a content board scene captured on the square aspect ratio device is displayed on the rectangular device, portions of the content board that are adjacent to the square region are visible so that the content board scene fits within the aspect ratio of the displaying device. Graphically formatting the region associated with a content board scene when the device used to capture the scene has a different aspect ratio then the device used to display the scene, minimizes the likelihood that one or more portions of the content board scene are not visible when being displayed on the electronic device due to a mismatch between the aspect ratio of the capturing device and the aspect ratio of the displaying device, thus conserving computing resources associated with correcting erroneous user input associated with parts of the content board scene not being visible.

In some embodiments, the electronic device displays the third content board scene on the external device includes displaying a third region of a respective content board without displaying a fourth region of the respective content board such as if portions 640a-b were not displayed in FIG. 6G, and displays the third content board scene on the electronic device includes displaying the third region of the respective content board and displaying the fourth region of the respective content board such portions 640a-b being displayed in addition to the original content board scene 638 in FIG. 6G. In some embodiments, when the capturing device has a different aspect ratio then the displaying device, displaying the content board scene on the displaying device includes displaying the content board scene at an aspect ratio that is in accordance with the aspect ratio of the displaying device. In some embodiments, when two different devices are displaying the same scene, if the two devices have different aspect ratios, then the content board scenes will be displayed with different portions of the content board visible when displaying the content board scene. For instance, on a smaller device (e.g., smaller aspect ratio), a third region of the content board is only visible when the content board scene is displayed on the smaller device, however, when the same content board scene is displayed on a larger device (e.g., larger aspect ratio), the third region and an additional portion of the content board scene (e.g., the fourth region) are displayed on the larger device. However, in both scenarios, the full original region associated with the content board scene will be displayed. Displaying a portion of the content board scene based on the aspect ratio of the displaying device, minimizes the need to reformat the content board scene (e.g., compressing or lengthening the content board scene) ensuring that the full original region that defined the scene is visible even when the scene is displayed on different devices without the need to provide additional input, thereby minimizing input errors associated with viewing a compressed and/or lengthened content board scene and/or minimizing inputs associated with adjusting a region, thereby conserving computing resources associated with additional inputs.

In some embodiments, the third content board scene is displayed without visual boundary indicators around a third region of a content board corresponding to the third content board scene such as in FIG. 6G, wherein no visual boundaries are displayed when displaying the “Dolphins” content board scene. As described above, since the same content board scene can have different portions of the content board displayed depending on the aspect ratio of the device that is displaying the content board scene, the device does not display a boundary of the content board scene and/or the region associated with the content board scene so as to create a seamless viewing environment when viewing the same content board scene on two different devices so that the user does not see that the content board scene has been altered due to the aspect ratio of the device. In some embodiments, as part of a debugging mode or as part of the normal operation of the content creation application, the device displays a boundary of the region in response to detecting an input from the user that activates the boundary. Displaying the content board scene without visual boundary indicators, allows the content board scene as it were naturally being displayed as part of the displaying the content board and conserves computing resources associated with displaying and maintaining a visual boundary at the display generation component of the electronic device.

In some embodiments, the electronic device receives, via the one or more input devices, an indication to export a third content board scene such as detecting selection of selectable option 634d of content board scene user interface 632 in FIG. 6E. In some embodiments, the device receives an indication from the user to export the third content board scene to an external device (e.g., associated with an external user) in the form of the user selecting a selectable option from a user interface. Optionally, the indication from the user to export the third content board scene includes receiving an indication to print the third content board scene at an external printer and/or in another document format used to print graphical content.

In some embodiments, in response to receiving the indication to export the third content board scene: in accordance with an indication to export the third content board scene according to an aspect ratio of the electronic device, the electronic device initiates a process to export the third content board scene with an aspect ratio of the electronic device such as in response to detecting selection of a selectable option pertaining to “This Device” on user interface 636 in FIG. 6F. In some embodiments, the indication to export the third content board scene includes an indication to export the third content board scene according to an aspect ratio of the electronic device (e.g., the transmitting device). For instance, the device receives the indication from the user to export the third content board scene according to the aspect ratio of the device in the form of the user selecting an additional selectable option (after selecting the selectable option associated with exporting the third content board scene) indicating that the third content board scene is to be exported such that the third content board scene is displayed according to the aspect ratio of the electronic device (e.g., how the third content board scene is displayed on the electronic device). In some embodiments, in accordance with an indication to export the third content board scene according to an aspect ratio of an external electronic device at which the third content board scene was created, the electronic device initiates a process to export the third content board scene with an aspect ratio of the external electronic device, independent of (optionally different from) an aspect ratio of the electronic device such as in response to detecting selectable option pertaining to “Originating Device” on user interface 636 in FIG. 6F. In some embodiments, the indication to export the third scene includes an indication to export the third content board scene according to an aspect ratio of the external electronic device at which the third content board was originally created. For instance, the device receives the indication from the user to export the third content board scene according to the aspect ratio of the external device (e.g., the originating device) in the form of the user selecting an additional selectable option (after selecting the selectable option associated with exporting the third content board scene) indicating that the content board scene is to be exported according to the aspect ratio of the external device. In some embodiments, in response to receiving the indication to export the third content board scene according to the aspect the ratio of the external electronic device, the transmitting electronic device transmits and/or exports an indication along with the content board scene that is configured to be read by the receiving device, informing the receiving the device that it is to display the content board scene according to the aspect ratio of the device at which the scene was created. In some embodiments, if the electronic device that is exporting the scene is the same device as the device that was used to create the third scene, then the aspect ratio used to export the scene will be the same regardless if the user selects the current electronic device or the originating electronic device. Thus, in some embodiments, if the device detects that it is the device that created the scene to be exported, the device does not provide the user with an option for how to export the scene. In some embodiments, the aspect ratio with which the content board scene is exported is different depending on the orientation of the electronic device (e.g., with respect to gravity) at the time the indication to export the scene is detected (e.g., whether the device is displaying the scene in a landscape and/or portrait mode) . . . . Allowing the user of the transmitting device to indicate which aspect ratio to use when exporting a content board scene, minimizes visual errors associated with displaying the same content board scene on devices with different aspect ratios by allowing the exporting user to control which aspect ratio to user, thereby conserving computing computer resources associated with correcting erroneous input caused by the visual errors.

In some embodiments, while displaying the first content board scene, and while displaying a scene navigation user interface associated with the content creation application, wherein the scene navigation user interface is configured to navigate between a plurality of content board scenes stored on the electronic device including the first content board scene, the electronic device receives an indication at the scene navigation user interface to display a third content board scene of the plurality of content board scenes stored on the device such as content board scene navigation user interface 644 in FIG. 6L. In some embodiments, the scene navigation user interface is displayed on a portion of the user interface of the content creation application so as to minimize visual occlusions of the content board (for instance below the content board). In some embodiments, the scene navigation user interface includes one or more visual indicators, with each visual indicator corresponding to a selectable option corresponding to a content board scene stored on the electronic device. In some embodiments, the visual indicators include text (with the name of the scene corresponding to the content board scene associated with the visual indicator) and/or a thumbnail representation of the content board scene corresponding to the visual indication. In some embodiments, receiving the indication to display the third content board scene includes receiving/detecting that the user has selected the selectable option associated with the third content board scene at the scene navigation user interface.

In some embodiments, in response to receiving the indication to display the third content board scene: the electronic device transitions from displaying the first content board scene to displaying the third content board scene of the plurality of content board scenes according to a first animation sequence such as in response to an input at selectable option 650 of content board scene navigation user interface 644 in FIG. 6L, the electronic device navigates to the content board scene associated selectable option 646d in FIG. 6M. In some embodiments, the first animation sequence includes moving from displaying a first region of the content board associated with first content board scene to displaying a third region of the content board associated with the third content board scene, with the movement panning from the first region of the content board to the third region of the content board in the same manner as if a physical camera were moving from the first region to the second region. In some embodiments, in addition to the movement described above, the zoom level of the content board is gradually adjusted from a first zoom level associated with the first content board scene, to a third zoom level associated with the third content board scene, such that at the beginning of the first animation sequence the device displays the first region at the first zoom level and end of the first animation sequence the device displays the third region at the third zoom level. Transitioning from displaying the first content board scene to the third content board scene according to an animation sequence described above, allows the user to maintain spatial awareness of what portion of the content board is being displayed when transitioning from the first content board scene to the third content board scene, thereby minimizing erroneous input associated with lack of spatial awareness of the content board, and thereby conserving computing resources associated with inputs needed to correct erroneous input.

In some embodiments, in accordance with the plurality of content board scenes being created in a first order, the third content board scene is a first respective content board scene. In some embodiments, in accordance with the plurality of content board scenes being created in a second order, different from the first order, the third content board scene is a second respective content board scene, different from the first respective content board scene such as the navigation order of selectable options 646a-646e in FIG. 6O being in a different order due to the content board scenes being created in a different order. In some embodiments, the order in which the plurality of content board scenes are created refers to the chronological order (e.g., order in time) in which the plurality of scene were generated by the electronic device. Thus, in some embodiments, upon detecting an indication to navigate from the first content board scene to the third content board scene, the third content board scene is based on which content board scene of the plurality of content board scenes was chronologically created after the first content board scene was created. Navigating content board scenes based on the chronological order that the content board scenes created, minimizes the likelihood that undesired content board scenes are displayed in response to an indication to navigate to a “next” scene, thereby conserving computing resources associated with the user providing additional input necessary to navigate to a desired content board scene.

In some embodiments, in accordance with a determination that a first respective content board scene is closest in proximity of the plurality of content board scenes to the first content board scene on the content board, the third content board scene is the first respective content board scene such as the navigation order of selectable options 646a-e illustrated in FIG. 6M. In some embodiments, in accordance with a determination that a second respective content board scene, different from the first respective content board scene, is closest in proximity of the plurality of content board scenes to the first content board scene, the third content board scene is the second respective content board scene such as if the navigation order of selectable options 646a-e illustrated in FIG. 6M were different due to a different layout of the content board scene. In some embodiments, and as described above, each content board scene of the plurality of content board scenes is associated with a region and/or zoom level of the content board. Thus, in some embodiments, the content board scene that is “closest in proximity” to the first content board scene refers to the region associated with a content board scene that is closest in distance to the region associated with the first content board scene. Thus, in some embodiments, upon detecting an indication to navigate from the first content board scene to the third content board scene, the third content board scene is based on which content board scene is associated with a region of the content that is closest is proximity to the region of the content board scene associated with the first content board scene. Navigating content board scenes based on the proximity, minimizes the likelihood that undesired content board scenes are displayed in response to an indication to navigate to a “next” scene, thereby conserving computing resources associated with the user providing additional input necessary to navigate to a desired content board scene.

In some embodiments, the scene navigation user interface includes a plurality of selectable options, each selectable option corresponding to a content board scene of the plurality of content board scenes stored on the electronic device. In some embodiments, receiving the indication to display the third content board scene comprises receiving a first input at a first selectable option of the plurality of selectable options corresponding to the third content board scene such as the content board associated with selectable option 646a of content board scene navigation user interface 644 being displayed if the device detected selection of selectable option 646a in FIG. 6M. In some embodiments, the selectable options of the scene navigation user interface include either a textual or visual representation of the content board scene associated with the selectable option. For instance, the textual representation includes the name corresponding to the content board scene, whereas the visual representation includes a thumbnail (e.g., a miniaturized version of the content board scene) of the content board scene associated with the content board scene associated with selectable option. In some embodiments, the first input includes detecting that the user has selected the selectable option for instance by pointing a pointer at the selectable option and providing input, by the one or more input devices, indicating selection of the selectable option.

In some embodiments, the electronic device receives an indication to display a fourth content board scene, different from the third content board scene, wherein receiving the indication to display the fourth content board scene comprises receiving a second input at a second selectable option of the plurality of selectable options corresponding to the fourth content board scene. In some embodiments, in response to receiving the indication to display the fourth content board scene, the electronic device transitions from displaying the third content board scene to displaying the fourth content board scene of the plurality of content board scenes according to a second animation sequence such as the content board associated with selectable option 646e of content board scene navigation user interface 644 being displayed if the device detected selection of selectable option 646e in FIG. 6M. In some embodiments, the second animation sequence includes one or more characteristics of the first animation sequence described above. Navigating content board scenes using a scene navigation user interface that includes selectable options corresponding to one or more of the content board scenes stored at the electronic device, minimizes the likelihood that undesired content board scenes are displayed in response to an indication to navigate to a scene, thereby conserving computing resources associated with the user providing additional input necessary to navigate to a desired content board scene.

In some embodiments, the scene navigation user interface includes a next scene selectable option such as selectable option 650 in FIG. 6L. In some embodiments, the next scene selectable option is unassociated with any of the content board scenes stored on the electronic device. In some embodiments, the next scene selectable option includes an arrow or other visual indicator indicating that if selected, the user will navigate to a content board scene that has not been previously navigated to (e.g., an unnavigated-to scene). In some embodiments, the electronic device receives a first input at the next scene selectable option. In some embodiments, in response to receiving the first input at the next scene selectable option: in accordance with a fourth content board scene being a next unnavigated-to scene, the electronic device transitions from displaying the third content board scene to displaying the fourth content board scene according to a second animation sequence such as if in response to detecting selection of selectable option 650 in FIG. 6L, device 500 transitions from the “Seahorses” content board scene to the “Fish” content board scene by playing an animation sequence that animates the transition. In some embodiments, in accordance with the fifth content board scene being the next unnavigated-to scene, the electronic device transitions from displaying the third content board scene to displaying the fifth content board scene according to a third animation sequence such as the transition from displaying the content board scene associated with selectable option 646c to displaying the content board scene associated with selectable option 646d in FIG. 6M including an animation sequence. In some embodiments, the electronic device maintains a list of content board scenes that have been previously navigated to, and/or a list of scenes that have not yet been navigated to during a current interaction of the user with the content creation application. In some embodiments, upon receiving the first input, the electronic device selects a scene from the list of unnavigated to scenes to display in response to the first input. In some embodiments, the content board scene that is selected is based on the proximity of the content board scene to the third content board scene (as described above). Additionally or alternatively, the electronic device selects a scene from the list of unnavigated to scenes based on the order that the unnavigated to scenes were created (as described above). Thus, in some examples, even though there may be a scene which was chronologically created after a scene that is being displayed, when the user provides an input to select the next scene, the device will navigate to another scene if the next scene (in creation order) was already navigated to. In some embodiments, the second and third animation sequences shares one or more characteristics with the first and second animation scenes described above. In some embodiments, even though a content board scene may be in closer proximity to the content board scene that is currently being displayed, upon receiving the first input at the next scene selectable option, the device will navigate to a scene that is further away if the closest scene has already been previously navigated to. Navigating content board scenes using a scene navigation user interface that includes a next scene selectable options corresponding to one or more of the unnavigated to content board scenes stored at the electronic device, minimizes the likelihood that undesired content board scenes are displayed in response to an indication to navigate to a scene, thereby conserving computing resources associated with the user providing additional input necessary to navigate to a desired content board scene.

In some embodiments, while the first content scene has been generated, and while displaying a third region of the content board scene, different from the first region, the electronic device receives an indication to update the first content board scene. In some embodiments, in response to receiving the indication to update the first content board scene, the electronic device modifies the first content board scene in accordance with the displayed third region such as selectable option 634 of user interface 634b were selected in FIG. 6E. In some embodiments, rather than creating a scene for each combination of region and zoom level desired to be a content board scene by the user, the device allows the user to modify an already saved scene by allowing the user to update the region and/or zoom level associated with the already save scene. For instance, the user using the scene navigation user interface described above, provides an indication to modify an existing scene, and in response the device modifies the indicated content board scene with the current region and/or zoom level being displayed by the content creation application. In some embodiments, the computer system updates either the zoom level, the region, or both simultaneously depending on which of the region and zoom level are different from the content board scene when the input to update the content board scene is provided. Allowing the user to modify existing scenes, minimizes the number of scenes required to be stored by the device, thereby conserving computing resources such as memory associated with storing additional content board scenes.

In some embodiments, the electronic device receives, from an external electronic device associated with an external user, an indication of a third content board scene associated with the content board of the content creation application. In some embodiments, in response to receiving the indication of the third content board scene, the electronic device stores the third content board scene on the electronic device in association with the content board such as if the Sea Turtle content board scene were generated by a user using an external device in FIG. 6E. In some embodiments, content board scenes associated with a content board that is being edited collaboratively (e.g., by one or more user interacting with the content board using their own devices) are also edited collaboratively, meaning that when a user edits and/or generates a content board scene associated with the collaborative content board, the edits and/or generated content board scene are transmitted to each device of the users that are part of the collaboration. In some embodiments, the content board scenes associated with the collaborative content board are individually stored at each device of a user that is part of the collaboration, however when a scene is modified, the modification is automatically sent to each user so that the corresponding content stored on each user's device is modified in accordance with the modification. In some embodiments, each user can create a content board scene and/or scenes for the same content board. In some embodiments, when a user creates a new content board scene for a collaborative content board, the content board scene is automatically transmitted to each user that is associated with the collaborative content board, such that each user's device individually stores all content board scenes that are associated with the content board, no matter which user has created the content board scene. Sharing content board scenes associated with a content board that is being collaboratively edited, reduces the number of inputs needed to generate content board scenes on a user's individual device, thereby conserving computing resources associated with the additional input required to create a content board scene.

In some embodiments, the electronic device displays a third region of the content board, and displays a scene list user interface, wherein the scene list user interface includes a plurality of entries, each entry associated with a content board scene of a plurality of content board scenes stored on the electronic device such as content board scene navigation such as content board scene navigation user interface 644 in FIG. 6N. In some embodiments, the scene list user interface includes a textual and/or visual representation of each content board scene associated with the content board and stored on the electronic device. In some embodiments, the scene list user interface is the same as the scene navigation user interface. Alternatively, the scene list user interface is a different user interface than the scene navigation user interface. In some embodiments, in accordance with a determination that the displayed third region of the content board corresponds to a third content board scene of the plurality of content board scenes, the electronic device, displays a visual indicator associated with the entry of the plurality of entries associated with the third content board scene such as selectable option 646c including a visual indicator 652 in response to device 500 displaying the content board scene associated with selectable option 646c in FIG. 6N. In some embodiments, in accordance with a determination that the displayed third region of the content board corresponds to a fourth content board scene of the plurality of content board scenes, the electronic device displays a visual indicator associated with the entry of the plurality of entries associated with the fourth content board scene such as if selectable option 646d were visible in FIG. 6N and included a visual indicator 652 in response to device 500 displaying the content board scene associated with selectable option 646d. In some embodiments, the visual indicator includes applying a color and/or highlighting to the entry of the plurality of entries associated with the displayed region of the content board that is associated with a content board scene of the plurality of content board scenes. In some embodiments, the visual indicator includes bolding and/or altering the text associated with the entry in a manner that causes the entry to be visually distinct from the other entries of the scene list user interface. In some embodiments, a region being displayed corresponds to a content board scene when the region is the same as the region and/or zoom level that is associated with the content board scene. In some embodiments, while a first entry of the plurality of entries is highlighted due to the displaying a region corresponding to the entry, when the device detects that the user has provided input to change the region that is displayed, the devices ceases highlighting the first entry. If the user input caused another region corresponding to an entry of the plurality of entries, the device then optionally highlights the new corresponding entry. In some embodiments, an entry of the plurality of entries is highlighted by the device, even if more than just the region that corresponds to the entry is being displayed. Thus, even if a region is displayed with additional portions of the content board, so long as the entirety of the region of the corresponding scene is displayed by the display generation component of the device, the device will highlight the entry of the plurality of entries corresponding to the displayed region. In some embodiments, if multiple regions corresponding to multiple content board scenes are concurrently displayed, then the device will highlight those multiple region entries concurrently. Providing a visual indicator to an entry of a scene list user interface that corresponds to a stored content board scene when a region associated with content board scene is the same as the displayed region, minimizes the likelihood of the user creating duplicative scenes, thereby conserving computing resources (such as memory) that would otherwise be expended when a duplicative scene is created.

It should be understood that the particular order in which the operations in FIG. 7 have been described, optionally including the additional and/or alternatives operations to the illustrated operations in FIG. 7 described herein, is merely exemplary and is not intended to indicate that the described order is the only order in which the operations could be performed. One of ordinary skill in the art would recognize various ways to reorder the operations described herein.

### Associating and Connecting Multiple Objects

Users use content boards, typically in association with a content creation application, for a variety of purposes including the documentation of thoughts to engage in collaboration with multiple users in a centralized location, preparation of materials for presentations to share with others, and ideas for the purposes of planning, brainstorming, and/or journaling. A content board mimics some of the characteristics associated with real-world analogs such as: a cork board wherein one or more users attach information to the board with push-pins, and/or a dry-erase board where users can scribe words and/or images in efforts to share information. A content board, as related to a content creation application running on an electronic device provides a digital recreation of the benefits of the real-world analogs, such as those discussed above. A content creation application provides further benefit of the ability to save content generated to memory in a manner which can be easily reopened, modified, and saved in an updated form at a subsequent time.

In some circumstances, a user optionally prefers to associate or group multiple objects on the content board together such that modifications in the location and/or size of a first object will result in change in the size/location of a second object that is associated/grouped with the first object. In a content creation application, the act of associating a second object to a first object is accomplished through “grouping” functions which requires user input (on one or more input devices that are part and/or communicatively coupled to an electronic device) to indicate to the electronic device to group the second object with the first object. However, when grouping objects in some circumstances, the grouping results in a connection established only through user input, and the group can be modified or released only through further user input. For instance, in order to add a third object to the group, in some circumstances, the user is required to provide further input to break the group. Such user input to create or modify groups of associated objects results in multiple user inputs, each requiring further processor tasking and power requirements.

In some circumstances, the connection of a second object to a first object on an existing content creation board currently requires an end-point of a second object to be placed and/or modified in a manner which results in an end-point of the second object to coincide (e.g., be coincident) with an end-point or perimeter of the first object. However, such connections between objects require the user to precisely connect an end of the second object with the end-point or perimeter of the first object, and the required precision sometimes results in a failed connection between objects when the user has not connected the objects with the needed precision. Furthermore, such connections are limiting in the sense that they do not allow for a connection wherein the objects overlap each other, or are offset from each other, while still allowing for the modification of the multiple connected objects through the modification of one of the multiple connected objects. For instance, in existing content board applications (e.g., content creation applications), following the connection of the second object to the first object by coinciding an endpoint of the second object to the first object, input provided to modify the first object (e.g. scale, move, stretch) the first object, will not result in the modification of the second object. Further user input, such as input to group the second object with the first, would be required to impart the modifications made to the first object, to the second object. Otherwise, modifying the second object similarly to the modification of the first object would require precise input (e.g. inputting the exact scaling factor applied to the first object) to independently modify the second object identically to the modification of the first object.

The embodiments described below are directed toward efficiently connecting objects in a content creation application (for instance a first object and a second object) with limited user input thereby providing a more user friendly, intuitive, and efficient user experience when connecting objects. Efficient methods for connecting objects in a content creation application, in some circumstances, includes generating a continuous boundary around a first displayed object, wherein interaction with the continuous boundary with a second object allows a reduced number of user inputs to connect a second object with a first object, which reduces processor tasking and power usage of the device, and increases battery life for battery powered devices. It is understood that people use devices. When a person uses a device, that person is optionally referred to as a user of the device.

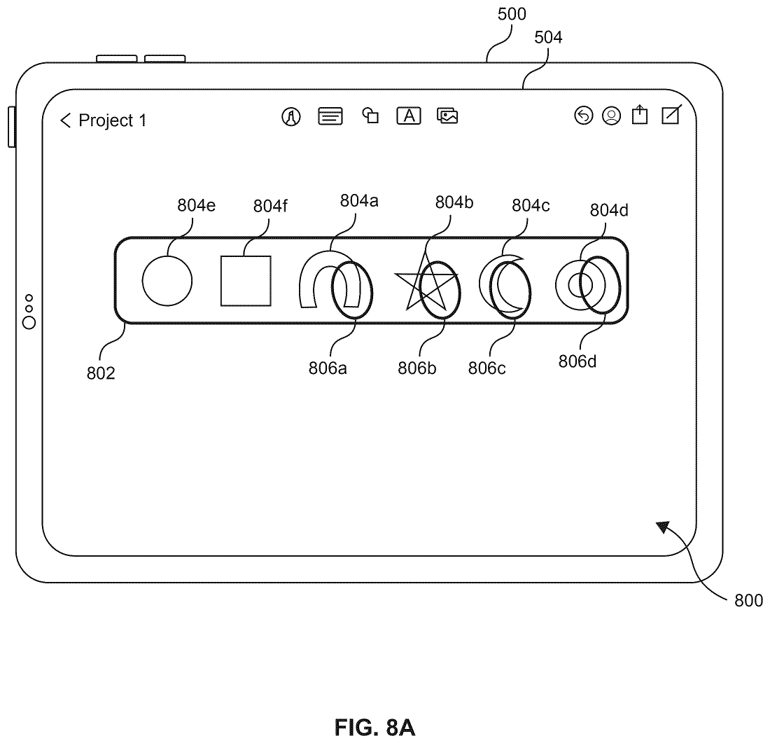

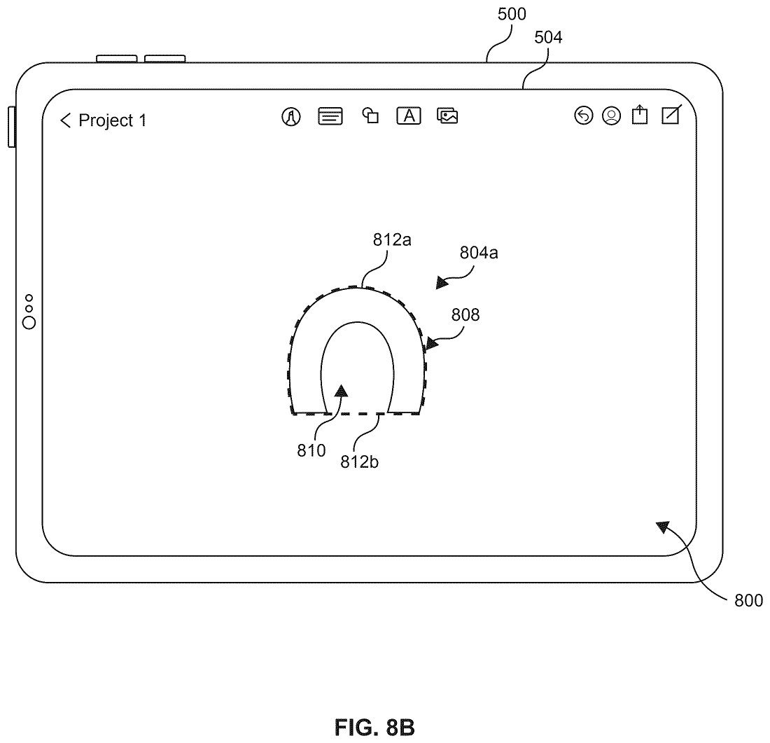

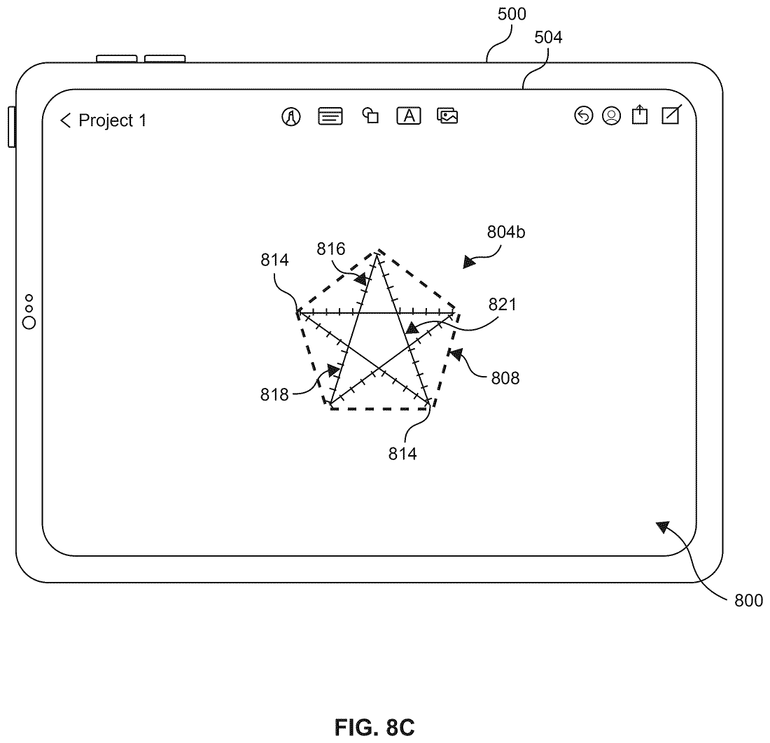

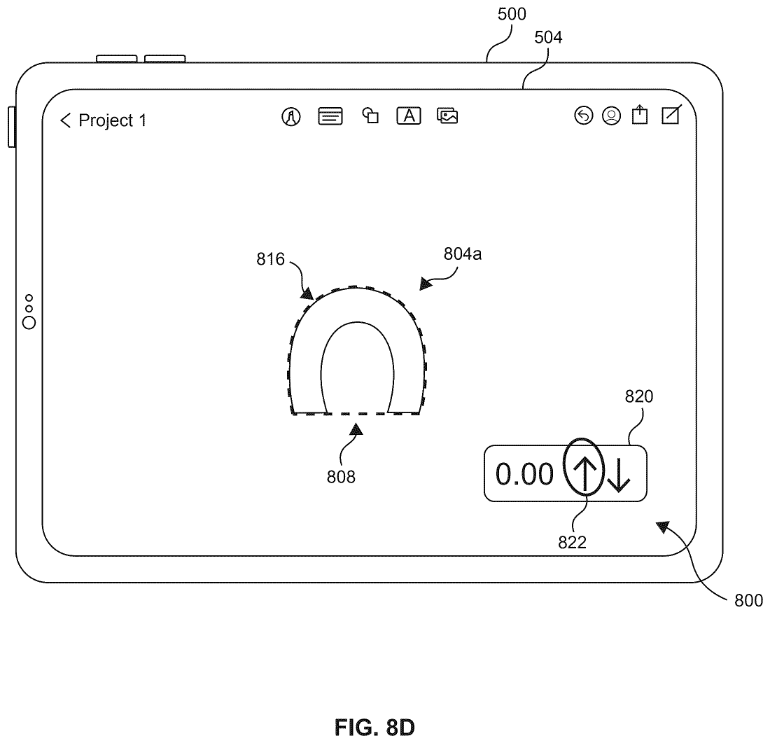

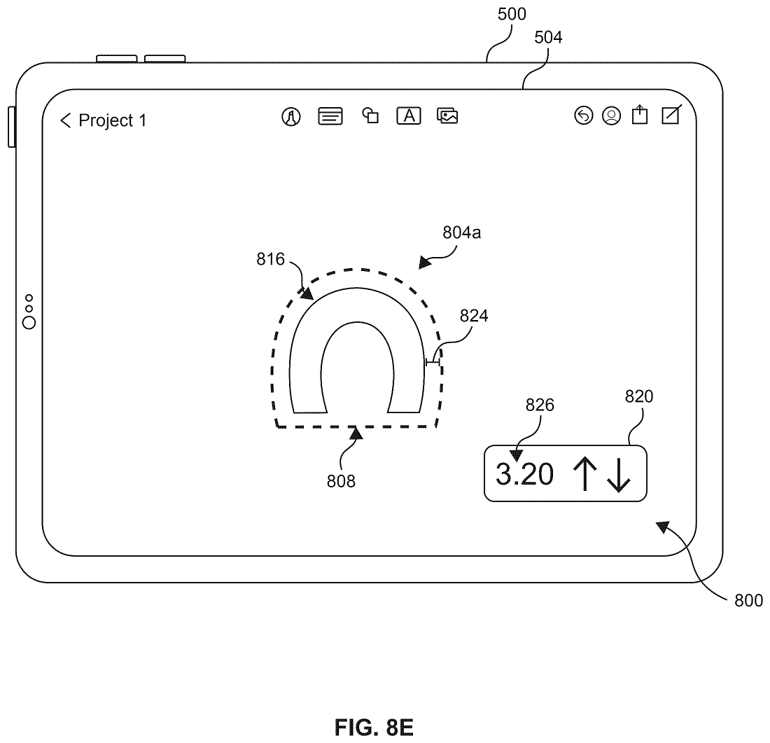

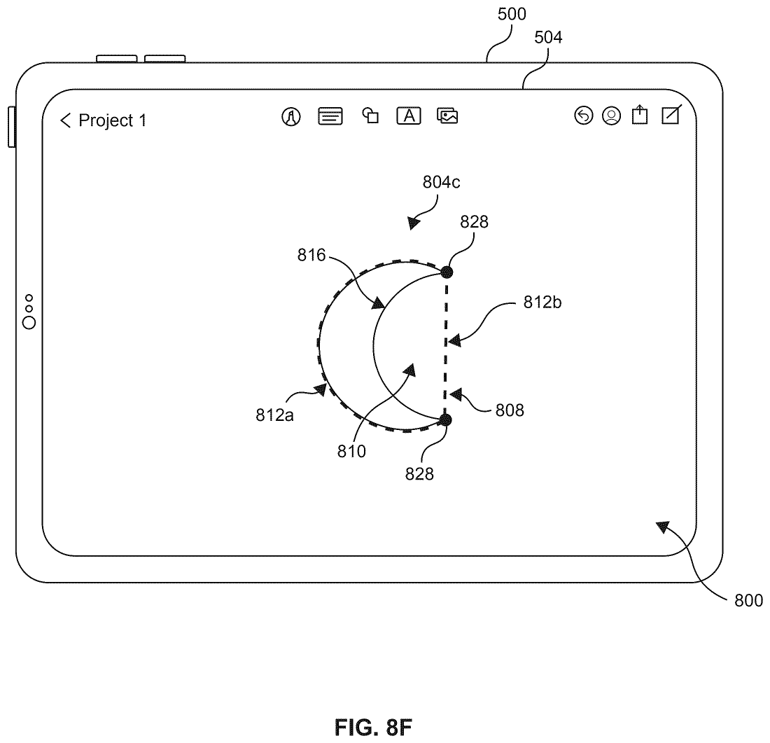

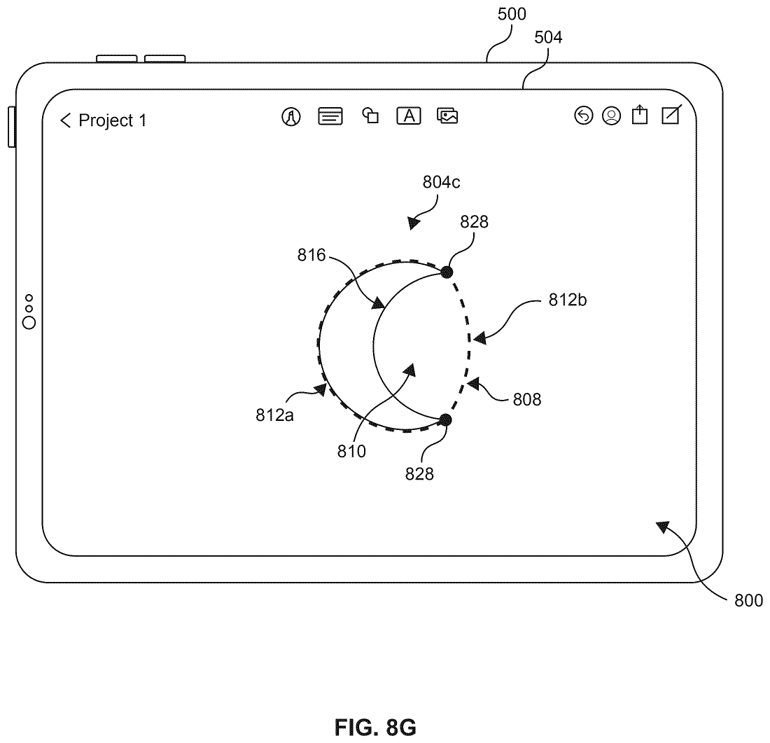

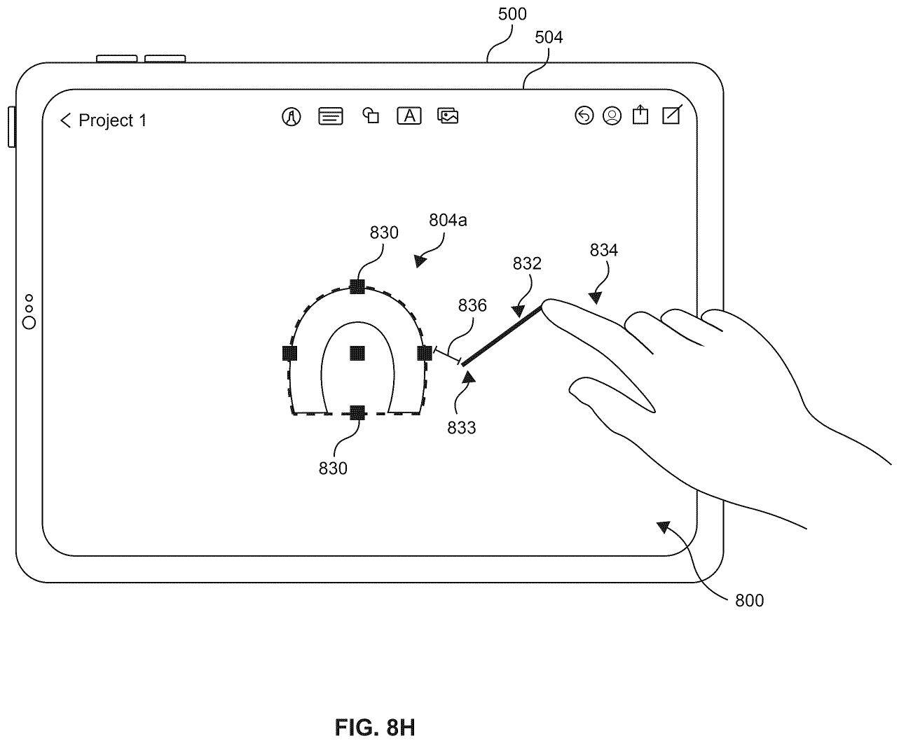

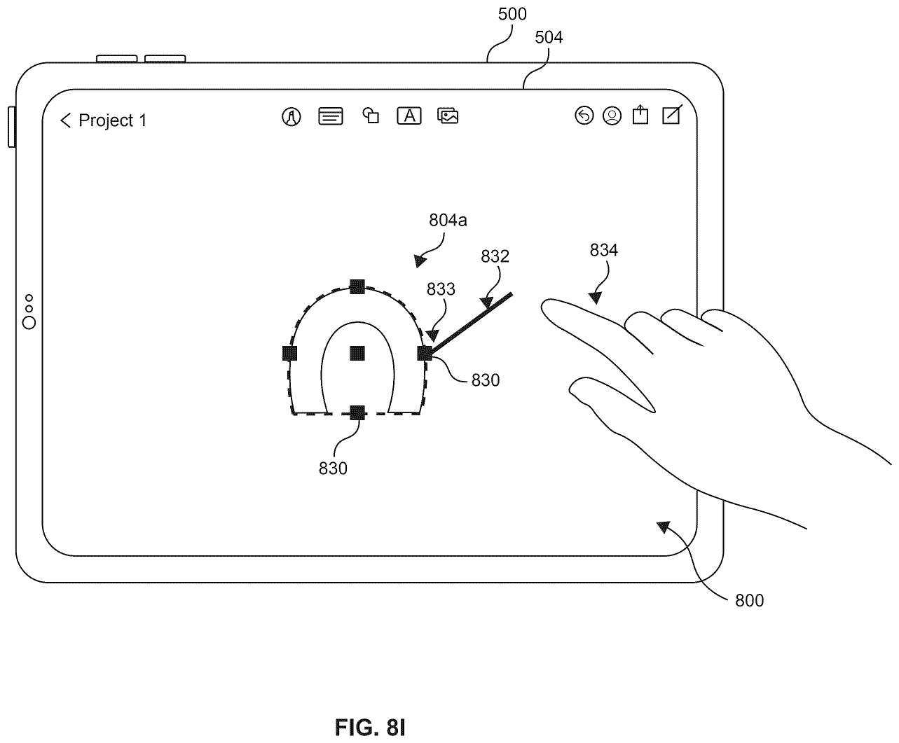

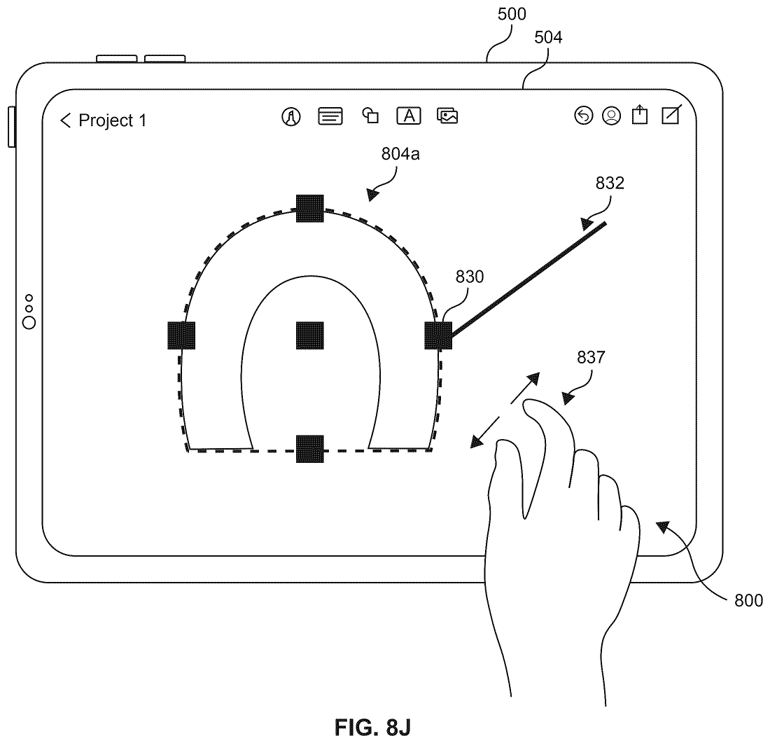

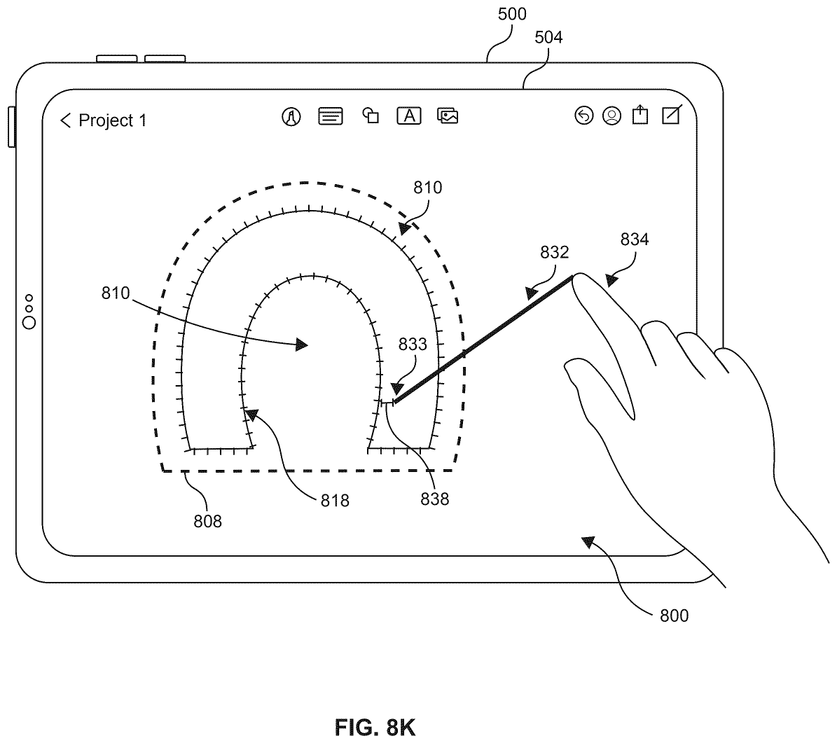

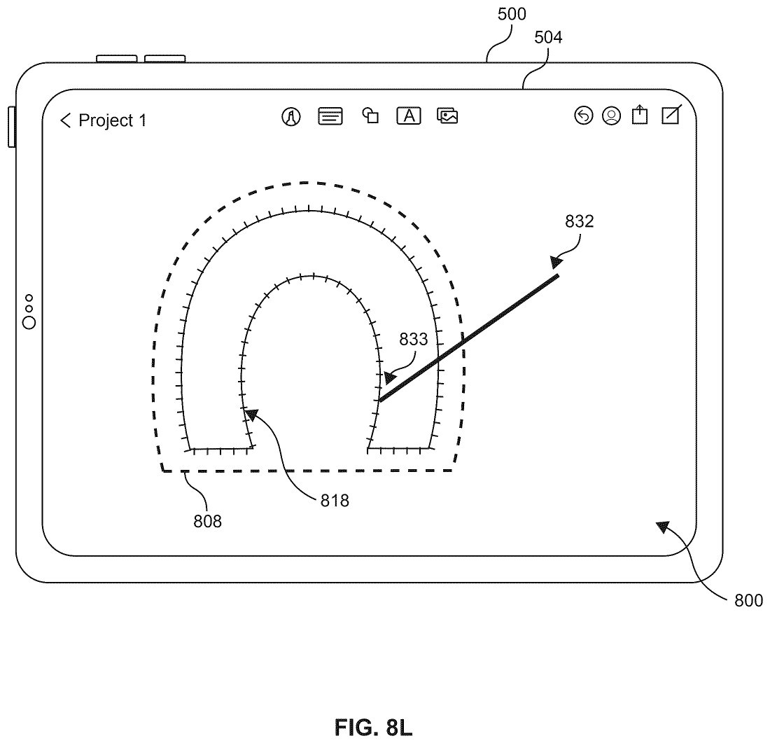

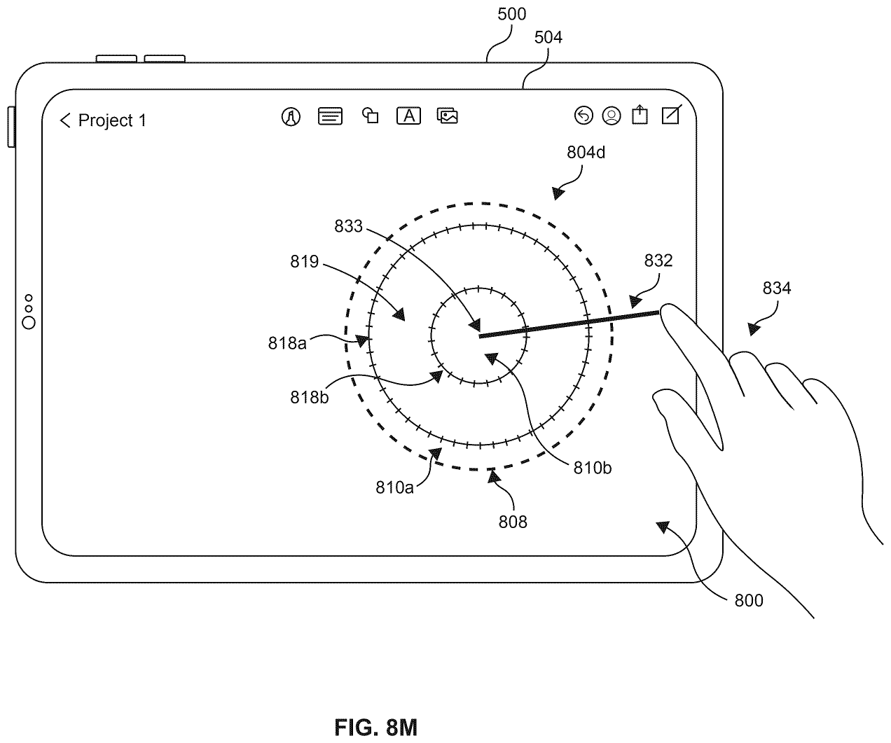

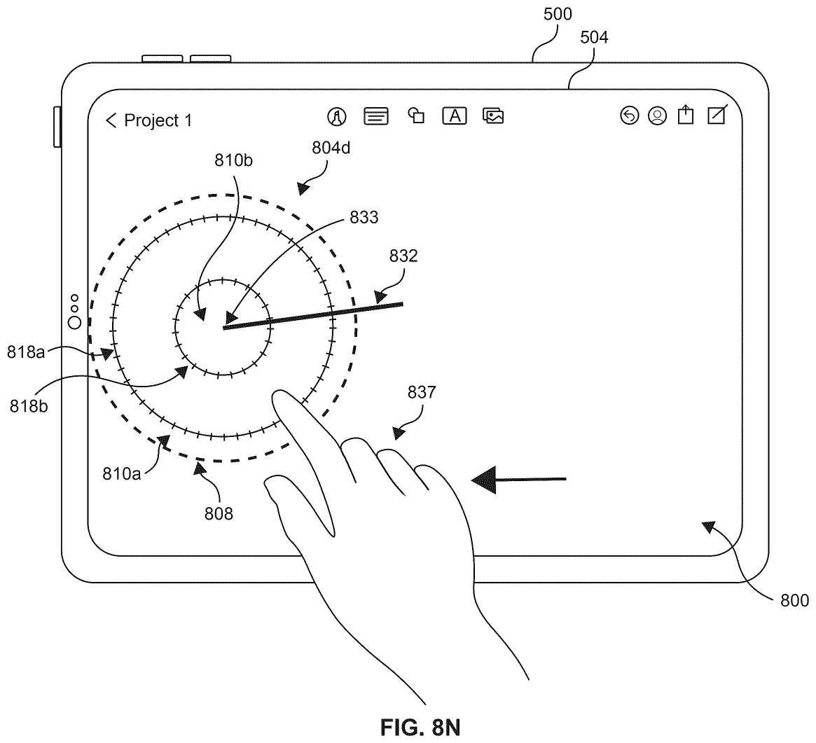

FIGS. 8A-8N illustrate exemplary ways in which an electronic devices displays user interfaces for displaying and interacting with objects on a content creation board. The embodiments in these figures are used to illustrate the processes described below, including the processes described in FIG. 9 of how an electronic device in a content creation application interconnect multiple objects together in an efficient and computing resource preserving manner. Some examples, described below, include the generation of a continuous boundary around a first object, and the interactions of a second object with or within the generated continuous boundary to provide a more efficient manner to connect the second object with the first object. Although FIGS. 8A-8N illustrate various examples of ways an electronic device is able to perform the processes described below with respect to FIG. 9, it should be understood that these examples are not meant to be limiting, and the electronic device is able to perform one or more processes described below with reference to FIG. 9 in ways not expressly described with reference to FIGS. 8A-8N. In some embodiments, while the methods for connecting objects are described in the context of a content board application, the context should be seen as exemplary, and should not be viewed as limiting to the disclosure. In some embodiments, the methods and processes described herein can be applied in multiple contexts where the connection of objects would be desired.

FIG. 8A illustrates an exemplary electronic device 500 (e.g., electronic device) displaying, via a display generation component 504, a content board 800 associated with a content creation application. Electronic device 500 via content board 800, in some embodiments, displays a user interface element 802 providing a user the ability to select and display a predetermined object 804 (e.g. objects 804a-f of FIG. 8A) on the content board 800. The content board 800 provides the option to display an object through user input (e.g. user input 806a-806d of FIG. 8A) wherein the user input corresponds to the selection of one or more selectable options (e.g., selectable options 803a-803f). In some embodiments, electronic device 500 receives selection of a selectable option (e.g., selectable options 803a-803f) corresponding to a predetermined object 804a-f through user input 806 (e.g. keyboard input, mouse input, stylus input), and in response to detecting the selection of an object 804a-d, electronic device 500 displays an object on the content board. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, head mounted displays, or any other suitable display device.

As shown in FIG. 8A, in some embodiments the electronic device 500 displays a user interface element 802 (e.g. of a content creation application installed on electronic device 500) on the display generation component 504. In some embodiments, the user interface element 802 provides one or more user selectable options (e.g., selectable options 803a-803f) predetermined objects 804a-d which a user optionally selects, displays, and/or modifies. In some embodiments, electronic device 500 displays user interface element 802 and receives user input at user interface element 802 thereby allowing the user to select an option which allows the creation and/or modification of an object using one or more of a variety of inputs which include, but are not limited to a keyboard input (e.g. providing text for inclusion in association with an object, providing dimensions for an object to be displayed), through a mouse (e.g. selecting a predetermined shape, drawing a shape, defining boundaries of a shape), a stylus (e.g. selecting a shape, drawing a shape), or interaction with a touch screen (e.g. a stylus or finger to draw a shape or select a predetermined shape) to select, modify, create, or otherwise provide an input to instructed the electronic device to display an object on the content creation board. For instance, in response to receiving input 806a that is configured to select a selectable option 803a from the first user interface element 802 (e.g., the horseshoe 804a), electronic device 500 displays a horseshoe shape on the content board as illustrated in FIG. 8B.

As illustrated in FIG. 8B, electronic device 500 displays, via the display generation component 504, on a content board 800 associated with the content creation application, object 804a, in accordance with some embodiments. In some embodiments, upon displaying the first object 804a (e.g., a horseshoe shape), the electronic device 500 generates a continuous boundary 808 around the horseshoe 804a. The continuous boundary 808 as shown, designates an area of interactivity 810 within the bounds of the continuous boundary 808. In some embodiments, an area of interactivity refers to an area that when a second object comes into contact with the area of interactivity, electronic device 500 connects/associates the second object with the horseshoe 804a without requiring further user input. The continuous boundary 808 is optionally coincident with one or more portions of the perimeter of the horseshoe 804a, for instance the first portion 812a as shown along the convex portion of the perimeter of the horseshoe and the linear ends of the horseshoe. Additionally, or alternatively, the continuous boundary 808 is optionally different from one or more portions of the horseshoe 804a, for instance a second portion 812b as shown in conjunction with the concave portion of the horseshoe 804 representing some embodiments wherein at least a portion of the continuous boundary is different than the perimeter of the horseshoe.

Referring back to FIG. 8A, in some embodiments, electronic device 500 detects the user providing input 806b, and in response displays pentagram 804b as illustrated in FIG. 8C. A pentagram, as discussed herein, is a five-pointed star polygon with a pentagon inscribed therein, but not limited thereto. In response to the input from the user to display pentagram 804b, the electronic device 500 generates a continuous boundary 808 which surrounds the pentagram shaped object. As illustrated, the continuous boundary comprises multiple portions that intersect with distal extents 814 (e.g. coincident with endpoints, coincident with vertices, tangent to curved portions) of the pentagram 804b. The area of interactivity 810 as shown includes area within the continuous boundary, optionally including area within the perimeter 816 of the first object, and further optionally including area within the continuous boundary which is outside the perimeter 816 of the pentagram 804b.

In some embodiments, as shown in FIG. 8C, upon displaying a pentagram 804b, the electronic device 500 further generates a perimetral outline 818 in conjunction with generating a continuous boundary 808. In some embodiments, the perimetral outline 818 is coincident with the perimeter 816 of the first object. In some embodiments, the perimetral outline 818 is optionally generated to be coincident with the outer perimeter of the first object (e.g. the five-pointed star), and optionally the inner perimeter 821 of the first object (e.g. the pentagon) does not dictate the shape or boundary of the perimetral outline. In some embodiments, the perimetral outline 818 designates a boundary between the pentagram 804b and the continuous boundary 808 of the pentagram wherein the area 810 between the continuous boundary 808 and the perimetral outline 818 optionally designates an area of interactivity, and the area 819 within the perimetral outline 818 is optionally not an area of interactivity.

In some embodiments, as shown in FIGS. 8D, an electronic device 500 receives user an input to display a horseshoe 804a, such as in response to a user input 806a as shown in FIG. 8A. Subsequent to, or simultaneously with, the input to display the horseshoe, a continuous boundary 808 is generated by the electronic device 500 around the first object. As illustrated in FIG. 8D, the electronic device 500 receives a modifying input 822 associated with offsetting the continuous boundary from the perimeter 816 of the first object at user interface 820. In some embodiments, the electronic device displays a second user interface element (e.g. boundary offset user interface) 820 through which the device receives user input to modify the bounds of the continuous boundary in relation to the first object. In some embodiments as illustrated, user inputs (e.g. modifying input 822) incrementally increase the continuous boundary offset (e.g. mouse click, touch screen input, keyboard keystroke), similarly incrementally decrease the continuous boundary offset, provide a discrete input (e.g. keyboard input providing a specific offset), or a combination thereof. When the electronic device receives a user input (e.g. modifying input 822) to modify the continuous boundary offset 824, the electronic device, via the content board 800, updates the continuous boundary 808 as shown in FIG. 8E.

Following the user input as illustrated in FIG. 8E, subsequent to (or simultaneously with) the electronic device 500 receiving modifying input 822 commensurate with a request to increase a continuous boundary offset 824 (See FIG. 8D modifying input 822), results in electronic device 500 updating the continuous boundary 808 from the horseshoe in accordance with the modifying input 822.

As illustrated in FIG. 8E, when the electronic device 500 detects an input (e.g. modifying input 822) to increase the continuous boundary offset 824 the electronic device 500 offsets/modifies the continuous boundary away from the first object, which is further indicated in the boundary offset user interface 820 of some embodiments. In some embodiments the second user interface includes a numerical identifier 826 indicating a numerical value of the continuous boundary offset. In some embodiments, when electronic device 500 detects an input to boundary offset user interface 820, and specifically to the one or more selectable options (e.g., selectable options 803a-803f shown in FIG. 8A) of the user interface, electronic device 500 modifies the continuous boundary offset of the object that is associated with the boundary offset user interface 820. Additionally or alternatively, inputs to modify the continuous boundary offset are applied to a plurality of displayed objects (e.g. multiple selected objects, globally to all displayed objects). In some embodiments, a user optionally modifies the continuous boundary offset to be applied to all subsequently displayed objects.

When the electronic device receives an input to display a crescent shape, such as user input 806c as shown in FIG. 8A, a crescent 804c is displayed by electronic device 500 in response to user input 806c as shown on FIG. 8F. In conjunction with displaying crescent 804c, electronic device 500 generates a continuous boundary 808. In some embodiments, continuous boundary 808 includes a first portion 812a associated with the convex portion of the crescent, such that the first portion of the continuous boundary follows the perimeter 816 of the convex portion and is optionally coincident with the perimeter 816 of the crescent. In some embodiments, continuous boundary 808 includes a second portion 812b of that is associated with the concave portion of the crescent, which is different than the perimeter 816 of the crescent. In some embodiments, first portion 812a of the continuous boundary 808 interconnects with the second portion 812b of the continuous boundary at one or more continuous boundary vertices 828. The generation of one or more portions of the continuous boundary 808 to be different than the perimeter of the crescent (e.g. not following the perimeter of the crescent) simplifies the continuous boundary in relation to the perimeter of the object. For instance, as shown in FIG. 8F, the second portion 812b of the continuous boundary is a linear line segment as opposed to the arced concave portion of the crescent. Generating a linear second portion of the continuous boundary 812b requires less processor utilization, and thus less power consumption, than generating a continuous boundary to follow the perimeter of the crescent. Furthermore, generating the second portion 812b of the continuous boundary as shown, results in an increased area within the continuous boundary, and thus provides an increased area of interactivity 810 within the continuous boundary for the interconnection of a second object to the crescent as shown.

In some embodiments, as shown in FIG. 8G, in response to receiving user input (e.g. 806c as shown in FIG. 8A) to display a crescent 804c, continuous boundary 808 is generated, wherein the continuous boundary has a second portion 812b associated with the concave portion of the crescent such that the second portion 812b is optionally different than the perimeter 816 of the crescent such that the second portion 812b is convex in relation to the concavity of the crescent. The second portion 812b is optionally connected to the first portion 812a in a manner such that the second portion of the continuous boundary is tangential to the first portion 812a at one or more continuous boundary vertices 828. The use of a convex second portion results in an increased area of interactivity 810 within the continuous boundary. Furthermore, generating a second portion of the continuous boundary 812b which is different than the perimeter of the crescent requires less processor utilization, and thus less power consumption, than generating a continuous boundary to follow the perimeter of the crescent.

In some embodiments, as shown in FIG. 8H for instance, following receiving a user input (e.g. 806a as shown in FIG. 8A) to display a horseshoe 804a, the electronic device 500 generates a continuous boundary around the horseshoe and further generates one or more magnetic points 830 a in association with the horseshoe. A magnetic point 830 optionally provides a discrete location wherein when a second object (e.g. line 832) is displayed through user input 834 (e.g. selection of predetermined object, drawing object with mouse, drawing object with touch screen input) within a threshold distance 836, the electronic device 500 connects the line 832 to the horseshoe 804a. When the electronic device 500 receives a user input (e.g. 834) to display a second object (e.g. line 832) such that a first end 833 of the line is within a threshold distance 836 to a magnetic point 830, a connection between the line 832 and the magnetic point 830 of the horseshoe are made as shown in FIG. 8I.

In response to the electronic device 500 receiving a user input to display a second object (e.g. line 832) in a manner that a first end 833 of the line is within a threshold distance 836 from a magnetic point 830, the electronic device 500 connects the line 832 to the horseshoe 804a as shown in FIG. 8I. In one or more embodiments, the electronic device 500 modifies (e.g. moved, stretched, scaled) the dimensions of the second object to connect the second object to the first object as shown FIG. 8I. Alternatively, in some embodiments the connection between the line 832 and the horseshoe 804a is optionally made without modification to the second object wherein the second object is visually separated from the first object (see FIG. 8H) although the second object is connected with the first object. Following the connection of the line to the horseshoe as shown in FIG. 8I, subsequent user inputs to modify the horseshoe 804a, result in the modification to the horseshoe and the line, such as illustrated in FIG. 8J.

In some embodiments, such as shown in FIG. 8J for instance, following the connection of a second object to a first object (e.g. as shown in FIGS. 8H-8I), in response to detecting user input 837, electronic device 500 modifies one or more characteristics of the horseshoe 804a. In some embodiments, and since the horseshoe 804a and line 832 are now associated with each other (e.g., connected), the same modifications are similarly applied to the line 832. For instance, as shown in FIG. 8J, when the size of object 804a is increased, the size of line 832 is similarly increased. In some embodiments, such modifications to a second object based on the modifications of a first object to which the second object is connected to, are optionally made simultaneously with the modification to the first object, however such modifications are optionally made subsequent to the modifications to the first object. Although a modification to enlarge the scale of the first object is illustrated in FIG. 8J, modifications as discussed herein optionally include, but are not limited to: scaling, stretching, moving, rotating, color change, line-weight adjustment, object transparency, or a combination thereof. Furthermore, while FIG. 8J surrounds the connection of a second object to a first object by way of connection to a magnetic point 830, alternate connection methods made between a second object and a first object would also result in modifications applied to a first object to be applied to the second object. Such connection methods include methods of interconnection of a second object to a first object as shown and described in embodiments illustrated in FIG. 8K for instance but are not limited thereto.

In some embodiments, as shown in FIG. 8K, in response to receiving user input 834 (e.g. the user drawing an object and/or selecting a predetermined object) to display a second object (e.g. line 832) which intersects the continuous boundary 808 (e.g. intersects with the continuous boundary, intersects with the area within the continuous boundary), the electronic device 500 connects the line 832 to the horseshoe 804a at a location that is based on the location of the intersection between the line 832 and the continuous boundary 808 of the horseshoe. In some embodiments, the intersecting of the continuous boundary 808 of the horseshoe with the line 832 results in the electronic device 500 connecting line 832 with the horseshoe 804a wherein the originally displayed location of the line 832, in relation to the horseshoe 804a, is maintained. For instance, in some embodiments, a line 832 as shown in FIG. 8K in relation to the horseshoe 804a, will maintain the relative location in association with the line 832 in the event the horseshoe 804a is moved (for instance due to user input). Similarly, in the event the horseshoe 804a is scaled which results in the scaling of the line 832 as well, the location of the line 832 is similarly scaled, thus maintaining the same relative location of the line 832 in relation to the horseshoe 804a.

In some embodiments, and as illustrated in FIG. 8K, displaying the horseshoe 804a results in the generation of a continuous boundary 808 and a perimetral outline 818. In some embodiments the perimetral outline is magnetic, thus when the electronic device 500 receives user input 834 to display a second object (e.g. line 832), wherein a first end 833 of the line is within threshold distance 838 of the perimetral outline 818, the electronic device 500 connects the line 832 to the horseshoe 804a at the perimetral outline 818. In some embodiments, when the electronic device 500 connects the line 832 with the perimetral outline 818, the electronic device 500 modifies the line 832 to result in the first end 833 of the line to coincide with the perimetral outline 818 as shown in FIG. 8L.

In some embodiments, when the electronic device 500 connects a line 832 to a horseshoe as illustrated in FIG. 8L, the electronic device 500 modifies the line 832 so that the first end 833 of the line coincides with the perimetral outline 818 of the horseshoe. Following the connection of the line 832 to the perimetral outline 818 of the horseshoe, in some embodiments in the event the horseshoe 804a is optionally modified, the electronic device 500 modifies the line 832 similarly, and the coinciding connection of the first end 833 of the line to the perimetral outline 818 of the horseshoe.

In some embodiments, in response to a user input (e.g. 806d, FIG. 8A), the electronic device 500, via the content board 800, displays a first object (e.g. torus 804d) as illustrated in FIG. 8M. Based on the displaying of the torus 804d, the electronic device 500 further generates a continuous boundary 808 associated with the torus 804d. In some embodiments, the electronic device 500 optionally further generates a first perimetral outline 818a associated with a first perimeter (e.g. an outer perimeter) of the torus 804d, wherein the first perimetral outline 818a is optionally coincident with the outer perimeter. In some embodiments, the electronic device further generates a second perimetral outline 818b associated with a second perimeter (e.g. an inner perimeter) of the torus 804d, wherein the second perimetral outline is optionally coincident with the inner perimeter of the torus 804d. In some embodiments, referencing FIG. 8M, the area within the continuous boundary 808, but not between the first perimetral outline 818a and second perimetral outline 818b of the first object, defines an area of interactivity. For instance, while in some embodiments an object comprises a single area of interactivity 810 (see FIG. 8B), in some embodiments as illustrated in FIG. 8M, an object (e.g. torus 804d) comprises a first area of interactivity (e.g. outer area of interactivity 810a) and a second area of interactivity (e.g. inner area of interactivity 810b) However, the area 819 between the first perimetral outline 818a and the second perimetral outline 818b is optionally not an area of interactivity. Accordingly, in response to detecting a user input 834 to display a line 832 wherein a first end 833 of the line coincides (e.g., touches) with the area of interactivity 810b, the electronic device 500 connects the line 832 to the torus in a manner which maintains the location of the line in relation to the torus as displayed by the user. Following the connection of the line 832 to the torus 804d, when the electronic device 500 receives user inputs to modify the torus 804d, the electronic device 500 similarly applies the modifications to line 832 as illustrated in FIG. 8N. Similarly, in the event a user input is received to display the line 832 wherein the first end 833 coincides (e.g. touches) with the area of interactivity 810a, the electronic device 500 connects the line to the torus in a manner which maintains the location of the line in relation to the torus as displayed by the user.

FIG. 8N illustrates modifications made to a torus 804d following the connection of a line 832 to the torus 804d. Following the connection of the line 832 to the torus 804d (see FIG. 8M), in the event user input 837 is received to modify the torus 804d (e.g. move, stretch, scale), the electronic device 500 applies the modifications to both the torus 804d and the line 832 in conjunction with each other. Accordingly, as shown for instance in FIG. 8N, user input 837 to move the torus 804d results in the electronic device 500 moving both the torus 804d and the line 832 in a manner that the spatial relationship (e.g. orientation, location) are maintained between the torus 804d and the line 832.

FIG. 9 is a flow diagram illustrating a method 900 for displaying one or more objects, and in response, generating areas and/or elements of interactivity, in accordance with some embodiments. The method 900 is optionally performed at an electronic device such as device 100, device 300, device 500 or device 580, as described above with reference to FIGS. 1A-1B, 2-3, 4A-4B and 5A-5I. Some operations in method 900 are, optionally combined and/or order of some operations is, optionally, changed.

In some embodiments, method 900 is performed at an electronic device in communication with a display generation component and one or more input devices. For example, the electronic device, the one or more input devices, and/or the display generation component have one or more characteristics of the computer system(s), the one or more input devices, and/or the display generation component(s) described with reference to method 700.

In some embodiments, while displaying, via the display generation component 504, a content board associated with a content creation application 800, the electronic device receives (902) an indication to display a first object, for instance when a user selects the horseshoe 804a using input 806a as illustrated in FIG. 8A. In some embodiments, a content creation application refers to an application running on a computer system displayed via the display generation component. In some embodiments, the content board refers to a user interface which includes an area into which a user(s) provide(s) input to draw, paste, import, or otherwise generate visual representations of objects, shapes, and text. A first object optionally includes an image, an object drawn by a user, a predetermined shape, a textual element, or other objects which a user has provided input to be displayed within the content board. In some embodiments, the user provides an input indicating a command to display a particular object or visual representation via the one or more input devices. The input is optionally provided through the use of a stylus-type device, the interaction of one or more portions of the user with a touch-screen interface, a keyboard, mouse, or other user input method or device, such as to select a virtual button for displaying the first object in the content board. The command is optionally associated with the drawing, pasting, importing, or otherwise generating a visual representation of an object, shape, or text. In some embodiments, the content board and the content creation applications share one or more characteristics of the content board and content creation applications described with reference to method 900.

In some embodiments, in response to receiving the indication to display (904) the first object, the electronic device displays (906), via the display generation component, the first object on the content board associated with the content creation application (800) such as horseshoe 804a as illustrated in FIGS. 8A-8B. In some embodiments, the indication to display the first object includes detecting that the user has drawn an object (for instance by using an electronic stylus that is communicatively coupled to the electronic device), or a pre-defined object that has been selected by a user, such as a shape, image, or block of text, or other input by the user. In some embodiments, the object is displayed on the content board for purposes of displaying and interaction by a first user, while further embodiments allow for the collaboration between multiple users interacting with the content board as discussed above with respect to method 900.

In some embodiments, in response to receiving the indication to display the first object the electronic device generates (908) (and/or displays) a continuous (optionally convex) boundary 808 around the first object, wherein at least a first portion 812b of the continuous (optionally convex) boundary is different than a first portion of a perimeter of the first object, wherein an area within the continuous (optionally convex) boundary defines an area of interactivity 810 of the first object as shown in FIG. 8B. In some embodiments, the continuous boundary is convex, and bounds the object in a manner which includes all portions of the object defined by a perimeter of the object. In some embodiments, the properties of the convex boundary include interconnected convex portions surrounding the object and do not include a concave portion. The continuous boundary, in some embodiments, provides a space-efficient designation of area associated with the object in a manner which mimics the shape of the object without requiring undue tasking of processing resources which negatively affect power resources, such as with a battery. The continuous boundary of the first object optionally establishes a designated area associated with the first object which allows a user to connect a second object with the first object through interaction of a second object with the continuous boundary of the first object (e.g., a portion of the second object intersects with a continuous boundary, or the area bounded by the continuous boundary). Intersect, as used herein, refers to the interaction between first object and a second object, wherein the second object overlaps (or is overlapped by), coincides with, traverses, or otherwise is in contact with the first object. The use of a continuous boundary which mimics the shape of the object without the use of concave portions, as compared to a compound boundary which includes concave portions, provides reduced complexity in defining the designated area associated with the first object. Furthermore, in some embodiments such as found with a horseshoe shape for example, a continuous boundary optionally includes empty space external to the perimeter of the object although the empty space is confined by a concavity of the object.

A continuous boundary, in some embodiments, includes an unbroken (e.g., continuous) boundary shape which defines an envelope around all portions of the object. While the perimeter of a shape optionally follows each and every contour of a shape, the continuous boundary optionally spans across concave portions of the object. For instance, in the case of a horseshoe shape, the continuous boundary optionally follows the convex shape of the closed portion of the horseshoe. However, in some embodiments the continuous boundary optionally spans across the open end of the horseshoe shape with a linear or convex portion rather than following the concave aspect of the perimeter in this portion. In the case of a star, for instance, the continuous boundary optionally bridges across the distal extents, or points of the star, without following the concave portions of the star between the distal extents (e.g., points) of the star. As noted, in the case of the horseshoe example, embodiments of a continuous boundary which include linear portions are optionally within the spirit and scope of the present disclosure. In some embodiments, the continuous boundary is configured to include all portions of the object bounded by the perimeter of the object while optionally minimizing area contained between the continuous boundary and the perimeter of the object. In some embodiments the continuous boundary optionally intersects with distal extents (e.g., points of the object that are away from the center) of the object while maintaining properties associated with a continuous boundary such as a portion of the continuous boundary optionally following a perimeter of the object. For instance, in the case of the horseshoe, the continuous boundary is optionally coincident with, or touching (e.g., following), the closed convex portion of the horseshoe. Where the continuous boundary spans across the open end of the horseshoe, the continuous boundary is optionally coincident only with the ends of the horseshoe but otherwise does not follow the concave portion of the horseshoe and instead maintains a linear or convex shape. For further example, in the instance of the star shape, the continuous boundary optionally touches each end-point of the star, but maintains a linear or convex shape between each point of the star. In some embodiments, the continuous boundary is optionally configured to maintain an offset distance from distal extents of the object. For example, the continuous boundary in the case of the star or horseshoe is optionally outwardly offset from the perimeter of the respective shape rather than touching, or intersecting, portions of the perimeter of the star or horseshoe. In some embodiments the offset distance between a continuous boundary and an object is a predetermined value, while in some embodiments the offset distance is established as desired by a user through user input. For example, in some use-cases a user prefers to have the continuous boundary outwardly offset from the perimeter of the object. A user-defined offset distance optionally creates the offset as desired by the user (e.g., based on user input). A continuous boundary offset is optionally established based on a minimum distance from the perimeter of the object, the area within the perimeter of the object, the area within the continuous boundary, or a combination thereof. For example, an offset of a fraction of a pixel, 2 pixels, 5 pixels, 10 pixels, or greater, are within the spirit and scope of the present disclosure. Additionally or alternatively, in some embodiments, the continuous boundary offset is established and modifiable in increments such as a fraction of a millimeter, 0.5 mm, 1 mm, 2, mm, 5, mm, 10 mm, or greater. In some embodiments a continuous boundary includes a single continuous curvilinear contour that lacks vertices. A continuous curvilinear contour without vertices optionally results in a continuous boundary in which all portions are tangentially interconnected with each other to create a closed shape. In some embodiments the continuous boundary includes at least a first convex contour and a second convex contour, such that the radius of the first convex contour is different than a radius of the second convex contour. Alternatively, in some embodiments, a continuous boundary includes a plurality of interconnected portions wherein at least one interconnection point between portions includes a vertex, or alternatively, a plurality of vertices. Portions of the continuous boundary which meet at a vertex optionally result in an angular corner where contours meet rather than curves. For instance, a crescent shaped object is optionally bounded by a continuous boundary having vertices such that the continuous boundary has a semi-circular form, or the same crescent shaped object is optionally bounded by a continuous boundary without vertices such that the continuous boundary has an ovoid form. Notably, convex boundaries without vertices optionally include one or more portions which are tangentially interconnected. A continuous boundary comprising a single continuous curvilinear contour, at least one convex contour including at least one vertex, multiple convex contours interconnected by a plurality of vertices, at least one linear portion, or a combination thereof, are within the spirit and scope of the present disclosure. While convex boundaries have been discussed in relation to the present disclosure, alternate embodiments wherein a boundary optionally includes convex portions, concave portions, linear portions, or a combination thereof, are optionally within the spirit and scope of the present disclosure.

While some embodiments described and shown herein include convex boundaries which exclude the use of a concave portion, alternate embodiments optionally include generating a compound boundary which alternatively includes one or more concave portions, upon the indication to display an object on the content board. A compound boundary is optionally used, for instance, when a compound boundary of the object is determined to exceed a threshold of area between a continuous boundary and a perimeter of an object.

Furthermore, some embodiments optionally include generating a concave boundary, such that the one or more portions of the concave boundary include one or more concave portions, and optionally includes one or more linear portions.

The use of a boundary in accordance with the present disclosure provides an area of interactivity, such that when the electronic device displays a first object, partially or entirely within the boundary of a second object, the device connects the first object with the second object without further user input. In some embodiments, a boundary optionally includes area within the boundary which is outside a perimeter of the object which it surrounds. Accordingly, the area outside the perimeter of the object but inside the boundary, and the area within the perimeter of the object designate an area of interactivity. In some embodiments an object comprises an inner perimeter and an outer perimeter surrounding the inner perimeter, such as found with a two-dimensional representation of a torus (e.g. donut shape) or an inner portion of block-style lettering for example. The area within the inner perimeter is outside the inner perimeter of the object, but within the boundary which surrounds the object, thus the area within the inner perimeter is optionally an area of interactivity. In some embodiments the boundary is optionally configured to follow the perimeter of the object in a convex, concave, or linear manner. In some embodiments the boundary is optionally configured to comprise at least two portions comprising differing characteristics. For example: a first curved portion with a first radius, and second curved portion with a second radius, different from the first radius; a first curved portion with a first arc length, and a second curved portion with a second arc length; a first curved portion and a second linear portion; a first linear portion with a first length, and a second linear portion with a second length, different from the first length; or a first portion having a first characteristic (e.g., linear, convex, concave), and a second portion having a second characteristic different from the first characteristic.

An area of interactivity, as discussed herein, designates an area with which a user optionally provides an indication to the electronic device to connect two objects. For instance, given a first object with an area of interactivity designated by a continuous boundary, when a user provides input to display a second object which intersects an area of interactivity of a first object, the intersection of the second object with the area of interactivity of the first object provides an indication to the electronic device to connect the second object with the first object.

In view of the present disclosure surrounding convex boundaries, concave boundaries, linear boundaries (e.g., polygonal), and compound boundaries, each embodiment discussed herein is optionally applicable to each of convex boundaries, concave boundaries, linear boundaries (e.g., polygonal) and compound boundaries, independently or in concert.

Generating a continuous boundary such as a convex boundary, concave boundary, compound boundary, or other boundary discussed herein around an object when displaying the object provides an efficient way for the electronic device to connect objects with one another and to associate an interaction area with the object by minimizing the likelihood of erroneous user input associated with mis-associating objects when interacting with them, thereby preserving computing resources associated with correcting erroneous user inputs. Furthermore, designating area between the boundary and the perimeter of the object as an area of interactivity with the object provides use of otherwise unused area to provide increased area of interactivity and functionality when interacting with displayed objects.

In some embodiments, at least one of the first portion 812b, and a second portion 812a of the continuous boundary is convex as illustrated in FIG. 8B such as shown in relation to the horseshoe shape 804a. In some embodiments the continuous boundary optionally comprises a first portion and a second portion which are interconnected to form the continuous boundary. In some embodiments, a continuous boundary optionally comprises a plurality of portions interconnected to form the continuous boundary. In some embodiments the at least one portion of the continuous boundary comprises a convex shape, optionally in relation to the first object. In the case of a crescent moon shaped object for example (FIG. 8F-8G), a first portion optionally crosses the concave aspect of the crescent moon wherein the first portion is different than the perimeter of the first object. Convex, as used in relation to a portion of the continuous boundary herein, optionally includes portions of the continuous boundary which are non-concave (e.g., convex, and/or linear). In some embodiments, such as in the case of the crescent moon for example, the second portion of the continuous boundary optionally follows the convex portion of the crescent moon and is similar to the perimeter of the first object. Alternately, such as in the case of a star (FIG. 8C), a first portion of the continuous boundary is convex, and a second portion of the continuous boundary is convex. In the case of each of the star and the crescent moon, concave aspects of the shapes are bounded by a convex portion and results in a continuous boundary with a form which is simplified (e.g., less segments, less portions, shorter perimeter length) in relation to the object. In some embodiments, an entirety of the continuous boundary is convex.

The optional use of a convex portion within a continuous boundary provides the electronic device an ability to provide simplified continuous boundaries surrounding complex objects or complex portions of objects. A convex portion, for instance optionally designates an area of interactivity which is entirely or partially bounded by a concavity or concave feature in the perimeter of an object. The convex portion designates the area bounded by the concave feature without requiring the continuous outline to follow the perimeter of the object, resulting in a simplified boundary for the object as compared to the perimeter of the object. Accordingly, the continuous boundary is a simplified designation of an area of interactivity which requires reduced processor utilization to generate as compared to the perimeter of an object. Using a continuous boundary as a simplified designation for an area of interactivity results in reduced processor utilization and reduced power consumption.

In some embodiments, after (and/or in response to) generating the continuous boundary, the electronic device generates one or more magnetic points 830 within (and/or on) the continuous boundary as shown in FIGS. 8I-8J.

In some embodiments following the generation of a continuous boundary around a first object, the electronic device optionally creates magnetic points within the continuous boundary. A magnetic point is an established connection point which allows a user to connect a second object, or a portion of a second object, to the magnetic point by displaying the second object in proximity to (e.g. within a threshold distance) to the magnetic point. Rather than requiring a user to provide explicit input to connect a second object to the first object through one or more commands (e.g., a grouping command), a user optionally must merely provide input to display the second object in proximity to the magnetic point, which optionally results in the electronic device interpreting the input to display the second object in proximity to the magnetic point as a command to connect the second object to the magnetic point. In some embodiments, in response to displaying the second object in proximity to the magnetic point, such as within a threshold distance, the electronic device eliminates the distance between the second object and the magnetic point, resulting in the second object connecting with and intersecting with the magnetic point. In some embodiments the magnetic points are optionally created in relation to the perimeter of the object, and in some embodiments the magnetic points are optionally created in relation to the continuous boundary of the object. In some embodiments the magnetic points are optionally generated in a predetermined pattern, such as a cruciform pattern with a magnetic point at each distal end of the cruciform pattern and one centrally located magnetic point. In some embodiments the magnetic points are created in relation to the continuous boundary, while some magnetic points are optionally outside the perimeter of the object. As shown in FIG. 8H for example, generation of magnetic points results in a plurality of magnetic points which lay outside the perimeter of the horseshoe. Alternatively, in some embodiments, generation of magnetic points optionally results in the magnetic points to all lay within the perimeter of the object. Alternatively still, in some embodiments generation of magnetic points optionally results in the magnetic points to all lay outside the perimeter of the object. In some embodiments, generation of magnetic points optionally results in one or more magnetic points to coincide with the continuous boundary. Additionally or alternatively, in some embodiments, generation of magnetic points optionally results in one or more magnetic points to coincide with the perimeter of the object. Alternate predetermined patterns include rectangular arrays and radial arrays, but not limited thereto. In some embodiments, the magnetic points are optionally generated as related to the object to fall within the perimeter of the object, or to optionally intersect with the object or the perimeter of the object. Embodiments optionally comprising 1, 2, 3, 4, 5, or more magnetic points are within the spirit and scope of the present disclosure.

The magnetic points associated with the first object provide predefined locations of interactivity with the first object for optionally connecting an endpoint or other portion of a second object to the first object. The use of a magnetic point in particular allows the placement of a first end or a first portion of a second object without requiring pin-point precision user inputs to make a connection between the first end of the second object and the first object. Requiring less precise user inputs to connect two objects mitigates the need for corrective user inputs to correct unsuccessful connections between objects, thus preserving computing resources associated with corrective user inputs.

In some embodiments, while displaying (e.g. drawing, selecting a predetermined object, pasting), via the display generation component, a second object 832 on the content board associated with the content creation application 800, the electronic device detects, via the one or more input devices, an input corresponding to a request to move at least a first end 833 of the second object. For instance, if object 832 were moved from a first position to a second position, such that the second position is as shown in FIG. 8H which is within the threshold distance from the first object the at least first end 833 of the second object is resultantly within the threshold distance 836 of a magnetic point of the first object. In response to detecting the input corresponding to the request to move the at least the first end of the second object, the electronic device moves the at least the first end of the second object, and in the event the movement of the second object results in the first end 833 of the second object being within a threshold distance 836 of a first magnetic point 830 of the one or more magnetic points, the electronic device connects the first end 833 of the second object with first magnetic point as shown in FIG. 8H-8I.

In some embodiments, displaying a second object in a manner that a first end of the second object is in near proximity (e.g. within a threshold distance) to a first magnetic point results in connecting the first end of the second object with the first magnetic point of the first object. Displaying of the second object is optionally achieved through user input such as drawing, pasting, importing, or otherwise generating a visual representation of an object, shape, or text. In some embodiments, the second object is optionally displayed in a location wherein a first end of the second object is in close proximity, within a threshold distance (e.g. a fraction of a pixel, 1 pixel, 2 pixels, 5 pixels, 10 pixels, or greater), to the magnetic point. Additionally or alternatively, in some embodiments, the threshold distance is established and modifiable in increments such as a fraction of a millimeter, 1 mm, 2, mm, 5, mm, 10 mm, or greater. Alternatively, a second object is optionally displayed distally located from the first magnetic point, and subsequently modified such that the first end of the second object is within a threshold distance of the first magnetic point, thus resulting in a connection between the second object and the first magnetic point. In some embodiments the threshold distance within which a connection to a magnetic point results is optionally indicated in pixels, millimeters, centimeters, inches, or other units of measure commonly used in conjunction with a content creation application.

In some embodiments the input corresponding to the request to move at least the first end of the second object (e.g. mouse input, keyboard input, touch-screen input, stylus input) provides an indication to the electronic device that a user has requested to move, or modify, a second object, or a portion of the second object, which results in at least a first end of the object being within a threshold distance of a magnetic point of the first object. When a user input requests a move, or modification of one or more characteristics of the second object, such that a first end of the second object is within the threshold distance of a magnetic point of the first object, the second object is connected to the first object. For instance, a user optionally provides a click-and-drag input with a mouse, or a touch-and-drag input with a finger on a touch-screen, which results in a first end of the second object being within the threshold distance of a magnetic point, resulting in the electronic device connecting the first end of the second object to the magnetic point of the first object. Similarly, a user optionally provides an input through keystrokes on a keyboard connected with the electronic device, such that the keystrokes result in a first end of the second object being within a threshold distance of a magnetic point of the first object, resulting in the electronic device connecting the second object to the first object.

When the first end of the second object is within the threshold distance of the first magnetic point, the first end of the second object is connected to the first magnetic point. In some embodiments, in response to the first end of the second object being offset from the first magnetic point but within the threshold distance from the first magnetic point, the second object is connected to the first magnetic point and the electronic device subsequently, or concurrently, modifies (e.g. moves) the second object to result in the first end of the second object to intersect with the first magnetic point of the first object. In some embodiments, in response to the first end of the second object being within the threshold distance from the first magnetic point, the second object is connected to the second object in relation to the first magnetic point, but the second object remains where displayed wherein the first end of the second object is within the threshold distance from the first magnetic point but offset therefrom.

In some embodiments the threshold distance within which a connection to a magnetic point is established is optionally a predetermined value (e.g. a fraction of a pixel, 1 pixel, 2 pixels, 5 pixels, 10 pixels, or greater). Additionally or alternatively, in some embodiments, the predetermined value is optionally a fraction of a millimeter, 0.5 mm, 1 mm, 2, mm, 5, mm, 10 mm, or greater. In some embodiments, the threshold distance within which a connection to a magnetic point is established is input by way of a user-controlled parameter which is optionally adjusted as desired by the user through user input.

In some embodiments when a second object is connected to a magnetic point of a first object, user inputs to modify one or more characteristics the first object (e.g. movement, stretching, scaling,) are optionally imparted upon the second object due to the connection of the second object to the magnetic point of the first object. Accordingly, when a first object which has a second object connected to a magnetic point of the first object, receiving user inputs to move, stretch, scale, or otherwise modify the first object, results in the application of the user inputs to move, stretch, scale, or otherwise modify the first object to similarly modify the second object.

The use of magnetic points to connect a second object to a first object when placed within a threshold distance eliminates the need to precisely place the second object to intersect with the magnetic point in order to connect the first end of the second object to the magnetic point of the first object. Further, the threshold distance establishes a level of reduced precision required to make a connection between the first end of the second object and the first object. A reduced level of precision necessary to establish a connection between objects results in mitigating unsuccessful attempts at interconnecting objects, which results in fewer user inputs to correct or establish connections between objects. Accordingly, fewer user inputs result in reduced processor tasking and reduced power consumption by the electronic device.

In some embodiments, such as shown in FIG. 8J, after generating the continuous boundary 808 around the first object, the electronic device receives, via the one or more input devices, an indication to modify one or more first characteristics (e.g., size/shape/boundary) of the first object. In response to receiving the indication to modify the one or more first characteristics of the first object, the electronic device optionally updates the continuous boundary 808 of the first object in accordance with the modified one or more first characteristics of the first object.

In some embodiments, following the generation of magnetic points in relation to a first object, and in response to user input(s) directed toward modification of one or more characteristics of the object, the electronic device translates user input to modify the first object to apply modifications similarly to the magnetic points of the first object. In the instance wherein one or more characteristics of the first object are modified, the continuous boundary and the magnetic points of the first object are updated accordingly. For instance, when the first object is optionally scaled by a first factor, the continuous boundary and the magnetic points of the first object are similarly scaled by the first factor, wherein the proportional location of the magnetic points in relation to the first object remain unchanged. In the event that the first object is optionally moved a first distance in a first direction, the continuous boundary and the magnetic points of the first object are similarly moved in the first distance in the first direction, wherein the relative location of the magnetic points to the first object remains unchanged.

In some embodiments, when a second object is connected to a magnetic point of the first object prior to the modification of one or more characteristics of the first object, the modification to one or more first characteristics of the first object are similarly applied to the magnetic points of the first object, and optionally to one or more first characteristics of the second object. The characteristics of an object include, but are not limited to, size, shape, height, width, color, general location, location of one or more portions of an object, perspective, or a combination thereof. For instance, in some embodiments, optionally moving the first object a first distance in a first direction results in movement of the magnetic points of the first object the first distance in the first direction such that the location of the magnetic points in relation to the first object are unchanged. Furthermore, moving of the first object the first distance in the first direction optionally the second object is optionally moved the second distance in the first direction such that the location of the second object in relation to the first object is unchanged. Similarly, scaling of the first object by a first factor results in scaling of the magnetic points of the first object by the first factor, such that the location of the magnetic points in relation to the first object are unchanged. Furthermore, the scaling of the first object optionally results in scaling of the second object by the first factor such that the relative location of the first end of the second object remains connected to the magnetic point.

Applying the modification of the one or more characteristics of the first object, to the magnetic points of the first object maintains user intended relative connections characteristics between a second object and a first object and mitigates the need to re-establish a connection between a second object and a first object following modifications to one or more characteristics of the first object, thus reducing user inputs required related to and following modifications of a first object to which a second object is connected. Reducing user inputs required to modify multiple associated objects streamlines user interaction with the electronic device, and further reduces processor utilization and power consumption associated with user inputs to the electronic device.

In some embodiments, in response to receiving the indication to display the first object, the electronic device generates (and/or displaying) a continuous perimetral outline 818 of the first object (804a, 804b) as shown in FIG. 8C and FIG. 8K for instance.

In some embodiments following an input to display a first object, the electronic device generates a perimetral outline. A perimetral outline optionally follows the perimeter of the object and identifies the area within the perimetral outline as part of the first object. In some embodiments the perimetral outline is optionally coincident with the perimeter of the object. In some embodiments the perimetral outline is optionally offset from the perimeter of the object in one or portions of the perimetral outline. In some embodiments the perimetral outline is offset equally from the perimeter of the object in all portions of the perimetral outline. In some embodiments, a perimetral outline offset is optionally indicated in pixels, millimeters, centimeters, inches, or other units of measure commonly used in conjunction with a content creation application. For instance, in some embodiments, a perimetral outline offset is optionally a distance of a fraction of a pixel, 1 pixel, 2 pixels, 5 pixels, 10 pixels, or greater. Additionally or alternatively, in some embodiments, the perimetral outline offset is established and modifiable in increments such as a fraction of a millimeter, 0.5 mm, 1 mm, 2, mm, 5, mm, 10 mm, or greater.

For example, in the case of a horseshoe shape, the perimetral outline optionally follows the outer perimeter of the shape. In the case of a pentagram shape comprising intersecting edges for example, wherein the intersecting edges comprise a pentagon within a star shape, a perimetral outline optionally follows only the outer perimeter. In some embodiments, as illustrated in FIG. 8C, when a perimetral outline 818 is generated by the electronic device 500, the perimetral outline is generated to be coincident with an outer perimeter 816 (e.g. the star shape). However, in some embodiments the electronic device 500 forgoes generating a perimetral outline associated with an inner perimeter 821 (e.g. the pentagon inscribed within the star of the pentagram 804b). Accordingly, in some embodiments the perimetral outline 818 associated with the outer perimeter 816 is optionally magnetic, while the inner perimeter 821 is optionally not magnetic. In the case of a torus for example, a first perimetral outline follows the outer perimeter of the torus. Furthermore, the torus optionally comprises a second perimetral outline which follows the inner perimeter of the torus.

The perimetral outline provides a definition of the bounds of the object to differentiate area which lies within the object from the area within the continuous boundary. The differentiation of area between the object and the continuous boundary allows the optional interactivity of the area within the continuous boundary which coincides with the object, and optional interactivity of the area within the continuous boundary outside the perimeter(s) of the object. Differentiation of areas within the convex boundary prevents erroneous user input associated with mis-associating objects when interacting with them, thereby preserving computing resources associated with correcting erroneous user inputs.

In some embodiments as shown in FIG. 8K, while displaying, via the display generation component, a second object 832 on the content board associated with the content creation application, wherein a first end 833 of the second object is at a first location in the content board, in accordance with the first location being within a threshold distance 838 of the perimetral outline 816, the electronic device connects the first end 833 of the second object with the perimetral outline 818 in a second location in the content board as illustrated in FIG. 8L.

In some embodiments the perimetral outline is magnetic in relation to the placement of objects in near proximity such that when a second object is placed within the threshold distance from the perimetral outline of a first object, the second object is connected to the first object. The connection to the perimetral outline when within a threshold distance to the perimetral outline is similar to the connection to a magnetic point when within a threshold distance of the magnetic point (described above).

In some embodiments, displaying a second object wherein a first end of the second object is in near proximity (e.g., within a threshold distance) to a perimetral outline of a first object results in the connection of the first end of the second object with the perimetral outline of the first object. In some embodiments, a threshold distance is optionally indicated in pixels, millimeters, centimeters, inches, or other units of measure commonly used in conjunction with a content creation application. For instance, in some embodiments, a threshold distance is optionally a distance of a fraction of a pixel, 1 pixel, 2 pixels, 5 pixels, 10 pixels, or greater. Additionally or alternatively, in some embodiments, threshold distance is established and modifiable in increments such as a fraction of a millimeter, 0.5 mm, 1 mm, 2, mm, 5, mm, 10 mm, or greater.

In some embodiments when a second object is connected to a perimetral outline of a first object, user inputs to modify one or more characteristics the first object (e.g. movement, stretching, scaling,) are optionally imparted upon the second object due to the connection of the second object to the perimetral outline of the first object. Accordingly, when a first object which has a second object connected to a perimetral outline of the first object, receiving user inputs to move, stretch, scale, or otherwise modify the first object, results in the application of the user inputs to move, stretch, scale, or otherwise modify the first object to similarly modify the second object.

Displaying of the second object is optionally achieved through user input such as drawing, pasting, importing, or otherwise generating a visual representation of an object, shape, or text. In some embodiments, the second object is optionally displayed in a location wherein the first end of the second object is in close proximity, within a threshold distance, to the perimetral outline of the first object. Alternatively, a second object is optionally displayed distally located from the perimetral outline, and subsequently modified such that the first end of the second object is within a threshold distance of the perimetral outline.

In some embodiments, when a first end of the second object is within a threshold distance of a perimetral outline of the first object, the first end of the second object is connected to the perimetral outline. In some embodiments, in response to the first end of the second object being offset from the perimetral outline but within the threshold distance from the perimetral outline, the electronic device connects the second object to the perimetral outline and the electronic device concurrently, or subsequently, modifies (e.g. moves) the second object to result in the first end of the second object intersecting with the perimetral outline of the first object. In some embodiments, in response to displaying the second object in a manner that results in the first end of the second object being offset from the perimetral outline of the first object but within the threshold distance from the perimetral outline, the electronic device connects the second object to the perimetral outline, but the device does not move the location of the second object and the first end of the second object although connected to the perimetral outline is displayed as being offset from the perimetral outline (e.g., the second object and the first object are not visibly connected).

In some embodiments, the threshold distance used to determine if an object should be connected to a perimetral outline is provided to the electronic device by way of a user-controlled parameter which is optionally adjusted as desired by the user through user input (for instance by the user providing an input on a user interface).

In some embodiments the connection between the second object and the perimetral outline of the first object occurs at the nearest portion of the perimetral outline of the first object in relation to a first location of the first end of the second object. Upon the display of the second object wherein the first end of the second object is in a first location, and the first location is within the threshold distance from the perimetral outline, the first end of the second object is subsequently connected to the perimetral outline at a second location intersecting with the perimetral outline. In some embodiments, a linear path extending between the first location and the second location is perpendicular to the perimetral outline at the second location.

Connecting one or more objects to the perimeter and/or a perimetral outline a first object such that the connection of the second object with the first object does not occlude portions of the first object minimizes the likelihood of erroneous input associated with such visual occlusions thereby preserving computing resources associated with inputs required to correct erroneous input.

In some embodiments, while displaying, via the display generation component, a second object on the content board associated with the content creation application, wherein a first end of the second object is at a first location, in accordance with the first location being inside the continuous boundary and outside the perimetral outline, the electronic device connects the first end of the second object with the first object at the first location. For instance, referencing FIG. 8K for example, in the event the second object 832 were displayed with the second end 833 with the area 810 within the continuous boundary 808 and outside the perimetral outline 818, the electronic device 500 would connect the first end 833 of second object to the first object. If the first end 833 of the second object were displayed within the continuous boundary 808, outside the perimetral outline 818, and within a threshold distance 838 from the perimetral outline 818, the electronic device would optionally connect the first end 833 of the second object to the perimetral outline 818 of the first object as shown in FIG. 8L.

In some embodiments a second object is optionally connected to a first object wherein a first end of the second object is optionally displayed through user input such as drawing, pasting, importing, or otherwise generating a visual representation of an object, shape, or text. In some embodiments, the second object is optionally displayed in a location wherein the first end of the second object is located within the continuous boundary, but outside the perimetral outline. Alternatively, a second object is optionally displayed with a first end located outside the continuous boundary, and subsequently modified in a manner which results in the first end of the second object being within the continuous boundary but outside the perimetral outline. When the first end of the second object is located within the continuous boundary, but outside the perimetral outline, the second object is connected to the first object at the location within the continuous boundary and outside the perimetral outline in relation to the object. Additionally or alternatively, in some embodiments, displaying a second object with a first end, or a portion, of the second object within the continuous boundary of the first object and within the perimetral outline of the first object, indicates to the electronic device to connect the second object to the first object at the location within the continuous boundary and within the perimetral outline in relation to the first object.

For example, in the example of a horseshoe shape being the first object, the electronic device upon displaying a second object such that the first end of the second object is located within the concave portion of the horseshoe, connects the object with the horseshoe.

In some embodiments, the first object comprises a donut or torus shaped first object. In some embodiments, the electronic device displays a second object in a manner that results in the first end of the second object being located at the center of the torus, result in in the first end of the second object being located within the continuous boundary, but outside the bounds of the first object as defined by an inner perimetral outline and an outer perimetral outline of the torus. Accordingly, the second object is connected to the torus relative to the torus.

In some embodiments the area within the continuous boundary and outside a perimetral outline designates an area of interactivity with the first object (described above). Furthermore, in some embodiments the area inside one or more perimetral outlines of a first object designates an area of non-interactivity with the first object wherein when a first end of a second object is displayed within the bounds of one or more perimetral outlines, the second object is not connected to the first object relative to the first object.

In some embodiments, an area within the bounds of a perimetral outline is optionally interactive but not magnetic, such that when a second object is displayed in relation to the first object in such a way that a first end of the second object is within the bounds of the perimetral outline, the connection established between the second object and the first object remains in the relative location to the first object as originally input by the user without jumping or snapping to another portion of the first object.

Connecting a second object to a first object when a first end of the second object is outside the perimetral outline while inside the continuous boundary, allows the efficient interconnection between a second object and the first object. By connecting the second object to the first object through interactions with an area within the continuous boundary which is outside the form of the object, connections to the first object are easier to achieve, allow for connection of the second object to the first object without occluding portions of the first object by utilizing area surrounding the first, and allows for quicker and more efficient connections of the second object to the first object. More efficient connections result in fewer user inputs and reduced processor utilization associated with the reduced inputs, thus resulting in reduced power consumption.

Furthermore, embodiments wherein the area within the perimetral outline(s) of an object are non-interactive allow the connection of objects in a manner that prevents occluding portions of the first object, and thus reduces subsequent user input to eliminate occluding the first object. The reduction of subsequent user inputs results in reduced processor utilization, thus resulting in reduced power consumption.

In some embodiments as shown in FIG. 8D, while displaying, via the display generation component, the first object 804a on the content board associated with the content creation application, the electronic device receives an indication to modify 822 a continuous boundary offset 824 of the continuous boundary 808 relative to the first object. In response to receiving the indication to modify the continuous boundary offset 824, the electronic device optionally updates placement of the continuous boundary 808 relative to a perimeter 816 of the first object as illustrated in FIG. 8E.

In some embodiments the continuous boundary is optionally offset from the perimeter of the object. In some embodiments the continuous boundary is optionally offset outward from the perimeter of an object. In some embodiments the continuous boundary is optionally offset in accordance with a threshold distance wherein the continuous boundary is offset a consistent distance from portions of the perimeter of the object which the continuous boundary follows. In some embodiments the continuous boundary follows the entirety of the perimeter(s) of the object, and in some embodiments the continuous boundary follows the convex portions of the object. An offset of the continuous boundary outward from the perimeter allows for the connection of a first end of a second object to a first object without occluding a portion of the first object. Alternatively, in some embodiments, the continuous boundary is optionally offset inward from the perimeter of the object which allows for interconnection of the first end of the second object with the first object in a manner that overlaps or occludes portions of the first object to visually emphasize the association and connection of the second object with the first object.

In some embodiments the continuous boundary is optionally offset a consistent distance, or offset distance, from the perimeter of the object. In some embodiments the continuous boundary is optionally offset a variable distance from the perimeter based on characteristics of the object such as, but not limited to, size, shape, angles, or a combination thereof. Alternatively, in some embodiments the continuous boundary is optionally offset in accordance with an algorithm in relation to variables such as, but not limited to, a ratio of area within the continuous boundary to area within the perimeter(s) of an object.

In some embodiments, the continuous boundary offset is established and modifiable in increments (e.g. a fraction of a pixel, 1 pixel, 2 pixels, 5 pixels, 10 pixels, or greater. Additionally or alternatively, in some embodiments, the continuous boundary offset is established and modifiable in increments such as a fraction of a millimeter, 0.5 mm, 1 mm, 2, mm, 5, mm, 10 mm, or greater. In some embodiments, the continuous boundary offset is optionally indicated in pixels, millimeters, centimeters, inches, or other units of measure commonly used in conjunction with a content creation application.

In some embodiments, when a user provides input to modify a continuous boundary offset, the continuous boundary is modified in accordance with the user input. If a user input indicates a positive offset for instance, the continuous boundary is offset from the object in a first direction (e.g. outward). Alternatively, if a user input indicates a negative offset for instance, the continuous boundary is offset from the object in a second direction (e.g. inward), different from than the first direction.

In some embodiments a continuous boundary is optionally modifiable through user input to allow a user to change the offset of the continuous boundary from the perimeter of an object. The continuous boundary is optionally modifiable and reconfigurable through user input at user interface element. The continuous boundary offset is optionally indicated in pixels, millimeters, centimeters, inches, or other units of measure commonly used in conjunction with a content creation application. In some embodiments a continuous boundary is offset outward such as with a positive parameter input, and in some embodiments a continuous boundary is optionally offset inward from the perimeter of the object such as with a negative parameter input.

In some embodiments the parameter of the continuous boundary offset comprises a parameter based on the area bounded by the continuous boundary relative to the area bounded by the perimeter of the object. Alternatively, in some embodiments the continuous boundary offset comprises a parameter based on the length of the continuous boundary in relation to the length of the perimeter of the object.

In some embodiments, a user input (e.g. through input at a user interface element), optionally indicates to the electronic device to increase the continuous boundary offset, resulting in enlarging the continuous boundary. Increasing the continuous boundary offset results in the continuous boundary surrounding an increased amount of area within the continuous boundary which is outside the perimeter of the object. More area in relation to the object which a continuous boundary surrounds provides increased area of interactivity for a user connect and/or associate other objects with it.

In some embodiments, a user input (e.g. though input at a user interface element), optionally indicates to the electronic device to decrease the continuous boundary offset, resulting in the continuous boundary surrounding a decreased amount of area within the continuous boundary which is outside the perimeter of the object. Less area in relation to the object which a continuous boundary surrounds, reduces unintended connections to objects as the number of objects on a content board increases. For instance, the reduction of the continuous boundary in some scenarios, results in preventing the overlap of continuous boundaries, and reducing ambiguity as related to the intention of a user when input is received to connect objects.

In some embodiments, the continuous boundary offset is optionally set by user input to a value of equal to or greater than zero. However, in some embodiments the continuous boundary offset is optionally set by user input to a value of equal to, less, than, or greater than zero.

In some embodiments, modification of the continuous boundary offset optionally results in a continuous boundary to maintain the same shape regardless of the value of the offset such that characteristics (e.g. angles, and/or relative proportions) remain consistent as the continuous boundary is modified to be larger or smaller. Alternatively, or additionally, in some embodiments the modification of the continuous boundary offset optionally further results in modification to characteristics of the continuous boundary (e.g. angles and/or relative proportions). For instance, in some embodiments, a continuous boundary having zero offset from the shape and/or a predetermined value optionally comprises two linear segments which meet at an angle. As the continuous boundary offset is increased, the angle at which the two linear segments meet is converted to a curved portion which connects between the two line segments, and the radius of the curved portion optionally increases as the continuous boundary offset is further increased.

The optional modification of a continuous boundary through user input allows the adjustment of a plurality of connections between a plurality of objects with limited input, such as a single input, thus reducing user inputs, reduces processor utilization, and reduces power usage.

Furthermore, offsetting the continuous boundary of a first object allows for connection of a second object to a first object at a location offset from the perimeter of the object to allow connections to be made in accordance with stylistic preference without individual adjustments to each connection. In the case of a document with a plurality of objects connected with each other, an offset allows for the plurality of objects to be connected in accordance with a single offset parameter, thus reducing user inputs, reduces processor utilization, and reduces power usage.

In some embodiments, such as shown for instance in FIG. 8K, while the first object 804a is displayed on the content board, the electronic device 500 receives an indication 834 to display a second object 832. In response to receiving the indication to display the second object 832, the electronic device optionally displays, via the display generation component, the second object 832 on the content board associated with the content creation application 800. Further in response to the indication to display the second object, in accordance with a first portion of the second object being within the continuous boundary 808 of the first object, the electronic device optionally associates the first portion of the second object 832 with the first object, relative to the first object 804a, such that the relative location of 832 remains unchanged in relation to the first object.

In some embodiments when the electronic device displays a second object such that the second object intersects the continuous boundary or an area bounded by the continuous boundary, the second object is connected with the first object relative to the first object.

In some embodiments, when the electronic device displays a first end of the second object such that the first end of the second object intersects the continuous boundary, the area within the continuous boundary, or a combination thereof, the second object is connected with the first object relative to the first object based on the intersection of the second object with the continuous boundary of the first object.

In some embodiments, when the electronic device displays a second object such that a portion of the second object intersects the continuous boundary, the area within the continuous boundary, or a combination thereof would result in the connection of the second object to the first object the electronic device subsequently connects the second object to the first object relative to the first object based on the intersection of the portion of the second object with the continuous boundary of the first object.

In some embodiments, when the electronic device displays a second object such that a portion of the second object, such as an endpoint or perimeter, intersects or overlaps the area within the continuous boundary of the first object, and the portion of the second object does not intersect the perimeter of the first object, the electronic device subsequently connects the second object to the first object relative to the first object.

In some embodiments, when the electronic device displays a second object such that the second object intersects or traverses across the area within the continuous boundary of the first object, and a first end of the second object and a second end of the second object are outside the continuous boundary of the first object, the electronic device subsequently connects the second object to the first object relative to the first object.

The connection of a second object to the first object upon a portion of the second object intersecting with the area within the continuous boundary of the first object results in increased efficiency of the connection of objects to each other. Efficiency as related to the connection to objects to each other requires fewer user inputs and reduced processor utilization, thus resulting in reduced power consumption.

In some embodiments, while displaying a second object, via the display generation component, on the content board, in accordance with the second object being entirely outside the continuous boundary, the electronic device forgoes connecting the second object with the first object. For example, referencing FIG. 8H, if the horseshoe shape 804a were displayed, but the magnetic points 830 were not generated, the second object 832 would be entirely outside the continuous boundary 808 as shown, and would result in no connection made between the second object 832 and the first object 804a.

In some embodiments when a second object is displayed on the content board in conjunction with the first object, wherein the second object does not intersect the continuous boundary of the first object, subsequent action is not taken connecting the second object to the first object. In some embodiments when the second object is connected to the first object based on a portion of the second object intersecting the continuous boundary of the first object, and subsequent user input results in the second object to no longer intersect the first object, the second object is disconnected from the first object. When a second object is not connected to the first object, or disconnected from a first object, modifications to one or more characteristics of the first object do not result in modifications of one or more characteristics of the second object as the first object and the second object are independent of one another.

Forgoing the connection of a second object to a first object when the second object does not intersect with the area within the continuous boundary of the first object prevents unintended connections between objects and prevents unnecessary connections between objects which require processor utilization, thus limiting power consumption. Similarly, disconnecting objects such as when a portion of a second object intersects with the area within the continuous boundary and subsequent user input modifies the second object in a manner which results in the second object no longer intersecting the continuous boundary of the first object, prevents unnecessary modifications to the second object in response to modifications to the first object. Preventing unnecessary modifications to objects reduces unnecessary processor utilization and reduces unnecessary power consumption.

In some embodiments, while displaying the second object, the electronic device receives, via the one or more input devices, an indication to modify one or more first characteristics of the second object (optionally including or not including movement of the second object). In response to receiving the indication to modify the one or more first characteristics of the second object, the electronic device optionally modifies the one or more first characteristics of the second object in accordance with the indication to modify the one or more first characteristics of the second object. Furthermore, in accordance with one or more portions of the second object being within the continuous boundary of the first object due to the modification of the one or more first characteristics of the second object, the electronic device optionally connects the second object with the first object relative to the first object. Referencing FIG. 8M for example, if the second object 832 were previously displayed in a manner which did not intersect with the continuous boundary 808 or the area 810 within the continuous boundary, and a user input to modify the second object 832 resulted in the second object 832 as displayed in FIG. 8M, then the second object would be connected to the first object 804d.

In some embodiments when a second object is not connected to the first object, and subsequent user input is provided which modifies one or more characteristics of the second object (e.g., size, location, shape, aspect ratio) which results in a portion of the second object to intersect the continuous boundary or an area therein, the device connects the second object the first object as a result of the modification to the second object. For example, in some embodiments subsequent user input moves the second object from a first location to a second location wherein a first end of the second object intersects the continuous boundary of the first object in the second location. In some embodiments the subsequent user input scales the second object wherein a portion of the second object intersects the continuous boundary of the first object of the second object after scaling. In response to the second object intersecting the continuous boundary of the first object, the second object is connected to the first object.

In some embodiments, a first object and a second object are displayed on a content board such that the second object does not intersect the first object. Subsequent user input which results in the second object intersecting the first object results in the electronic device connecting the second object to the first input. For example, subsequent user input which scales the second object (e.g. enlarging) in such a way that results in a portion of the second object to intersect the continuous boundary of the first object, results in the electronic device connecting the second object to the first object. For further example, subsequent user input which rotates the second object in such a way that results in a portion of the second object to intersect the continuous boundary of the first object, would also result in the electronic device connecting the second object to the first object.

Allowing the modification of a second existing object which is not connected to a first object, to intersect the continuous boundary of the first object and in response connecting the second object to the first object allows efficient connection of existing objects. Allowing efficient connection through user input to existing objects reduces user inputs, reduces processor utilization, and reduces power consumption.

In some embodiments, at least a portion of an area 810 within the continuous boundary is outside a perimeter of the first object, as illustrated for instance in FIG. 8B-8N.

In some embodiments a continuous boundary surrounding a first object includes an area within the continuous boundary that is also outside the perimeter(s) of the first object. The area which is outside the perimeter of the object provides but within the continuous boundary, in addition to the area within the perimeter(s) of the object designates an area of interactivity. In contrast with relying solely on the area within the perimeter(s) of an object, the area within the continuous boundary which is outside the perimeter(s) of an object provides increased area with which a user optionally provides input to connect a second object to a first object. For instance, the area partially bounded by the concavity of a horseshoe shaped object is visually surrounded by the horseshoe, but is not part of the object, provides an area of interactivity. Further examples include the area surrounded by a torus wherein the area in a center portion of a torus is visually surrounded by the torus, but not part of the object, provides an area of interactivity.

In some embodiments, the continuous boundary offset (described above) is asymmetrical such that a first portion of a continuous boundary and a second portion of the continuous boundary have different continuous boundary offsets. In some embodiments a first portion optionally has a continuous boundary offset of zero (described above) in relation to the perimeter of the object, such that the first portion continuous boundary is coincident with the respective portion of the perimeter which it is associated with. A second portion of the continuous boundary optionally has a continuous boundary offset of greater than zero such that there is an area of interactivity between the second portion of the continuous boundary and the respective portion of the perimeter. In the case of a horseshoe shape for example, a first portion of a continuous boundary in relation to the horseshoe shape is optionally coincident with the convex outside portion of the horseshoe, and a second portion of the continuous boundary is optionally linear and offset from the concave inner portion of the horseshoe.

In some embodiments, when the electronic device displays a second object such that a portion of the second object intersects with an area of the first object which is within the continuous boundary but outside the perimeter(s) of the first object, the electronic device subsequently connects the second object with the first object.

In some embodiments, when the electronic device displays a second object such that a portion of the second object intersects with an area of the first object which is within the continuous boundary and within the perimeter(s) of the first object, the electronic device subsequently connects the second object with the first object. Alternatively, in some embodiments, when the electronic device displays a second object such that a portion of the second object intersects with an area of the first object which is within the continuous boundary and within the perimeter(s) of the first object, the electronic device forgoes the second object with the first object.

The interactivity of areas within the continuous boundary but outside the perimeter(s) of a first object minimizes the likelihood of erroneous user input associated with mis-associating objects when interacting with them, thereby preserving computing resources associated with correcting erroneous user inputs. Furthermore, designating area between the boundary and the perimeter of the object as an area of interactivity with the object provides use of otherwise unused area to provide increased area of interactivity and functionality when interacting with displayed objects. In relation to embodiments wherein the electronic device forgoes connection between the second object and the first object when the portion of the second object is within the continuous boundary and within the perimeter(s) of the first object, optionally forgoing connection prevents the occlusion or visual overlapping of content within the first object which would require further user inputs (e.g. requiring further processor utilization and power consumption) to correct such occlusions.

It should be understood that the particular order in which the operations in FIG. 9 have been described, optionally including the additional and/or alternatives operations to the illustrated operations in FIG. 9 described herein, is merely exemplary and is not intended to indicate that the described order is the only order in which the operations could be performed. One of ordinary skill in the art would recognize various ways to reorder the operations described herein. In some embodiments, aspects/operations of methods 700 and 900 may be interchanged, substituted, and/or added between these methods. For example, the content boards of methods 700 and/or 900, the content creation applications of methods 700 and/or 900, and the shapes, scenes and/or other displayed content of methods 700 and/or 900, are optionally interchanged, substituted, and/or added between these methods. For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5I) or application specific chips. Further, the operations described above with reference to FIG. 7 are, optionally, implemented by components depicted in FIGS. 1A-1B. For example, receiving operation 704, and generating operations 708 and 710 are, optionally, implemented by event sorter 170, event recognizer 180, and event handler 190. Similarly, the operations described above with reference to FIG. 9 are, optionally, implemented by components depicted in FIGS. 1A-1B. For example, receiving operation 902, displaying operation 906 and generating operation 908 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to facilitate interactions of a user at an electronic device with one or more objects and/or one or more scenes to and creating associations between the one or more objects and/or one or more scenes to provide more efficient interactions between a user and a content board of a content creation application (e.g., connecting, grouping, creating transitions) or other interactions with the electronic device. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, and/or handwriting styles.

The present disclosure recognizes that the use of such personal information data, in the present technology, can be used to the benefit of users. For example, the personal information data can be used to automatically perform operations with respect to interacting with the electronic device as previously established in relation to one or more objects and/or one or more scenes. Accordingly, use of such personal information data enables more efficient interactions between a user and a content board of a content creation application. Further, other uses for personal information data that benefit the user are also contemplated by the present disclosure. For instance, a content creation application can facilitate the creation and navigation of content board scenes. Alternatively or additionally, associations between one or more objects can be used to apply modifications to one or more characteristics to made to a first object by a user, to a second object associated with the first object wherein the one or more characteristics of the second object are modified similarly to the one or more characteristics of the first object.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's content (e.g., scenes, objects) created with one or more content boards and previously stored on the electronic device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a user can create one or more scenes and/or one or more objects with associations without access to previously stored scenes and/or objects.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
while displaying, via the display generation component, a content board associated with a content creation application, receiving, via the one or more input devices, an indication to generate a content board scene associated with the content board;
in response to receiving the indication to generate the respective content board scene:
in accordance with a first region of the content board being displayed at a first zoom level when the indication to generate the content board scene is received, generating a first content board scene; and
in accordance with a second region, different from the first region, of the content board being displayed at the first zoom level when the indication to generate the respective content board scene is received, generating a second content board scene different from the first content board scene.

2. The method of claim 1, wherein the method further comprises:
in response to receiving the indication to generate the respective content board scene:
in accordance with the second region, different from the first region, of the content board being displayed at a second zoom level, different from the first zoom level, when the indication to generate the respective content board scene is received, generating a third content board scene different from the first content board scene and different from the second content board scene.

3. The method of claim 1, wherein:
in accordance with the display generation component of the electronic device having a first aspect ratio, the first content board scene has the first aspect ratio; and
in accordance with the display generation component of the electronic device having a second aspect ratio, different from the first aspect ratio, the first content board scene has the second aspect ratio.

4. The method of claim 1, wherein the first region is displayed on a user interface of the content creation application, and wherein an aspect ratio of the first content board scene is based on an aspect ratio of the of the user interface of the content creation application.

5. The method of claim 1, wherein the method further comprises:
receiving, via the one or more input devices, an indication to display a third content board scene via the display generation component of the electronic device; and
in response to receiving the indication to display the third content board scene, displaying the third content board scene with an aspect ratio that is based on an aspect ratio of the display generation component of the electronic device.

6. The method of claim 5, wherein the method further comprises:
receiving, via the one or more input devices, an indication to display a third content board scene via the display generation component of the electronic device, wherein the third content board scene is received from an external electronic device, the external electronic device having a first aspect ratio, and the third content board scene is associated with a third region of a respective content board; and
in response to receiving the indication to display the third content board scene, and in accordance with the electronic device having a second aspect ratio, different from the first aspect ratio, displaying the third content board scene with the second aspect ratio, wherein displaying the third content board scene with the second aspect ratio comprises displaying the third region of the third content board scene within a fourth region of the respective content board, the fourth region having the second aspect ratio.

7. The method of claim 5, wherein:
displaying the third content board scene on an external electronic device includes displaying a third region of a respective content board without displaying a fourth region of the respective content board, and
displaying the third content board scene on the electronic device includes displaying the third region of the respective content board and displaying the fourth region of the respective content board.

8. The method of claim 5, wherein the third content board scene is displayed without visual boundary indicators around a third region of a content board corresponding to the third content board scene.

9. The method of claim 1, wherein the method further comprises:
receiving, via the one or more input devices, an indication to export the first content board scene to an external electronic device; and
in response to receiving the indication to export the first content board scene to the external electronic device:
in accordance with an indication to export the first content board scene according to an aspect ratio of the electronic device:
initiating a process to transmit the first content board scene to the external electronic device having an aspect ratio of the electronic device; and
in accordance with an indication to export the first content board scene according to an aspect ratio of the external electronic device:
initiating a process to transmit the first content board scene to the external electronic device having an aspect ratio of the external electronic device.

10. The method of claim 1, wherein the method further comprises:
while displaying the first content board scene, and while displaying a scene navigation user interface associated with the content creation application, wherein the scene navigation user interface is configured to navigate between a plurality of content board scenes stored on the electronic device including the first content board scene, receiving an indication at the scene navigation user interface to display a third content board scene of the plurality of content board scenes stored on the device; and
in response to receiving the indication to display the third content board scene:
transitioning from displaying the first content board scene to displaying the third content board scene of the plurality of content board scenes according to a first animation sequence.

11. The method of claim 10, wherein:
in accordance with the plurality of content board scenes being created in a first order, the third content board scene is a first respective content board scene; and
in accordance with the plurality of content board scenes being created in a second order, different from the first order, the third content board scene is a second respective content board scene, different from the first respective content board scene.

12. The method of claim 10, wherein:
in accordance with a determination that a first respective content board scene is closest in proximity of the plurality of content board scenes to the first content board scene on the content board, the third content board scene is the first respective content board scene; and
in accordance with a determination that a second respective content board scene, different from the first respective content board scene, is closest in proximity of the plurality of content board scenes to the first content board scene, the third content board scene is the second respective content board scene.

13. The method of claim 10, wherein the scene navigation user interface includes a plurality of selectable options, each selectable option corresponding to a content board scene of the plurality of content board scenes stored on the electronic device, and wherein receiving the indication to display the third content board scene comprises receiving a first input at a first selectable option of the plurality of selectable options corresponding to the third content board scene, the method further comprising:
receiving an indication to display a fourth content board scene, different from the third content board scene, wherein receiving the indication to display the fourth content board scene comprises receiving a second input at a second selectable option of the plurality of selectable options corresponding to the fourth content board scene; and
in response to receiving the indication to display the fourth content board scene, transitioning from displaying the third content board scene to displaying the fourth content board scene of the plurality of content board scenes according to a second animation sequence.

14. The method of claim 10, wherein the scene navigation user interface includes a next scene selectable option, and wherein the method further comprises:
receiving a first input at the next scene selectable option; and
in response to receiving the first input at the next scene selectable option:
in accordance with a fourth content board scene being a next unnavigated-to scene, transitioning from displaying the third content board scene to displaying the fourth content board scene according to a second animation sequence; and
in accordance with a fifth content board scene being the next unnavigated-to scene, transitioning from displaying the third content board scene to displaying the fifth content board scene according to a third animation sequence.

15. The method of claim 1, wherein the method further comprises:
while the first content board scene has been generated, and while displaying a third region of the content board scene, different from the first region, receiving an indication to update the first content board scene; and
in response to receiving the indication to update the first content board scene, modifying the first content board scene in accordance with the displayed third region.

16. The method of claim 1, the method further comprising:
receiving, from an external electronic device associated with an external user, an indication of a third content board scene associated with the content board of the content creation application; and
in response to receiving the indication of the third content board scene, storing the third content board scene on the electronic device in association with the content board.

17. The method of claim 1, wherein method further comprises:
while displaying a third region of the content board, and while displaying a scene list user interface, wherein the scene list user interface includes a plurality of entries, each entry associated with a content board scene of a plurality of content board scenes stored on the electronic device: in accordance with a determination that the displayed third region of the content board corresponds to a third content board scene of the plurality of content board scenes, displaying a visual indicator associated with the entry of the plurality of entries associated with the third content board scene; and
in accordance with a determination that the displayed third region of the content board corresponds to a fourth content board scene of the plurality of content board scenes, displaying a visual indicator associated with the entry of the plurality of entries associated with the fourth content board scene.

18. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
while displaying, via the display generation component, a content board associated with a content creation application, receiving, via the one or more input devices, an indication to generate a content board scene associated with the content board;
in response to receiving the indication to generate the respective content board scene:
in accordance with a first region of the content board being displayed at a first zoom level when the indication to generate the content board scene is received, generating a first content board scene; and
in accordance with a second region, different from the first region, of the content board being displayed at the first zoom level when the indication to generate the respective content board scene is received, generating a second content board scene different from the first content board scene.

19. A non-transitory computer readable storage medium storing one or more programs, the one or more programs comprising instructions, which when executed by one or more processors of an electronic device that is in communication with a display generation component and one or more input devices, cause the electronic device to perform a method comprising:
while displaying, via the display generation component, a content board associated with a content creation application, receiving, via the one or more input devices, an indication to generate a content board scene associated with the content board;
in response to receiving the indication to generate the respective content board scene:
in accordance with a first region of the content board being displayed at a first zoom level when the indication to generate the content board scene is received, generating a first content board scene; and
in accordance with a second region, different from the first region, of the content board being displayed at the first zoom level when the indication to generate the respective content board scene is received, generating a second content board scene different from the first content board scene.

20-34. (canceled)
